(19) United States
(12) Patent Application Publication
(10) Pub. No.: US 2021/0333628 A1
(43) Pub. Date: Oct. 28, 2021

(54) POLARIZER, DISPLAY UTILIZING THE SAME AND ULTRAVIOLET EMITTING APPARATUS

(71) Applicant: SCIVAX CORPORATION, Kanagawa (JP)

(72) Inventors: Nobuyoshi Awaya, Kanagawa (JP); Yasumasa Suzaki, Kanagawa (JP)

(21) Appl. No.: 16/621,084

(22) PCT Filed: Jun. 24, 2019
(86) PCT No.: PCT/JP2019/025021

§ 371 Date: Dec. 10, 2019

(30) Foreign Application Priority Data
Aug. 30, 2018 (JP) 2018-162216

(51) Int. Cl. G02F 1/1335; G02F 1/1333; G02F 1/00

(52) U.S. Cl. CPC G02F 1/133548; G02F 1/0063; G02F 1/13336

(57) ABSTRACT

A polarizer that suppresses a decrease in extinction ratio due to leakage light in a Cross Nicol condition, a display that utilizes the same, and an ultraviolet emitting apparatus are provided. A polarizer includes a substrate transparent to light within a utilized bandwidth, a wire grid portion including a plurality of wires which extends in a direction and which is arranged side by side at a pitch shorter than a wavelength of the light, and a polarizing axis correcting portion which is formed of a dielectric provided at a side at which the light enters the wire grid portion, and which performs correction so as to reduce a displacement in an angle between an incidence-side transmittance axis of linear polarized light and an emitting-side absorption axis thereof when the linear polarized light within the utilized bandwidth enters at an azimuth angle of 45 degrees relative to the wires.

### TECHNICAL FIELD

The present disclosure relates to a polarizer, a display that utilizes the same, and an ultraviolet emitting apparatus.

### BACKGROUND ART

According to conventional polarizers, although absorption-type polarizers which are formed of polyvinyl alcohol in which iodine is impregnated and are elongated in one direction have been adopted, in order to efficiently utilize the backlight illumination of liquid crystals, and to brighten a screen, application of wire-grid-type polarizers as reflection-type polarizers is now taken into consideration (e.g., see Patent Document 1).

### CITATION LIST

### Patent Literatures

[Patent Document 1] WO2018/012523 A

### SUMMARY OF INVENTION

### Technical Problem

Conversely, regarding liquid crystal display devices like a liquid crystal television, a contrast at a wide view angle is desired. Moreover, in recent years, researches on head-up displays as means for directly projecting information on a human viewing field are advancing. Furthermore, in order to downsize abeam splitter for a head-up display, it is necessary to utilize light at a wide angle. Hence, there is a need to maintain the extinction ratio with respect to oblique incident light for wire-grid-type polarizers.

However, regarding wire-grid-type polarizers, although the extinction ratio with respect to incident light from a vertical direction is high, there is a disadvantage such that the extinction ratio decreases depending on an azimuth angle regarding incident light in an oblique direction. When, for example, linear polarized light with a wavelength of 550 nm is caused to enter a polarizer, as illustrated in FIG. 1, even if the incidence angle is changed when the azimuth angle is 0, a Cross Nicol transmittance remains unchanged. When, however, the azimuth angle is 45 degrees and the incidence angle is increased, the Cross Nicol transmittance increases, and the extinction ratio decreases.

Note that as illustrated in FIG. 158, the term azimuth angle (Azimuth) means an angle between the extending direction of a wire of a wire grid portion, and a component of a vector in the traveling direction of linear polarized light that enters such a portion, the component being horizontal to a wire grid surface. Moreover, the term incidence angle (Incidence) means an angle between the incident direction of linear polarized light and the normal line of the polarizer.

Hence, an objective of the present disclosure is to provide a polarizer that suppresses a decrease in extinction ratio due to leakage light in a Cross Nicol condition, a quantum dot display that utilizes the same, and an ultraviolet emitting apparatus.

### Solution to Problem

In order to accomplish the above objective, a polarizer according to the present disclosure includes:

a substrate transparent to light within a utilized bandwidth;

a wire grid portion that includes a plurality of wires which extends in a direction and which is arranged side by side at a pitch shorter than a wavelength of the light; and

a polarizing axis correcting portion which is formed of a dielectric provided at a side at which the light enters the wire grid portion, and which performs correction so as to reduce a displacement in an angle between an incidence-side transmittance axis of linear polarized light and an emitting-side absorption axis thereof when the linear polarized light within the utilized bandwidth enters at an azimuth angle of 45 degrees relative to the wires.

In this case, the polarizing axis correcting portion performs the correction so as to reduce the displacement in the angle between the incidence-side transmittance axis of the linear polarized light and the emitting-side absorption axis thereof by changing an intensity ratio between a P-wave of the incident light and an S-wave thereof.

It is preferable that, when the linear polarized light within the utilized bandwidth enters at the azimuth angle of 45 degrees and at an incidence angle of 50 degrees relative to the wires, the polarizing axis correcting portion should have a thickness that corrects the displacement in the angle between the incidence-side transmittance axis of the linear polarized light and the emitting-side absorption axis thereof to be equal to or smaller than 7 degrees, preferably, equal to or smaller than 2 degrees at all wavelengths within the utilized bandwidth.

Moreover, when the utilized bandwidth is a visual light range, it is preferable that, when the linear polarized light within the visual light range enters at the azimuth angle of 45 degrees and at an incidence angle of 40 degrees relative to the wires, the polarizing axis correcting portion should have a thickness that causes a wavelength of light which takes the minimum value of a TE transmittance to be equal to or greater than 495 nm and to be equal to or smaller than 570 nm.

Furthermore, when the utilized bandwidth is a visual light range, it is preferable that, when the linear polarized light within the visual light range enters at the azimuth angle of 45 degrees and at an incidence angle of 40 degrees relative to the wires, the polarizing axis correcting portion should have a thickness that corrects a TE transmittance of light which has a wavelength of equal to or greater than 507 nm and equal to or smaller than 555 nm to be equal to or smaller than 0.2%.

Still further, when the polarizing axis correcting portion is formed of silicon dioxide, it is preferable that the polarizing axis correcting portion should have a thickness of equal to or greater than 60 nm and equal to or smaller than 120 nm. Moreover, when the polarizing axis correcting portion is formed of silicon nitride, it is preferable that the polarizing axis correcting portion should have a thickness of equal to or greater than 40 nm and equal to or smaller than 90 nm. Furthermore, when the polarizing axis correcting portion is formed of titanium dioxide, it is preferable that the polarizing axis correcting portion should have a thickness of equal to or greater than 20 nm and equal to or smaller than 60 nm.

Moreover, the polarizing axis correcting portion may be placed on the wire grid portion at the substrate side, or at a side facing the substrate. Furthermore, the polarizing axis correcting portion may be placed on the respective tips of the wires of the wire grid portion. In this case, it is preferable that, in a cross section that is vertical to the extending direction of the wire, a cross-sectional shape of the polarizing axis correcting portion should include a part that has at least partially wider width than a width of the wire. For example, a cross-sectional shape of the polarizing axis correcting portion is formed in a reverse taper shape.

Furthermore, the wire grid portion may include an absorption layer.

A display according to the present disclosure includes:

a light source that emits blue light;

a polarizer that converts the light from the light source into linear polarized light;

a liquid crystal that changes a polarizing direction of the linear polarized light;

the polarizer according the present disclosure; and

a wavelength converter that converts the light into a red or green wavelength.

In this case, it is preferable that, when the linear polarized light enters at an azimuth angle of 45 degrees and at an incidence angle of 40 degrees relative to the wires, the polarizing axis correcting portion should have a thickness that causes a wavelength of light which takes the minimum value of a TE transmittance to be equal to or greater than 380 nm and to be equal to or smaller than 495 nm.

An ultraviolet emitting apparatus according to the present disclosure includes:

a light source that emits ultraviolet rays;

a curved mirror that reflects the ultraviolet rays emitted from the light source toward an object; and

the polarizer according to the present disclosure, in which the utilized bandwidth is the ultraviolet rays.

In this case, it is preferable that, when the linear polarized light enters at an azimuth angle of 45 degrees and at an incidence angle of 40 degrees relative to the wires, the polarizing axis correcting portion should have a thickness that causes a wavelength of light which takes the minimum value of a TE transmittance to be smaller than 380 nm.

### BRIEF DESCRIPTION OF DRAWINGS

FIG. 1 is a diagram illustrating a displacement θ of polarizing axis of a linear polarized light for each incidence angle at an azimuth angle of 45 degrees;

FIG. 2 is a diagram for describing polarizing axis correction that utilizes a change in polarizing axis due to passing through a dielectric thin film according to the present disclosure;

FIG. 3 is an outline cross-sectional view illustrating a polarizer of a model 1 according to the present disclosure;

FIG. 4 is a diagram illustrating a displacement θ of a polarizing axis relative to a wavelength for each film thickness of an SiN film at an azimuth angle of 45 degrees and at an incidence angle of 50 degrees;

FIG. 5 is a diagram illustrating a displacement θ of a polarizing axis relative to a wavelength for each incidence angle at an azimuth angle of 45 degrees relative to an SiN film;

FIG. 6 is a diagram illustrating a phase difference relative to a wavelength for each incidence angle at an azimuth angle of 45 degrees relative to an SiN film;

FIG. 7 is an outline cross-sectional view illustrating polarizers of models 2 to 4 according to the present disclosure;

FIG. 8 is a diagram illustrating a TE transmittance with respect to a wavelength for each incidence angle at an azimuth angle of 45 degrees relative to the polarizer of the model 2 according to the present disclosure;

FIG. 9 is a diagram illustrating a TE transmittance with respect to a wavelength for each incidence angle at an azimuth angle of 45 degrees relative to a polarizer of the model 3 according to the present disclosure;

FIG. 10 is a diagram illustrating a TE transmittance with respect to a wavelength for each incidence angle at an azimuth angle of 45 degrees relative to a polarizer of the model 4 according to the present disclosure;

FIG. 11 is an outline cross-sectional view illustrating polarizers of models 5 to 7 according to the present disclosure;

FIG. 12 is a diagram illustrating a TE transmittance with respect to a wavelength for each incidence angle at an azimuth angle of 45 degrees relative to the polarizer of the model 5 according to the present disclosure;

FIG. 13 is a diagram illustrating a TE transmittance with respect to a wavelength for each incidence angle at an azimuth angle of 45 degrees relative to the polarizer of the model 6 according to the present disclosure;

FIG. 14 is a diagram illustrating a TE transmittance with respect to a wavelength for each incidence angle at an azimuth angle of 45 degrees relative to the polarizer of the model 7 according to the present disclosure;

FIG. 15 is an outline cross-sectional view illustrating a polarizer of a model 8 according to the present disclosure;

FIG. 16 is a diagram illustrating a TE transmittance with respect to a wavelength for each incidence angle at an azimuth angle of 45 degrees relative to the polarizer of the model 8 according to the present disclosure;

FIG. 17 is an outline cross-sectional view illustrating polarizers of models 9 to 14 according to the present disclosure;

FIG. 18 is an outline cross-sectional view illustrating polarizers of models 14 to 16 according to the present disclosure;

FIG. 19 is a diagram illustrating a TE transmittance with respect to a wavelength for each incidence angle at an azimuth angle of 45 degrees relative to the polarizer of the model 9 according to the present disclosure;

FIG. 20 is a diagram illustrating a TE transmittance with respect to a wavelength for each incidence angle at an azimuth angle of 45 degrees relative to the polarizer of the model 10 according to the present disclosure;

FIG. 21 is a diagram illustrating a TE transmittance with respect to a wavelength for each incidence angle at an azimuth angle of 45 degrees relative to the polarizer of the model 11 according to the present disclosure;

FIG. 22 is a diagram illustrating a TE transmittance with respect to a wavelength for each incidence angle at an azimuth angle of 45 degrees relative to the polarizer of the model 12 according to the present disclosure;

FIG. 23 is a diagram illustrating a TE transmittance with respect to a wavelength for each incidence angle at an azimuth angle of 45 degrees relative to the polarizer of the model 13 according to the present disclosure;

FIG. 24 is a diagram illustrating a TE transmittance with respect to a wavelength for each incidence angle at an azimuth angle of 45 degrees relative to the polarizer of the model 14 according to the present disclosure;

FIG. 25 is a diagram illustrating a TE transmittance with respect to a wavelength for each incidence angle at an azimuth angle of 45 degrees relative to the polarizer of the model 15 according to the present disclosure;

FIG. 26 is a diagram illustrating a TE transmittance with respect to a wavelength for each incidence angle at an azimuth angle of 45 degrees relative to the polarizer of the model 16 according to the present disclosure;

FIG. 27 is a diagram illustrating a TE transmittance with respect to a wavelength for each incidence angle at an azimuth angle of 45 degrees relative to the polarizer of the model 17 according to the present disclosure;

FIG. 28 is an outline cross-sectional view illustrating polarizers of models 18 to 20 according to the present disclosure;

FIG. 29 is a diagram illustrating a TM transmittance with respect to a wavelength for each incidence angle at an azimuth angle of 45 degrees relative to the polarizer of the model 18 according to the present disclosure;

FIG. 30 is a diagram illustrating a TM transmittance with respect to a wavelength for each incidence angle at an azimuth angle of 45 degrees relative to the polarizer of the model 19 according to the present disclosure;

FIG. 31 is a diagram illustrating a TM transmittance with respect to a wavelength for each incidence angle at an azimuth angle of 45 degrees relative to the polarizer of the model 20 according to the present disclosure;

FIG. 32 is a diagram illustrating a TE transmittance with respect to a wavelength for each incidence angle at an azimuth angle of 45 degrees relative to the polarizer of the model 18 according to the present disclosure;

FIG. 33 is a diagram illustrating a TE transmittance with respect to a wavelength for each incidence angle at an azimuth angle of 45 degrees relative to the polarizer of the model 19 according to the present disclosure;

FIG. 34 is a diagram illustrating a TE transmittance with respect to a wavelength for each incidence angle at an azimuth angle of 45 degrees relative to the polarizer of the model 20 according to the present disclosure;

FIG. 35 is a diagram illustrating an extinction ratio with respect to a wavelength for each incidence angle at an azimuth angle of 45 degrees relative to the polarizer of the model 18 according to the present disclosure;

FIG. 36 is a diagram illustrating an extinction ratio with respect to a wavelength for each incidence angle at an azimuth angle of 45 degrees relative to the polarizer of the model 19 according to the present disclosure;

FIG. 37 is a diagram illustrating an extinction ratio with respect to a wavelength for each incidence angle at an azimuth angle of 45 degrees relative to the polarizer of the model 20 according to the present disclosure;

FIG. 38 is a diagram illustrating a TE transmittance with respect to an incidence angle at an azimuth angle of 45 degrees relative to the polarizers of the models 18 to 20 according to the present disclosure;

FIG. 39 is a diagram illustrating an extinction ratio with respect to an incidence angle at an azimuth angle of 45 degrees relative to the polarizers of the models 18 to 20 according to the present disclosure;

FIG. 40 is a diagram illustrating an absorption rate and reflectance of an absorption layer with respect to a TE wave;

FIG. 41 is an outline cross-sectional view illustrating polarizers of models 21 and 22 according to the present disclosure;

FIG. 42 is a diagram illustrating a TM transmittance with respect to a wavelength for each incidence angle at an azimuth angle of 45 degrees relative to the polarizer of the model 21 according to the present disclosure;

FIG. 43 is a diagram illustrating a TM transmittance with respect to a wavelength for each incidence angle at an azimuth angle of 45 degrees relative to the polarizer of the model 22 according to the present disclosure;

FIG. 44 is a diagram illustrating a TE transmittance with respect to a wavelength for each incidence angle at an azimuth angle of 45 degrees relative to the polarizer of the model 21 according to the present disclosure;

FIG. 45 is a diagram illustrating a TE transmittance with respect to a wavelength for each incidence angle at an azimuth angle of 45 degrees relative to the polarizer of the model 22 according to the present disclosure;

FIG. 46 is a diagram illustrating an extinction ratio with respect to a wavelength for each incidence angle at an azimuth angle of 45 degrees relative to the polarizer of the model 21 according to the present disclosure;

FIG. 47 is a diagram illustrating an extinction ratio with respect to a wavelength for each incidence angle at an azimuth angle of 45 degrees relative to the polarizer of the model 22 according to the present disclosure;

FIG. 48 is a diagram illustrating an extinction ratio (wavelength: 250 nm) with respect to an incidence angle at an azimuth angle of 45 degrees relative to the polarizers of the models 21 and 22 according to the present disclosure;

FIG. 49 is a diagram illustrating an extinction ratio (wavelength: 300 nm) with respect to an incidence angle at an azimuth angle of 45 degrees relative to the polarizers of the models 21 and 22 according to the present disclosure;

FIG. 50 is an SEM image that indicates a cross section of polarizers according to first to fourth examples of the present disclosure;

FIG. 51 is a diagram illustrating a TM transmittance with respect to a wavelength for each incidence angle at an azimuth angle of 45 degrees relative to the polarizer according to the first example of the present disclosure;

FIG. 52 is a diagram illustrating a TM transmittance with respect to a wavelength for each incidence angle at an azimuth angle of 45 degrees relative to the polarizer according to the second example of the present disclosure;

FIG. 53 is a diagram illustrating a TM transmittance with respect to a wavelength for each incidence angle at an azimuth angle of 45 degrees relative to the polarizer according to the third example of the present disclosure;

FIG. 54 is a diagram illustrating a TM transmittance with respect to a wavelength for each incidence angle at an azimuth angle of 45 degrees relative to the polarizer according to the fourth example of the present disclosure;

FIG. 55 is a diagram illustrating a TE transmittance with respect to a wavelength for each incidence angle at an azimuth angle of 45 degrees relative to the polarizer according to the first example of the present disclosure;

FIG. 56 is a diagram illustrating a TE transmittance with respect to a wavelength for each incidence angle at an azimuth angle of 45 degrees relative to the polarizer according to the second example of the present disclosure;

FIG. 57 is a diagram illustrating a TE transmittance with respect to a wavelength for each incidence angle at an azimuth angle of 45 degrees relative to the polarizer according to the third example of the present disclosure;

FIG. 58 is a diagram illustrating a TE transmittance with respect to a wavelength for each incidence angle at an azimuth angle of 45 degrees relative to the polarizer according to the fourth example of the present disclosure;

FIG. 59 is a diagram illustrating an extinction ratio with respect to a wavelength for each incidence angle at an azimuth angle of 45 degrees relative to the polarizer according to the first example of the present disclosure;

FIG. 60 is a diagram illustrating an extinction ratio with respect to a wavelength for each incidence angle at an azimuth angle of 45 degrees relative to the polarizer according to the second example of the present disclosure;

FIG. 61 is a diagram illustrating an extinction ratio with respect to a wavelength for each incidence angle at an azimuth angle of 45 degrees relative to the polarizer according to the third example of the present disclosure;

FIG. 62 is a diagram illustrating an extinction ratio with respect to a wavelength for each incidence angle at an azimuth angle of 45 degrees relative to the polarizer according to the fourth example of the present disclosure;

FIG. 63 is a diagram for describing an example production method of the polarizer according to the present disclosure;

FIG. 64 is a diagram for describing an example production method of the polarizer according to the present disclosure;

FIG. 65 is a schematic diagram illustrating a quantum dot display according to the present disclosure;

FIG. 66 is a schematic diagram illustrating a ultraviolet emitting apparatus according to the present disclosure;

FIG. 67 is a schematic diagram illustrating the pattern direction of a wire grid according to the present disclosure;

FIG. 68 is an outline cross-sectional view illustrating a polarizer of a model 23 according to the present disclosure;

FIG. 69 is a diagram illustrating a TE reflectance with respect to a wavelength for each Al height relative to a horizontal-line-type polarizer of the model 23 of the present disclosure;

FIG. 70 is a diagram illustrating a TE reflectance with respect to a wavelength for each Al height relative to a longitudinal-line-type polarizer of the model 23 according to the present disclosure;

FIG. 71 is a diagram illustrating a TE reflectance with respect to a wavelength for each Al height relative to an 45-degree-oblique-line-type polarizer of the model 23 according to the present disclosure;

FIG. 72 is a diagram illustrating a TM reflectance with respect to a wavelength for each Al height relative to the horizontal-line-type polarizer of the model 23 according to the present disclosure;

FIG. 73 is a diagram illustrating a TM reflectance with respect to a wavelength for each Al height relative to the longitudinal-line-type polarizer of the model 23 according to the present disclosure;

FIG. 74 is a diagram illustrating a TM reflectance with respect to a wavelength for each Al height relative to the 45-degree-oblique-line-type polarizer of the model 23 according to the present disclosure;

FIG. 75 is a diagram illustrating a reflection extinction ratio with respect to a wavelength for each Al height relative to the horizontal-line-type polarizer of the model 23 according to the present disclosure;

FIG. 76 is a diagram illustrating a reflection extinction ratio with respect to a wavelength for each Al height relative to the longitudinal-line-type polarizer of the model 23 according to the present disclosure;

FIG. 77 is a diagram illustrating a reflection extinction ratio with respect to a wavelength for each Al height relative to the 45-degree-oblique-line-type polarizer of the model 23 according to the present disclosure;

FIG. 78 is a diagram illustrating a TM transmittance with respect to a wavelength for each Al height relative to the horizontal-line-type polarizer of the model 23 according to the present disclosure;

FIG. 79 is a diagram illustrating a TM transmittance with respect to a wavelength for each Al height relative to the longitudinal-line-type polarizer of the model 23 according to the present disclosure;

FIG. 80 is a diagram illustrating a TM transmittance with respect to a wavelength for each Al height relative to the 45-degree-oblique-line-type polarizer of the model 23 according to the present disclosure;

FIG. 81 is a diagram illustrating a TE transmittance with respect to a wavelength for each Al height relative to the horizontal-line-type polarizer of the model 23 according to the present disclosure;

FIG. 82 is a diagram illustrating a TE transmittance with respect to a wavelength for each Al height relative to the longitudinal-line-type polarizer of the model 23 according to the present disclosure;

FIG. 83 is a diagram illustrating a TE transmittance with respect to a wavelength for each Al height relative to the 45-degree-oblique-line-type polarizer of the model 23 according to the present disclosure;

FIG. 84 is a diagram illustrating a transmittance extinction ratio with respect to a wavelength for each Al height relative to the horizontal-line-type polarizer of the model 23 according to the present disclosure;

FIG. 85 is a diagram illustrating a transmittance extinction ratio with respect to a wavelength for each Al height relative to the longitudinal-line-type polarizer of the model 23 according to the present disclosure;

FIG. 86 is a diagram illustrating a transmittance extinction ratio with respect to a wavelength for each Al height relative to the 45-degree-oblique-line-type polarizer of the model 23 according to the present disclosure;

FIG. 87 is an outline cross-sectional view illustrating polarizers of models 24 and 25 according to the present disclosure;

FIG. 88 is a diagram illustrating a TE reflectance with respect to a wavelength for each Fill Factor relative to the polarizer of the model 24 according to the present disclosure;

FIG. 89 is a diagram illustrating a TE reflectance with respect to a wavelength for each hard mask thickness relative to the polarizer of the model 25 according to the present disclosure;

FIG. 90 is a diagram illustrating a TM reflectance with respect to a wavelength for each Fill Factor relative to the polarizer of the model 24 according to the present disclosure;

FIG. 91 is a diagram illustrating a TM reflectance with respect to a wavelength for each hard mask thickness relative to the polarizer of the model 25 according to the present disclosure;

FIG. 92 is a diagram illustrating a reflection extinction ratio with respect to a wavelength for each Fill Factor relative to the polarizer of the model 24 according to the present disclosure;

FIG. 93 is a diagram illustrating a reflection extinction ratio with respect to a wavelength for each hard mask thickness relative to the polarizer of the model 25 according to the present disclosure;

FIG. 94 is a diagram illustrating a TM transmittance with respect to a wavelength for each Fill Factor relative to the polarizer of the model 24 according to the present disclosure;

FIG. 95 is a diagram illustrating a TM transmittance with respect to a wavelength for each hard mask thickness relative to the polarizer of the model 25 according to the present disclosure;

FIG. 96 is a diagram illustrating a transmittance extinction ratio with respect to a wavelength for each Fill Factor relative to the polarizer of the model 24 according to the present disclosure;

FIG. 97 is a diagram illustrating a transmittance extinction ratio with respect to a wavelength for each hard mask thickness relative to the polarizer of the model 25 according to the present disclosure;

FIG. 98 is an outline cross-sectional view illustrating polarizers of models 26, 27, and 28 according to the present disclosure;

FIG. 99 is a diagram illustrating a TE reflectance with respect to a wavelength for each incidence angle relative to the polarizer of the model 26 according to the present disclosure;

FIG. 100 is a diagram illustrating a TE reflectance with respect to a wavelength for each incidence angle relative to the polarizer of the model 27 according to the present disclosure;

FIG. 101 is a diagram illustrating a TE reflectance with respect to a wavelength for each incidence angle relative to the polarizer of the model 28 according to the present disclosure;

FIG. 102 is a diagram illustrating a TM reflectance with respect to a wavelength for each incidence angle relative to the polarizer of the model 26 according to the present disclosure;

FIG. 103 is a diagram illustrating a TM reflectance with respect to a wavelength for each incidence angle relative to the polarizer of the model 27 according to the present disclosure;

FIG. 104 is a diagram illustrating a TM reflectance with respect to a wavelength for each incidence angle relative to the polarizer of the model 28 according to the present disclosure;

FIG. 105 is a diagram illustrating a reflection extinction ratio with respect to a wavelength for each incidence angle relative to the polarizer of the model 26 according to the present disclosure;

FIG. 106 is a diagram illustrating a reflection extinction ratio with respect to a wavelength for each incidence angle relative to the polarizer of the model 27 according to the present disclosure;

FIG. 107 is a diagram illustrating a reflection extinction ratio with respect to a wavelength for each incidence angle relative to the polarizer of the model 28 according to the present disclosure;

FIG. 108 is a diagram illustrating a transmittance extinction ratio with respect to a wavelength for each incidence angle relative to the polarizer of the model 26 according to the present disclosure;

FIG. 109 is a diagram illustrating a transmittance extinction ratio with respect to a wavelength for each incidence angle relative to the polarizer of the model 27 according to the present disclosure;

FIG. 110 is a diagram illustrating a transmittance extinction ratio with respect to a wavelength for each incidence angle relative to the polarizer of the model 28 according to the present disclosure;

FIG. 111 is an outline cross-sectional view illustrating polarizers of models 29, 30, and 31 according to the present disclosure;

FIG. 112 is a diagram illustrating a TE reflectance with respect to a wavelength for each incidence angle relative to the polarizer of the model 29 according to the present disclosure;

FIG. 113 is a diagram illustrating a TE reflectance with respect to a wavelength for each incidence angle relative to the polarizer of the model 30 according to the present disclosure;

FIG. 114 is a diagram illustrating a TE reflectance with respect to a wavelength for each incidence angle relative to the polarizer of the model 31 according to the present disclosure;

FIG. 115 is a diagram illustrating a TM reflectance with respect to a wavelength for each incidence angle relative to the polarizer of the model 29 according to the present disclosure;

FIG. 116 is a diagram illustrating a TM reflectance with respect to a wavelength for each incidence angle relative to the polarizer of the model 30 according to the present disclosure;

FIG. 117 is a diagram illustrating a TM reflectance with respect to a wavelength for each incidence angle relative to the polarizer of the model 31 according to the present disclosure;

FIG. 118 is a diagram illustrating a reflection extinction ratio with respect to a wavelength for each incidence angle relative to the polarizer of the model 29 according to the present disclosure;

FIG. 119 is a diagram illustrating a reflection extinction ratio with respect to a wavelength for each incidence angle relative to the polarizer of the model 30 according to the present disclosure;

FIG. 120 is a diagram illustrating a reflection extinction ratio with respect to a wavelength for each incidence angle relative to the polarizer of the model 31 according to the present disclosure;

FIG. 121 is a diagram illustrating a TM transmittance with respect to a wavelength for each incidence angle relative to the polarizer of the model 29 according to the present disclosure;

FIG. 122 is a diagram illustrating a TM transmittance with respect to a wavelength for each incidence angle relative to the polarizer of the model 30 according to the present disclosure;

FIG. 123 is a diagram illustrating a TM transmittance with respect to a wavelength for each incidence angle relative to the polarizer of the model 31 according to the present disclosure;

FIG. 124 is a diagram illustrating a transmittance extinction ratio with respect to a wavelength for each incidence angle relative to the polarizer of the model 29 according to the present disclosure;

FIG. 125 is a diagram illustrating a transmittance extinction ratio with respect to a wavelength for each incidence angle relative to the polarizer of the model 30 according to the present disclosure;

FIG. 126 is a diagram illustrating a transmittance extinction ratio with respect to a wavelength for each incidence angle relative to the polarizer of the model 31 according to the present disclosure;

FIG. 127 is an outline cross-sectional view illustrating polarizers of models 30, 31, and 32 according to the present disclosure;

FIG. 128 is a diagram illustrating a reflection extinction ratio with respect to a wavelength for each azimuth angle at an incidence angle of 45 degrees relative to the polarizer of the model 30 according to the present disclosure;

FIG. 129 is a diagram illustrating a reflection extinction ratio with respect to a wavelength for each azimuth angle at an incidence angle of 45 degrees relative to the polarizer of the model 31 according to the present disclosure;

FIG. 130 is a diagram illustrating a reflection extinction ratio with respect to a wavelength for each azimuth angle at an incidence angle of 45 degrees relative to the polarizer of the model 32 according to the present disclosure;

FIG. 131 is a diagram illustrating a transmittance extinction ratio with respect to a wavelength for each azimuth angle at an incidence angle of 45 degrees relative to the polarizer of the model 30 according to the present disclosure;

FIG. 132 is a diagram illustrating a transmittance extinction ratio with respect to a wavelength for each azimuth angle at an incidence angle of 45 degrees relative to the polarizer of the model 31 according to the present disclosure;

FIG. 133 is a diagram illustrating a transmittance extinction ratio with respect to a wavelength for each azimuth angle at an incidence angle of 45 degrees relative to the polarizer of the model 32 according to the present disclosure;

FIG. 134 is a diagram illustrating a reflection extinction ratio with respect to a wavelength for each azimuth angle at an incidence angle of 40 degrees relative to the polarizer of the model 30 according to the present disclosure;

FIG. 135 is a diagram illustrating a reflection extinction ratio with respect to a wavelength for each azimuth angle at an incidence angle of 40 degrees relative to the polarizer of the model 31 according to the present disclosure;

FIG. 136 is a diagram illustrating a reflection extinction ratio with respect to a wavelength for each azimuth angle at an incidence angle of 40 degrees relative to the polarizer of the model 32 according to the present disclosure;

FIG. 137 is a diagram illustrating a transmittance extinction ratio with respect to a wavelength for each azimuth angle at an incidence angle of 40 degrees relative to the polarizer of the model 30 according to the present disclosure;

FIG. 138 is a diagram illustrating a transmittance extinction ratio with respect to a wavelength for each azimuth angle at an incidence angle of 40 degrees relative to the polarizer of the model 31 according to the present disclosure;

FIG. 139 is a diagram illustrating a transmittance extinction ratio with respect to a wavelength for each azimuth angle at an incidence angle of 40 degrees relative to the polarizer of the model 32 according to the present disclosure;

FIG. 140 is a diagram illustrating a reflection extinction ratio with respect to a wavelength for each azimuth angle at an incidence angle of 50 degrees relative to the polarizer of the model 30 according to the present disclosure;

FIG. 141 is a diagram illustrating a reflection extinction ratio with respect to a wavelength for each azimuth angle at an incidence angle of 50 degrees relative to the polarizer of the model 31 according to the present disclosure;

FIG. 142 is a diagram illustrating a reflection extinction ratio with respect to a wavelength for each azimuth angle at an incidence angle of 50 degrees relative to the polarizer of the model 32 according to the present disclosure;

FIG. 143 is a diagram illustrating a transmittance extinction ratio with respect to a wavelength for each azimuth angle at an incidence angle of 50 degrees relative to the polarizer of the model 30 according to the present disclosure;

FIG. 144 is a diagram illustrating a transmittance extinction ratio with respect to a wavelength for each azimuth angle at an incidence angle of 50 degrees relative to the polarizer of the model 31 according to the present disclosure;

FIG. 145 is a diagram illustrating a transmittance extinction ratio with respect to a wavelength for each azimuth angle at an incidence angle of 50 degrees relative to the polarizer of the model 32 according to the present disclosure;

FIG. 146 is a diagram illustrating a reflection extinction ratio with respect to a wavelength for each azimuth angle at an incidence angle of 35 degrees relative to the polarizer of the model 30 according to the present disclosure;

FIG. 147 is a diagram illustrating a reflection extinction ratio with respect to a wavelength for each azimuth angle at an incidence angle of 35 degrees relative to the polarizer of the model 31 according to the present disclosure;

FIG. 148 is a diagram illustrating a reflection extinction ratio with respect to a wavelength for each azimuth angle at an incidence angle of 35 degrees relative to the polarizer of the model 32 according to the present disclosure;

FIG. 149 is a diagram illustrating a transmittance extinction ratio with respect to a wavelength for each azimuth angle at an incidence angle of 35 degrees relative to the polarizer of the model 30 according to the present disclosure;

FIG. 150 is a diagram illustrating a transmittance extinction ratio with respect to a wavelength for each azimuth angle at an incidence angle of 35 degrees relative to the polarizer of the model 31 according to the present disclosure;

FIG. 151 is a diagram illustrating a transmittance extinction ratio with respect to a wavelength for each azimuth angle at an incidence angle of 35 degrees relative to the polarizer of the model 32 according to the present disclosure;

FIG. 152 is a diagram illustrating a reflection extinction ratio with respect to a wavelength for each azimuth angle at an incidence angle of 55 degrees relative to the polarizer of the model 30 according to the present disclosure;

FIG. 153 is a diagram illustrating a reflection extinction ratio with respect to a wavelength for each azimuth angle at an incidence angle of 55 degrees relative to the polarizer of the model 31 according to the present disclosure;

FIG. 154 is a diagram illustrating a reflection extinction ratio with respect to a wavelength for each azimuth angle at an incidence angle of 55 degrees relative to the polarizer of the model 32 according to the present disclosure;

FIG. 155 is a diagram illustrating a transmittance extinction ratio with respect to a wavelength for each azimuth angle at an incidence angle of 55 degrees relative to the polarizer of the model 30 according to the present disclosure;

FIG. 156 is a diagram illustrating a transmittance extinction ratio with respect to a wavelength for each azimuth angle at an incidence angle of 55 degrees relative to the polarizer of the model 31 according to the present disclosure;

FIG. 157 is a diagram illustrating a transmittance extinction ratio with respect to a wavelength for each azimuth angle at an incidence angle of 55 degrees relative to the polarizer of the model 32 according to the present disclosure; and

FIG. 158 is a schematic diagram for describing an incidence angle and an azimuth angle.

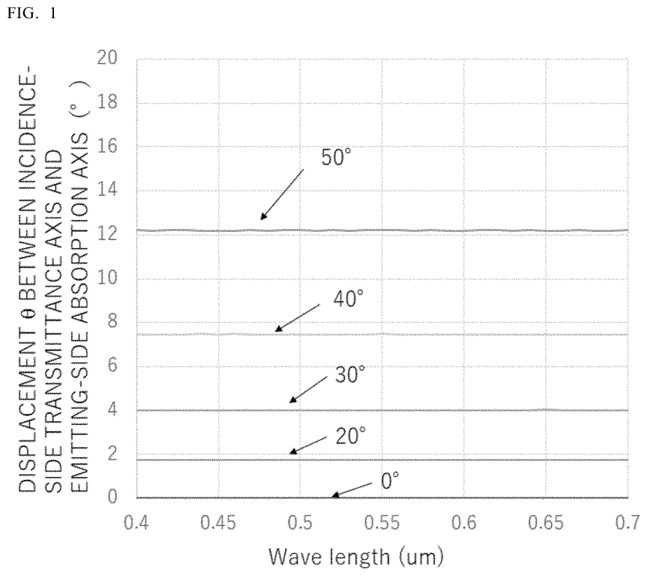

### DESCRIPTION OF EMBODIMENTS

A polarizer according to the present disclosure will be described below. The polarizer according to the present disclosure mainly includes, for example, as illustrated in FIG. 3, a substrate 1, a wire grid portion 2, and a polarizing axis correcting portion 3.

The substrate 1 directly or indirectly supports the wire grid portion 2. An applicable material for the substrate 1 is not limited to any particular material as long as it is transparent to light in a utilized bandwidth, but when light in the utilized bandwidth is visual light and ultraviolet rays, for example, SiO₂ is applicable.

Moreover, the wire grid portion 2 has a plurality of wires 21 which extends in one direction and which is arranged side by side at a shorter pitch than the wavelength of light in the utilized bandwidth. In the case of, for example, visual light and ultraviolet rays, it is appropriate if the wires 21 are arranged side by side at a pitch of 100 nm. An applicable material for the wire grid portion 2 is not limited to any particular material as long as it can adjust polarization, but for example, metal or metal oxide, such as aluminum (Al), silver (Ag), tungsten (W), amorphous silicon, and titanium oxide (TiO2), are applicable.

Moreover, the polarizing axis correcting portion 3 performs correction so as to reduce a displacement θ of a polarizing axis of linear polarized light when the linear polarized light in the utilized bandwidth enters at an azimuth angle of 45 degrees relative to the wires 21. The term azimuth angle means an angle between the extending direction of the wires of the wire grid portion, and a horizontal direction component of, to a wire grid surface, a vector in the traveling direction of the incident linear polarized light. Moreover, the term incidence angle means an angle between the incident direction of the linear polarized light and the normal line of the polarizer. Furthermore, the term displacement θ of the polarizing axis means an angle between an incidence-side transmittance axis and an emitting-side absorption axis.

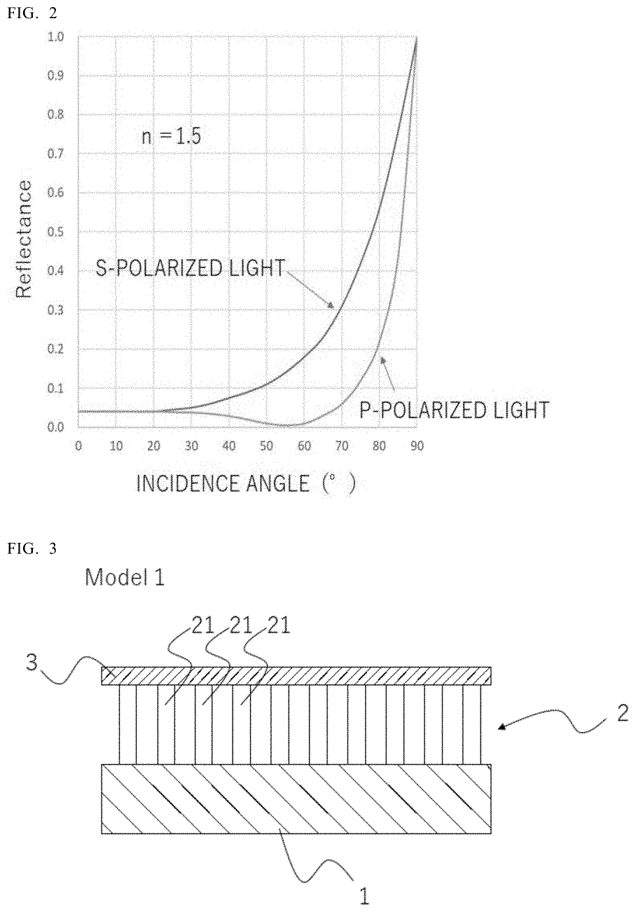

When oblique light enters the surface of a material that has a different refractive index, as illustrated in FIG. 2, a P-wave that has a parallel electric field to an incidence plane and an S-wave that is vertical to the incidence plane have different reflectance. Hence passing-through linear polarized light has changed intensities of the P-wave and of the S-wave relative to those of incident light, and thus a polarizing axis changes. By utilizing this phenomenon, a correction can be performed in such a way that the displacement θ of the polarizing axis of the linear polarized light is reduced. Regarding the polarizing axis correcting portion 3, a thin film formed of a dielectric may be placed at a side where light enters relative to the wire grid portion 2. Such a thin film may be placed at the substrate-1 side of the wire grid portion 2, or may be placed at the opposite side, i.e., a side of the wire grid portion 2 facing the substrate 1. Moreover, when such a thin film is placed at the opposing side of the wire grid portion 2 to the substrate 1, the thin film may be placed on respective tips of the wires 21 of the wire grid portion 2. In this case, it is preferable that the cross-sectional shape of the polarizing axis correcting portion 3 should have a larger portion than the width of the wire 21. Note that, in this specification, the term cross-sectional shape means a shape of a cross section vertical to the extending direction of the wire 21.

Moreover, it is preferable that the polarizing axis correcting portion 3 should be formed in a thickness capable of sufficiently correcting the displacement θ of the polarizing axis when the linear polarized light in the utilized bandwidth enters at the azimuth angle of 45 degrees relative to the wires 21. More specifically, a thickness capable of, when the linear polarized light in the utilized bandwidth enters at the azimuth angle of 45 degrees and at the incidence angle of 50 degrees relative to the wires 21, correcting the displacement θ of the polarizing axis to be equal to or smaller than 7 degrees at all wavelengths within the utilized bandwidth, preferably, equal to or smaller than 4 degrees, and more preferably, equal to or smaller than 3 degrees, and further preferably, equal to or smaller than 2 degrees, is preferable.

Moreover, the applied dielectric for the polarizing axis correcting unit 3 is not limited to any particular dielectric as long as, when light in the utilized bandwidth enters at the azimuth angle of 45 degrees relative to the wires 21, the polarizing axis for the wire grid portion 2 can be corrected. For example, silicon nitride (SiN), silicon dioxide (SiO₂), and titanium oxide (TiO₂), etc., are applicable. It is preferable that the thickness of the polarizing axis correcting portion 3 should be 40 to 90 nm when the polarizing axis correcting portion 3 is formed of silicon nitride (SiN), 60 to 120 nm when formed of silicon dioxide (SiO₂), and 20 to 60 nm when formed of titanium oxide (TiO₂). It is apparent that other applicable dielectrics for the polarizing axis correcting portion 3 are metal oxides, such as tantalum pentoxide (Ta₂O₅), oxidization hafnium (HfO₂), and zirconium dioxide (ZrO₂), and various glasses, and the like.

Moreover, it is preferable that the polarizing axis correcting portion 3 should be formed in a thickness that causes a Cross Nicol transmittance of the whole lights in the utilized bandwidth to be equal to or smaller than 1.0%, preferably, to be equal to or smaller than 0.8%, and more preferably, to be equal to or smaller than 0.7% when the linear polarized light in the utilized bandwidth enters at the azimuth angle of 45 degrees and at the incidence angle of 40 degrees relative to the wires 21.

Furthermore, it is preferable that the polarizing axis correcting portion 3 should be formed in a thickness that causes the minimum value of the Cross Nicol transmittance of the light in the utilized bandwidth to be equal to or smaller than 0.2% when the linear polarized light in the utilized bandwidth enters at the azimuth angle of 45 degrees and at the incidence angle of 40 degrees relative to the wires 21. When, in particular, the wavelength of the light that is desired to suppress a Cross Nicol transmittance is known beforehand, it is appropriate to cause a wavelength that indicates the minimum value of the Cross Nicol transmittance to match the wavelength of light desired to suppress a Cross Nicol transmittance. For example, there is a definition that is a relative luminous efficiency which represents, as a value, the intensity of brightness feeling by a human eye for each wavelength of light. According to this definition, a human feels most intensively green light with a wavelength of 495 nm to 570 nm. In particular, a human feels most intensively light around 555 nm at a bright place, and feels most intensively light around 507 nm at a dark place. Hence, it is preferable that the thickness of the polarizing axis correcting portion 3 should be adjusted in such a way that, when the utilized bandwidth of the polarizer is a visual light range, the wavelength of light which takes the minimum value of the Cross Nicol transmittance becomes equal to or greater than 495 nm and equal to or smaller than 570 nm, preferably, equal to or greater than 507 nm and equal to or smaller than 555 nm.

The thickness of the polarizing axis correcting portion 3 as described above can be decided by creating and checking various thicknesses in practice, and by calculation using an optical simulation software, and the like.

Next, the optical characteristics of the polarizer according to the present disclosure were calculated by simulation. A software DiffractMOD available from synopsis (synopsys, Inc) was applied for the simulation.

[Simulation 1]

First of all, using the simulation software, effects of the polarizing axis correcting portion 3 of the polarizer on the displacement θ of the polarizing axis, and on a phase difference were calculated. An assumed polarizer (model 1) included, as illustrated in FIG. 3, the polarizing axis correcting portion 3 which was a thin film formed of silicon nitride (SiN) and which was formed on the upper part of the wire grid portion 2.

Simulation 1-1

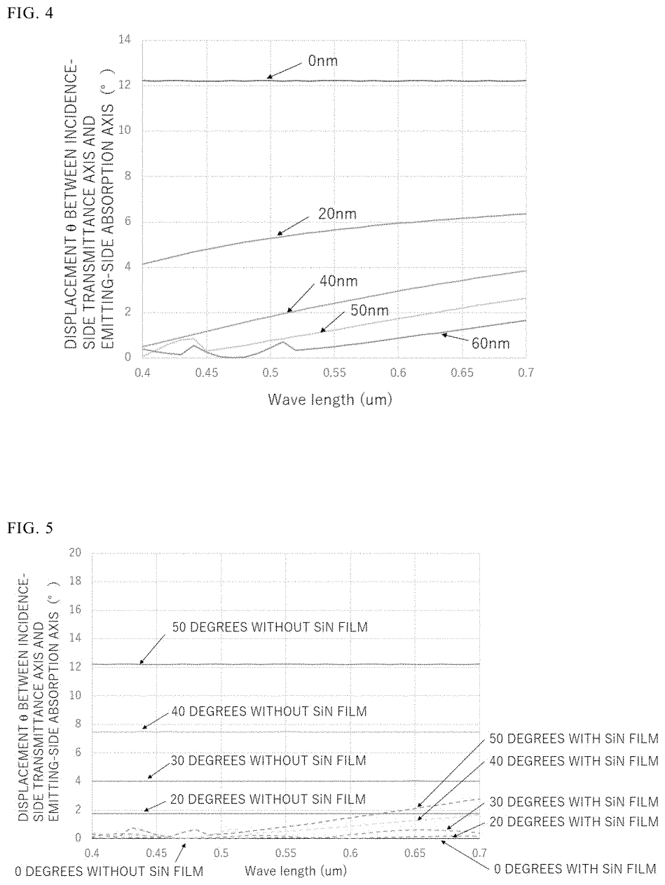

First, a simulation was made for, for each film thickness of the polarizing axis correcting portion 3, the displacement θ of an angle between an incidence-side transmittance axis and an emitting-side absorption axis with respect to the wavelength of the linear polarized light when this linear polarized light enters the wire grid portion 2 from the polarizing-axis-correcting-portion-3 side at the azimuth angle of 45 degrees and at the incidence angle of 50 degrees relative to the polarizer. The results are shown in FIG. 4.

As is clear from FIG. 4, it becomes apparent that the greater the film thickness of the polarizing axis correcting portion 3 becomes, the more the displacement θ of the polarizing can be reduced. More specifically, it becomes apparent that, when there is no polarizing axis correcting portion 3, the displacement θ of the polarizing axis is equal to or greater than 12 degrees, but when the film thickness of the polarizing axis correcting portion 3 becomes 20 nm, the displacement θ of the polarizing axis can be reduced to be equal to or smaller than 7 degrees with respect to the wavelength within the visual light range. Moreover, it becomes also apparent that, when the film thickness of the polarizing axis correcting portion 3 becomes 60 nm, the displacement θ of the polarizing axis can be reduced to be equal to or smaller than 2 degrees with respect to the wavelength within the visual light range.

Simulation 1-2

Next, a simulation was made for, for each incidence angle, the displacement θ of an angle between the incidence-side transmittance axis and the emitting-side absorption axis with respect to the wavelength of the linear polarized light when the film thickness of the polarizing axis correcting portion 3 of the above-described polarizer is 60 nm, and such linear polarized light enters the wire grid portion 2 from the polarizing-axis-correcting-portion-3 side at the azimuth angle of 45 degrees relative to the polarizer. The results are shown in FIG. 5.

As shown in FIG. 5, it becomes apparent that, when there is no polarizing axis correcting portion 3, the greater the incidence angle is, the greater the value of the displacement θ of the polarizing axis becomes, but when there is the polarizing axis correcting portion 3, even if the incidence angle becomes large, the displacement θ of the polarizing axis can be sufficiently reduced.

Simulation 1-3

Next, a simulation was made for, for each incidence angle, a change in phase difference with respect to the wavelength of the linear polarized light when the film thickness of the polarizing axis correcting portion 3 of the above-described polarizer is 60 nm, and such linear polarized light enters the wire grid portion 2 from the polarizing-axis-correcting-portion-3 side at the azimuth angle of 45 degrees relative to the polarizer. The results are shown in FIG. 6.

As shown in FIG. 6, there is substantially no difference in phase difference depending on the presence or absence of the polarizing axis correcting portion 3. Hence, it becomes apparent that even if the polarizing axis correcting portion 3 is provided, the linear polarized light is maintained.

[Simulation 2]

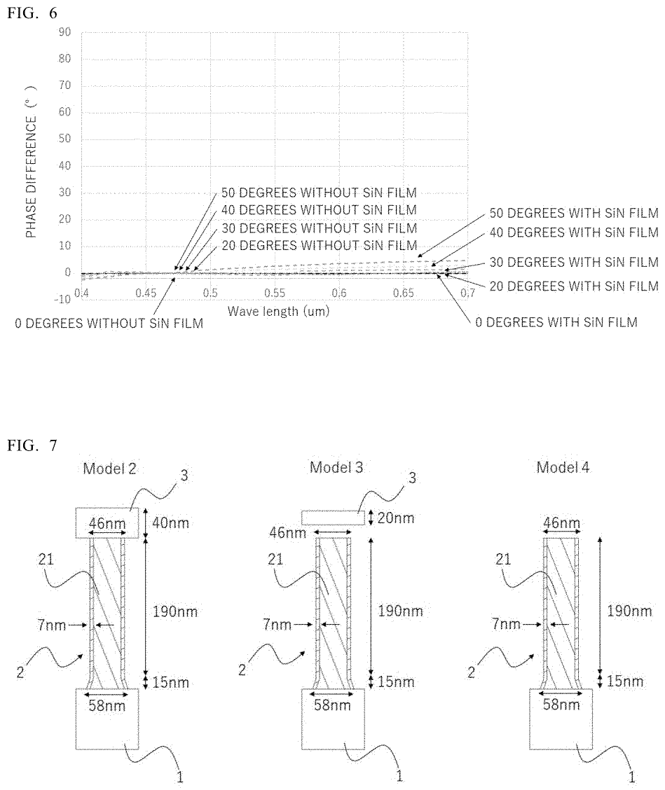

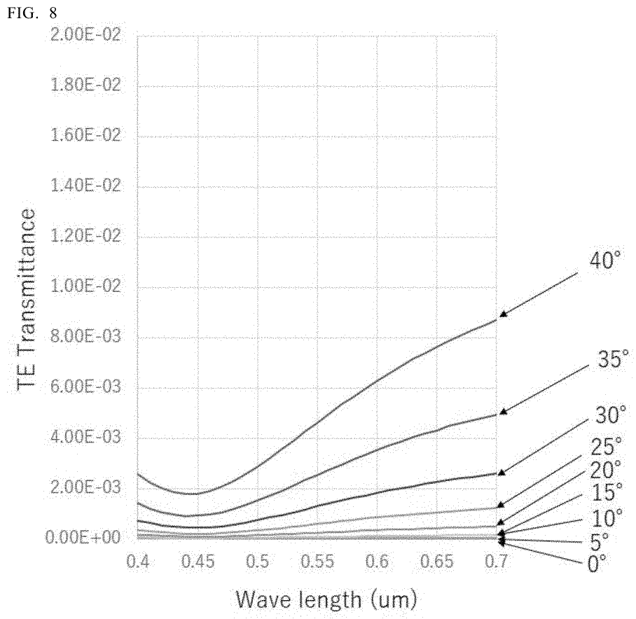

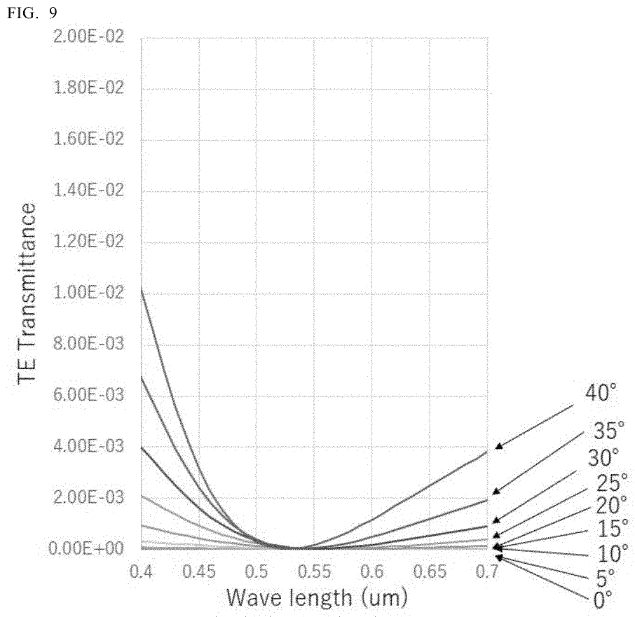

Next, using the simulation software, effects of the polarizing axis correcting portion 3 of the polarizer on a TE transmittance (i.e., a Cross Nicol transmittance) were calculated. As illustrated in FIG. 7, an assumed polarizer included the substrate 1 formed of silicon dioxide, the wire grid portion 2 which was formed thereon, had the center part formed of aluminum, and had the side faces formed of aluminum oxide that was a natural-oxidation film, and the polarizing axis correcting portion 3 that was a thin film of silicon nitride (SiN) formed thereon. In this case, the wires 21 of the wire grid portion 2 had a pitch of 100 nm and each included a base portion that had a trapezoidal cross-sectional shape vertical to the extending direction of the wires 21, and a body portion in a rectangular shape. Moreover, the base portion had a height of 15 nm, had a width of 58 nm at the base-material side, and had a width of 46 nm at the body-portion side. Furthermore, the body portion had a height of 190 nm, and had a width of 46 nm from the base-portion side to a surface side. Moreover, both sides of the aluminum oxide had a width of 7 nm. The assumed polarizing axis correcting portions 3 were a thin film that had a film thickness of 40 nm and formed right above the wires 21 (model 2), and a thin film that had a film thickness of 20 nm and placed with a gap of 30 nm from the respective tips of the wires 21 (model 3). Still further, an assumed comparative example had no polarizing axis correcting portion 3 (model 4).

A simulation was made for, for each incidence angle, the TE transmittance with respect to the wavelength of the linear polarized light when such linear polarized light enters in the wire grid portion 2 from the polarizing-axis-correcting-portion-3 side at the azimuth angle of 45 degrees relative to each of the above-described polarizers. The results are shown in FIGS. 8 to 10.

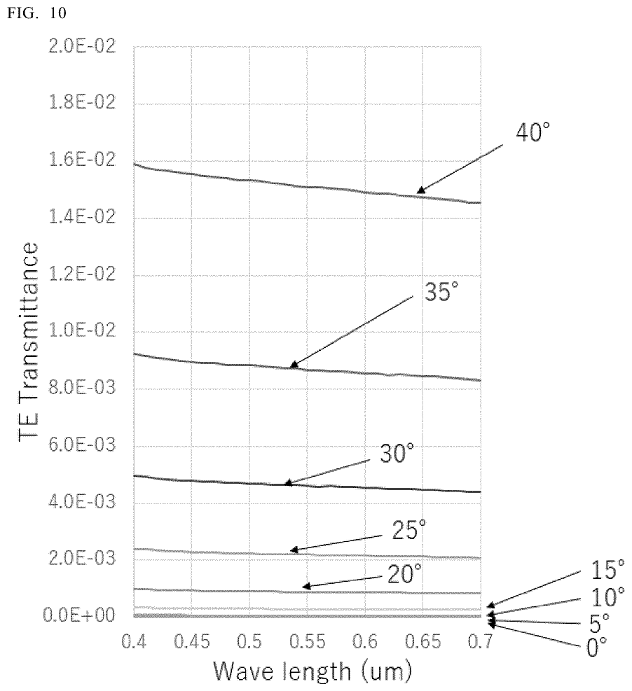

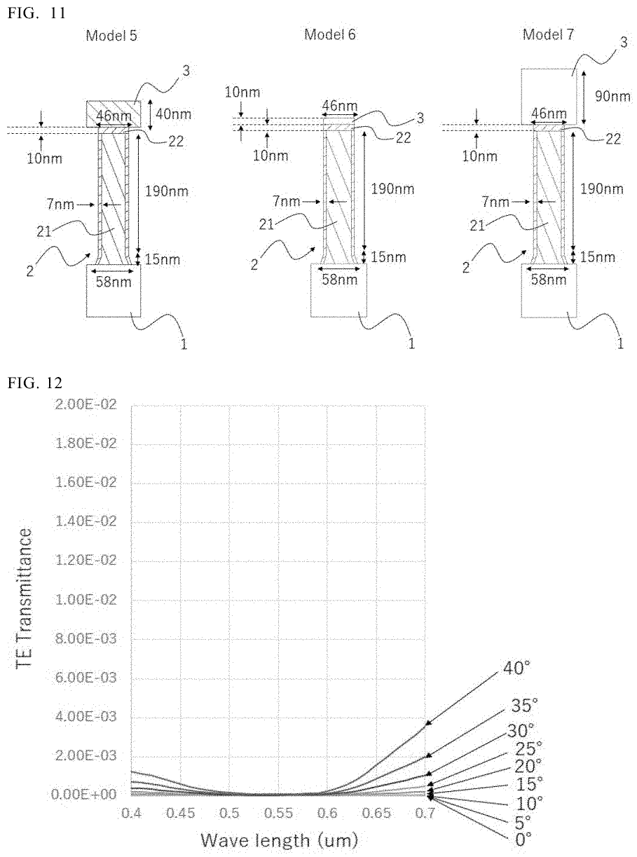

As shown in FIGS. 8 and 9, it becomes apparent that, according to the polarizer which has the polarizing axis correcting portion 3, the TE transmittance is low in comparison with the polarizer that has no polarizing axis correcting portion 3 as illustrated in FIG. 10. Moreover, it becomes also apparent that even if the polarizing axis correcting portion 3 has the gap from the wire grid portions 2, the effect is achievable.

[Simulation 3]

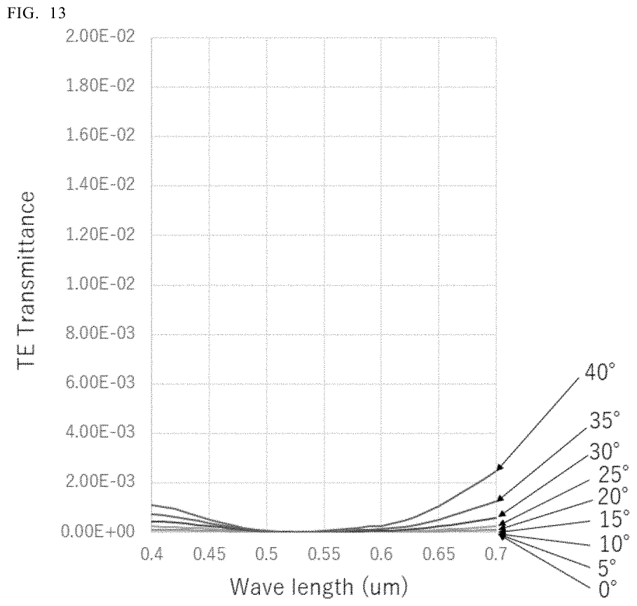

Next, in the polarizer that included an absorption-type wire grid, an effect of the polarizing axis correcting portion 3 on the TE transmittance (i.e., the Cross Nicol transmittance) was calculated using the simulation software. The assumed polarizer included, as illustrated in FIG. 11, the substrate 1 formed of silicon dioxide, the wire grid portion 2 formed thereon, having the center portion formed of aluminum, having the side faces formed of aluminum oxide that was a natural-oxidation film, and having an absorption layer 22 at a vertex and formed of germanium, and the polarizing axis correcting portion 3 which was a thin film of silicon nitride (SiN) or silicon dioxide (SiO₂) formed thereon. In this case, the wires 21 of the wire grid portion 2 had a pitch of 100 nm and each included a base portion that had a trapezoidal cross-sectional shape vertical to the extending direction of the wires 21, and a body portion in a rectangular shape. Moreover, the base portion had a height of 15 nm, had a width of 58 nm at the base-material side, and had a width of 46 nm at the body-portion side. Furthermore, the body portion had a height of 190 nm, and had a width of 46 nm from the base-portion side to a surface side. Moreover, both sides of the aluminum oxide had a width of 7 nm. Still further, the absorption layer 22 had a rectangular cross-sectional shape, had a height of 10 nm, and had a width of 46 nm. Assumed polarizing axis correcting portions 3 were: a thin film which was formed of silicon nitride (SiN), had a film thickness of 40 nm, and placed on the respective tips of the wires 21 (model 5); a thin film which was formed of silicon dioxide (SiO₂), had a film thickness of 10 nm, and placed on the respective tips of the wires 21 (model 6); and a thin film which had a film thickness of 90 nm and placed on the respective tips of the wires 21 (model 7).

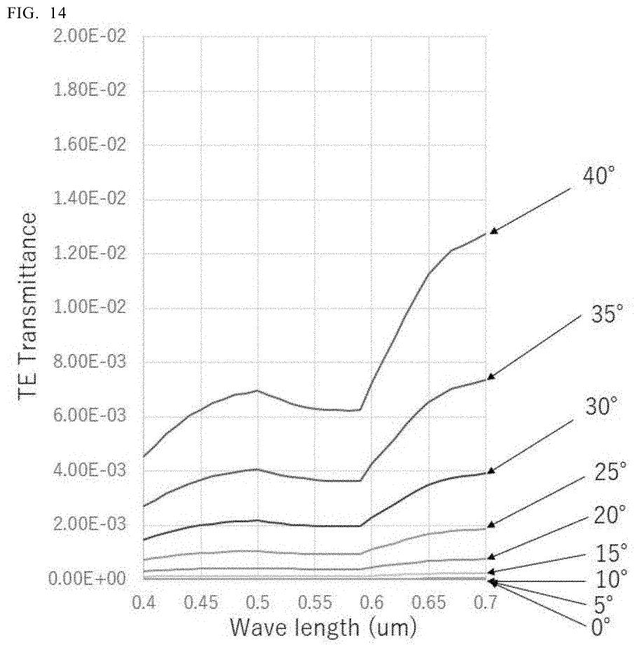

A simulation was made for, for each incidence angle, the TE transmittance with respect to the wavelength of the linear polarized light when the linear polarized light enters the wire grid portion 2 from the polarizing-axis-correcting-portion-3 side at the azimuth angle of 45 degrees relative to each of the above-described polarizers. The results are shown in FIGS. 12 to 14.

It becomes apparent that, as shown in FIGS. 12 to 14, even if the wire grid portion 2 includes the absorption layer 22, the TE transmittance can be reduced. Moreover, it becomes also apparent that the absorption-type polarizer that is the model 5 which includes the absorption layer 22 has a higher reduction effect on the TE transmittance in comparison with reflection type polarizer that is the model 2.

[Simulation 4]

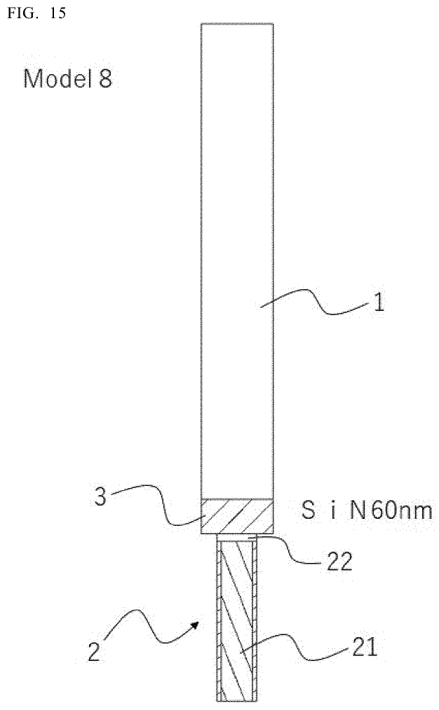

Next, using the simulation software, the TE transmittance (i.e., the Cross Nicol transmittance) when, in the polarizer that included the absorption-type wire grid, the polarizing axis correcting portion 3 is provided between the substrate 1 and the wire grid portion 2 was calculated. The assumed polarizer included, as illustrated in FIG. 15, the substrate 1 formed of silicon dioxide (SiO₂), and the wire grid portion 2 which had the center part formed of aluminum, had the side faces formed of aluminum oxide that was a natural-oxidation film, and had the absorption layer 22 which was formed of germanium and formed at the polarizing-axis-correcting-portion-3 side. The assumed polarizing axis correcting portion 3 was a thin film formed of silicon nitride (SiN). In this case, the wires 21 of the wire grid portion 2 had a pitch of 100 nm, each had a vertical rectangular cross-sectional shape to the extending direction of the wires 21, had a height of 205 nm and had a width of 46 nm. Moreover, both sides of the aluminum oxide had a width of 7 nm. Furthermore, the absorption layer 22 had a height of 10 nm, and had a width of 46 nm. The polarizing axis correcting portion 3 was a thin film that had a thickness of 60 nm (model 8).

A simulation was made for, for each incidence angle, the TE transmittance with respect to the wavelength of the linear polarized light when the linear polarized light enters the wire grid portion 2 from the substrate-1 side at the azimuth angle of 45 degrees relative to each of the above-described polarizer. The results are shown in FIG. 16.

It becomes apparent that, as shown in FIG. 16, even if the polarizing axis correcting portion 3 is provided between the substrate 1 and the wire grid portion 2, the TE transmittance can be reduced.

[Simulation 5]

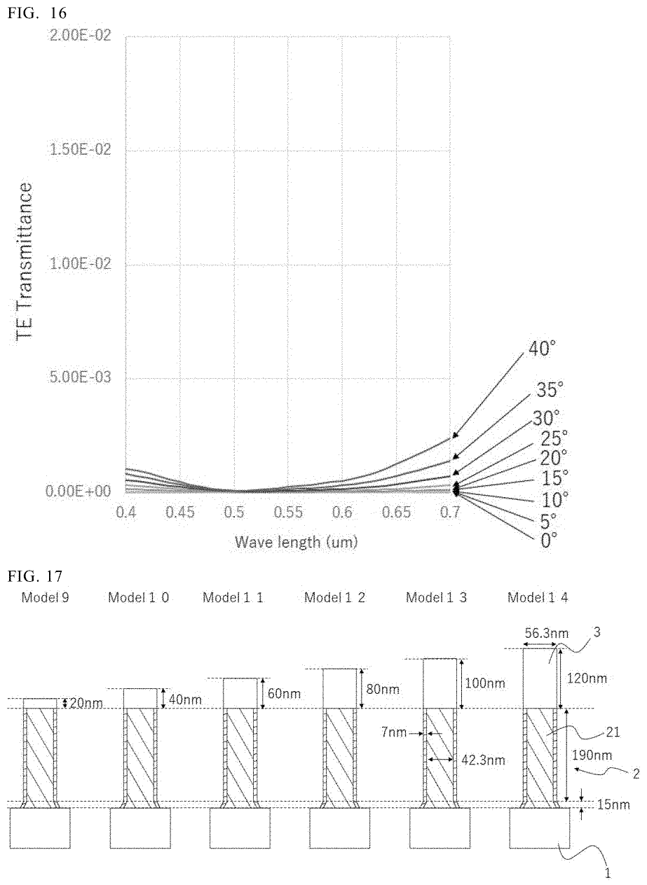

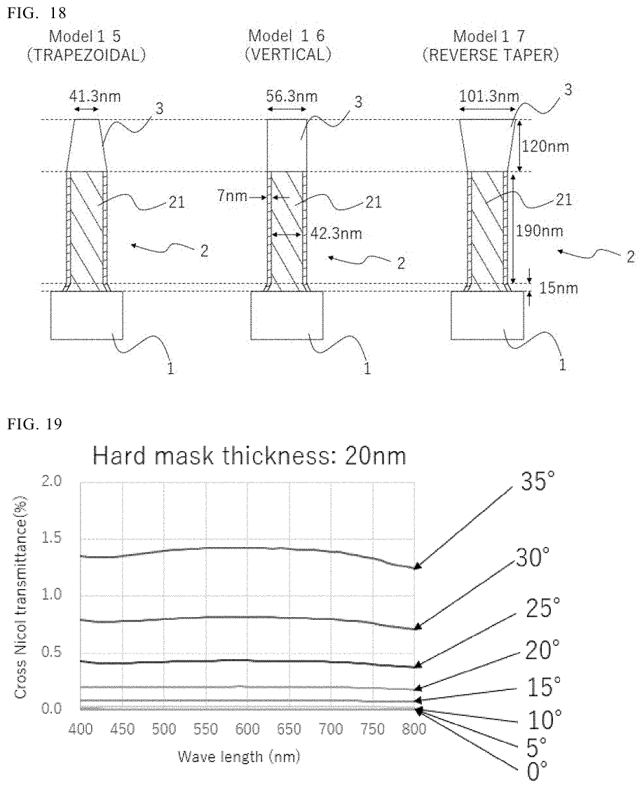

Next, using the simulation software, an effect of the polarizing axis correcting portion 3 on the TE transmittance (i.e., the Cross Nicol transmittance) in the polarizer that included the wire grid was calculated. The assumed polarizer included, as illustrated in FIGS. 17 and 18, the substrate 1 formed of silicon dioxide, the wire grid portion 2 formed thereon, having the center part formed of aluminum, and having the side faces formed of aluminum oxide that was a natural-oxidation film, and further the polarizing axis correcting portion 3 which was formed on respective tips of the wires 21 and which was a layer of silicon dioxide (SiO₂). In this case, the wires 21 of the wire grid portion 2 had a pitch of 100 nm and each included a base portion that had a trapezoidal cross-sectional shape vertical to the extending direction of the wires 21, and a body portion formed in a rectangular shape. Moreover, the base portion had a height of 15 nm and had a width of 68.3 nm at the base-material side, and 56.3 nm at the body-portion side. Furthermore, the body portion had a height of 190 nm, and had a width of 56.3 nm from the base-portion side to a surface side. Still further, both sides of aluminum oxide had a width of 7 nm. The assumed polarizing axis correcting portions 3 were: layers each formed of silicon dioxide (SiO₂), had a rectangular cross-sectional shape, and had a height from 20 nm to 120 nm 20 nm changed 20 nm by 20 nm, and placed on the respective tips of the wires 21 (models 9 to 14); a layer which had a tapered cross-sectional shape, had a width of 56.3 nm at the wire-21 side and 41.3 nm at the tip side, and had a thickness of 120 nm, and placed on the respective tips of the wires 21 (model 15); a layer which had a rectangular cross-sectional shape, had a width of 56.3 nm, and had a height of 120 nm, and placed on the respective tips of the wires 21 (model 16); and a layer which had a reverse taper cross-sectional shape, had a width of 56.3 nm at the wire-21 side, and 101.3 nm at the tip side, and had a height of 120 nm, and placed on the respective tips of the wires 21 (model 17).

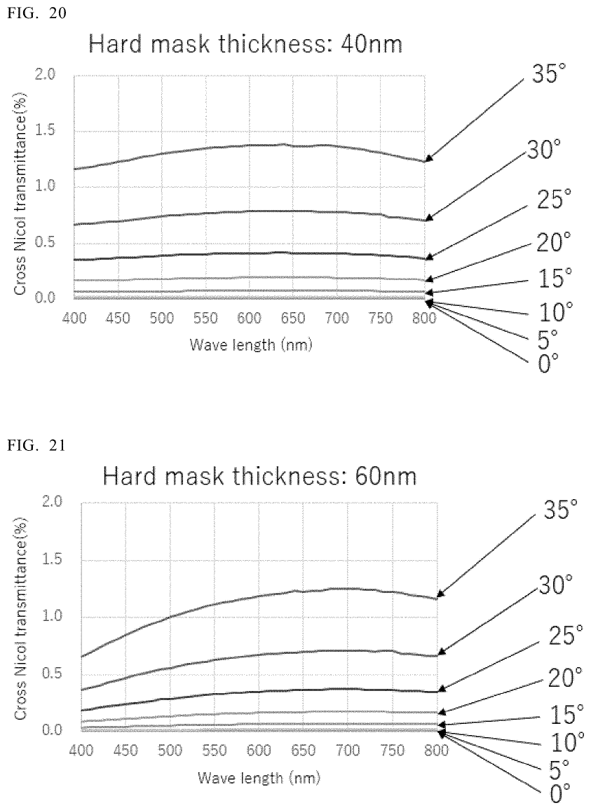

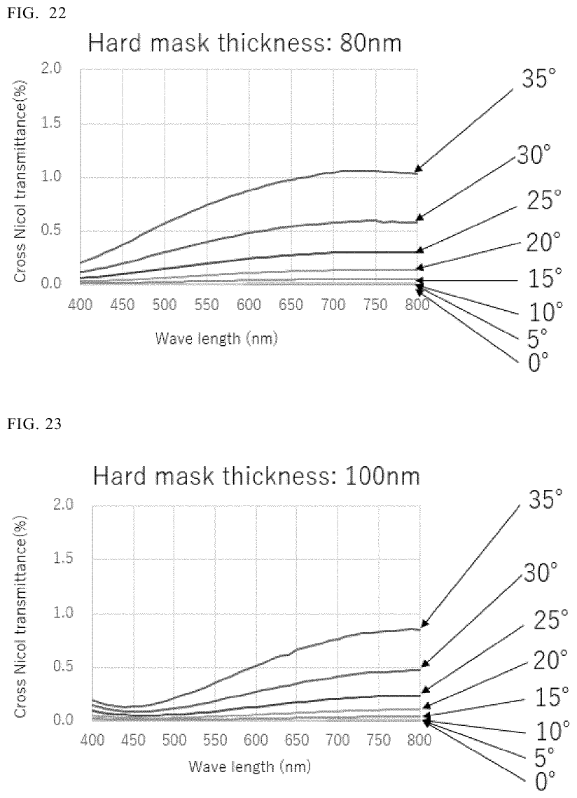

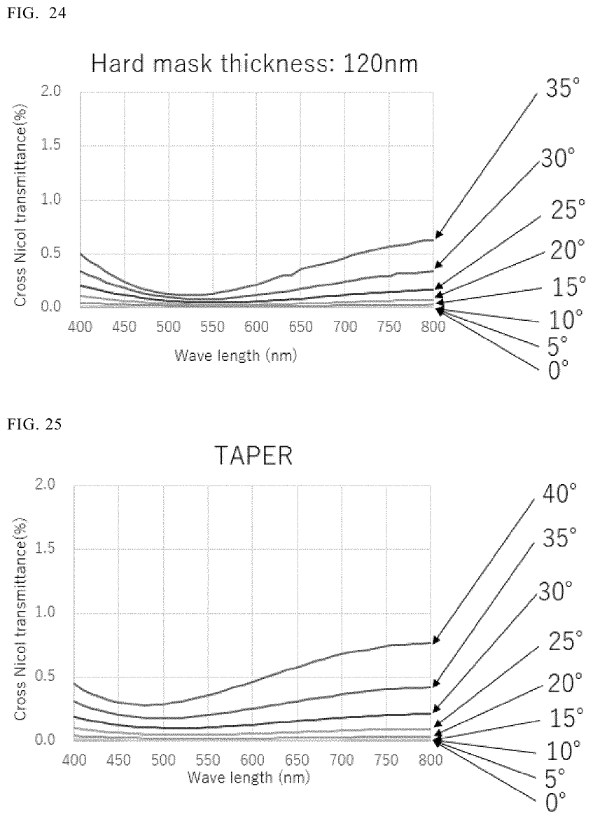

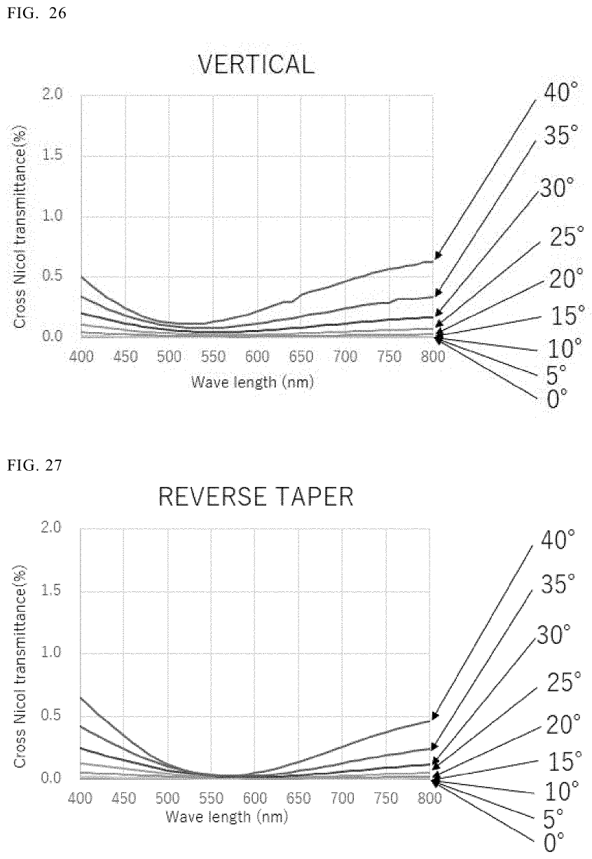

A simulation was made for, for each incidence angle, the TE transmittance with respect to the wavelength of the linear polarized light when the linear polarized light enters the wire grid portion 2 from the polarizing-axis-correcting-portion-3 side at the azimuth angle of 45 degrees relative to each of the above-described polarizers. The results are shown in FIGS. 19 to 27.

It becomes apparent that, as shown in FIGS. 19 to 27, even if the polarizing axis correcting portion 3 are placed on only the respective tips of the wires 21, the TE transmittance can be sufficiently reduced. Moreover, it becomes apparent that, when the thickness of the polarizing axis correcting portion 3 changes, the wavelength of light which takes the minimum value of the TE transmittance changes. Furthermore, it becomes apparent that, as for the cross-sectional shape of the polarizing axis correcting portion 3, a shape which has a larger portion than the width of the wire 21 like the model 17 is better than a shape which has a portion smaller than the width of the wire 21 like the model 14, and a shape which has the same width as the width of the wire 21 like the model 16.

[Simulation 6]

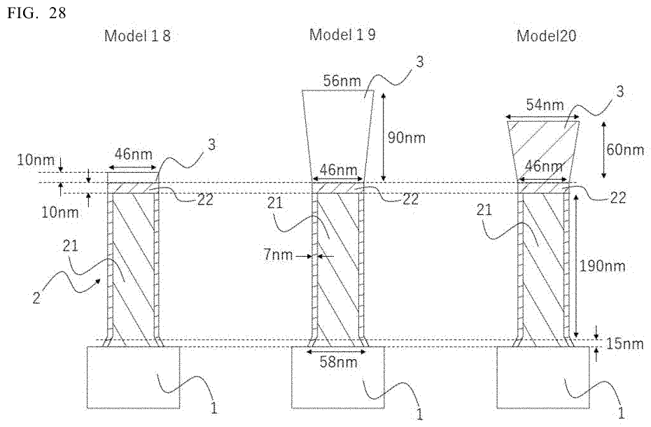

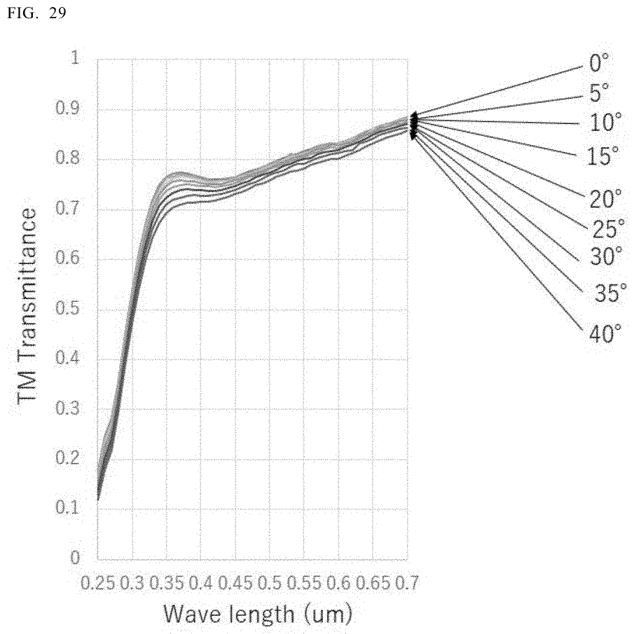

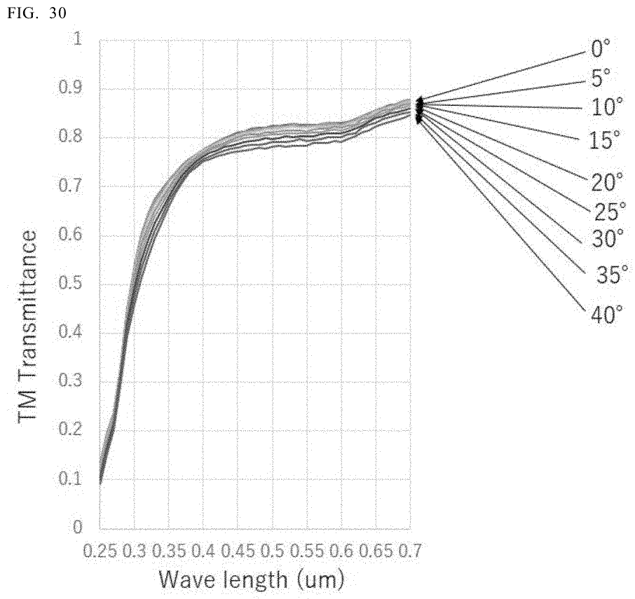

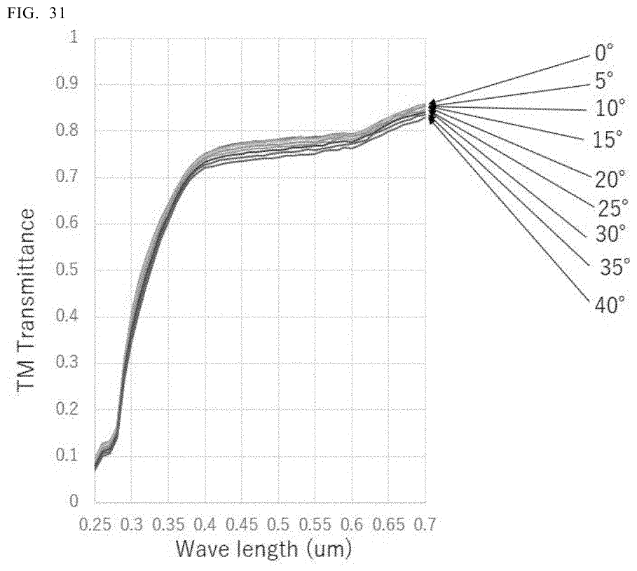

Next, using the simulation software, effects of the polarizing axis correcting portion 3 on the TM transmittance, the TE transmittance (i.e., the Cross Nicol transmittance) and the extinction ratio in the polarizer that included the absorption-type wire grid was calculated. As illustrated in FIG. 28, the assumed polarizer included the substrate 1 formed of silicon dioxide (SiO₂), and the wire grid portion 2 which was formed thereon, had the center part formed of aluminum, had the side faces formed of aluminum oxide that was a natural-oxidation film, and had the absorption layer 22 formed of germanium at the polarizing-axis-correcting-portion-3 side. The assumed polarizing axis correcting portion 3 was thin films of silicon dioxide (SiO₂) (models 18 and 19), and a thin film of silicon nitride (SiN). In this case, the wires 21 of the wire grid portion 2 had a pitch of 100 nm, and each included a base portion that had a trapezoidal cross-sectional shape vertical to the extending direction of the wire 21, and the rectangular body portion. Moreover, the base portion had a height of 15 nm and had a width of 58 nm at the base-material side, and 46 nm at the body-portion side. Furthermore, the body portion had a height of 190 nm, and had a width of 46 nm from the base-portion side to a surface side. Moreover, both sides of the aluminum oxide had a width of 7 nm. The assumed polarizing axis correcting portion 3 were: a layer formed of silicon dioxide (SiO₂), had a rectangular cross-sectional shape, had a width of 46 nm and a height of 10 nm, and placed on the respective tips of the wires 21 (model 18); a layer formed of silicon dioxide (SiO₂), had a reverse taper cross-sectional shape, had a width of 46 nm at the wire-21 side, and 56 nm at the vertex side, and had a height of 90 nm, and placed on the respective tips of the wires 21 (model 19); and a layer formed of silicon nitride (SiN), had a reverse taper cross-sectional shape, had a width of 46 nm at the wire-21 side, and 54 nm at the vertex side, and had a height of 60 nm, and placed on the respective tips of the wires 21 (model 20).

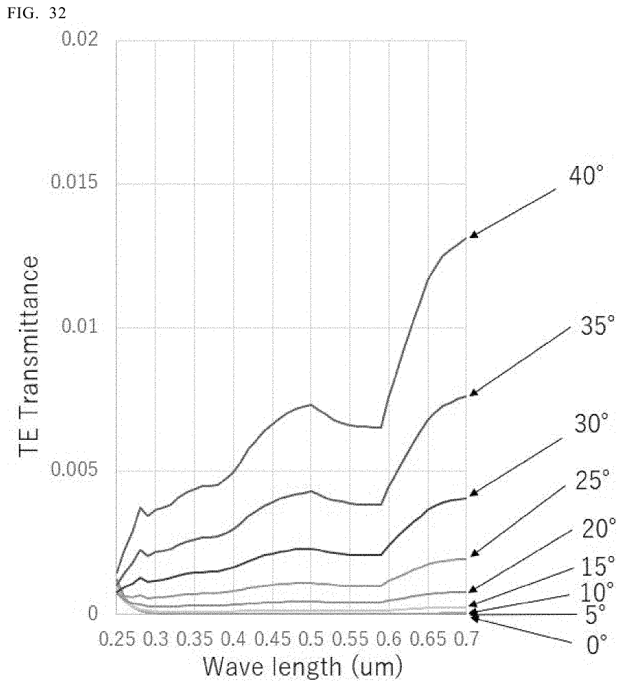

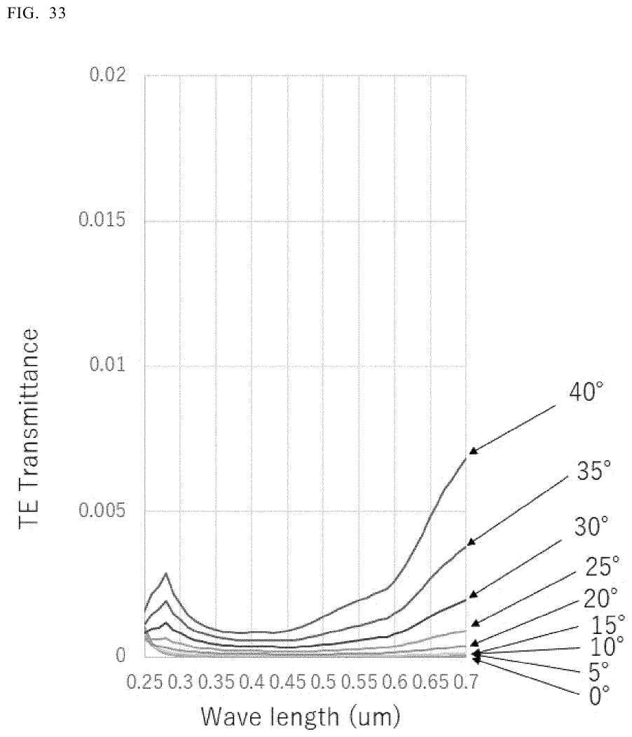

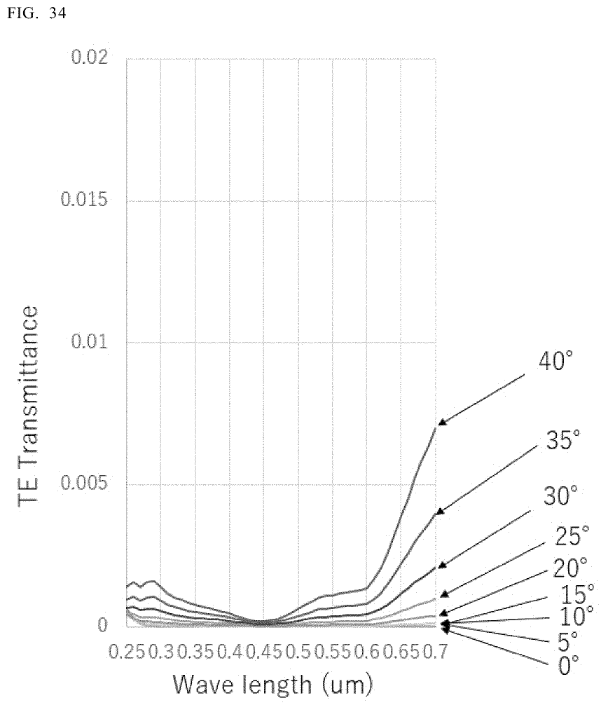

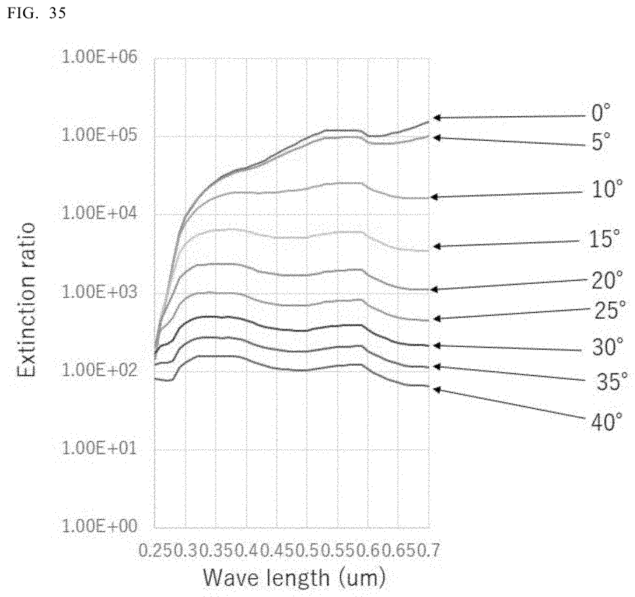

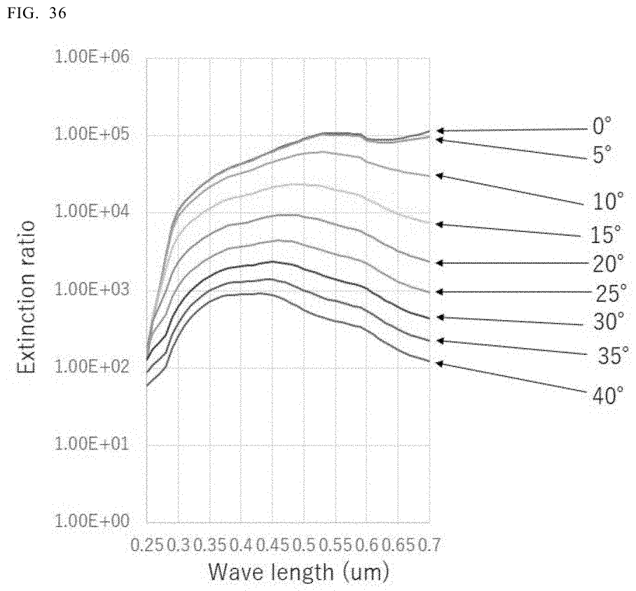

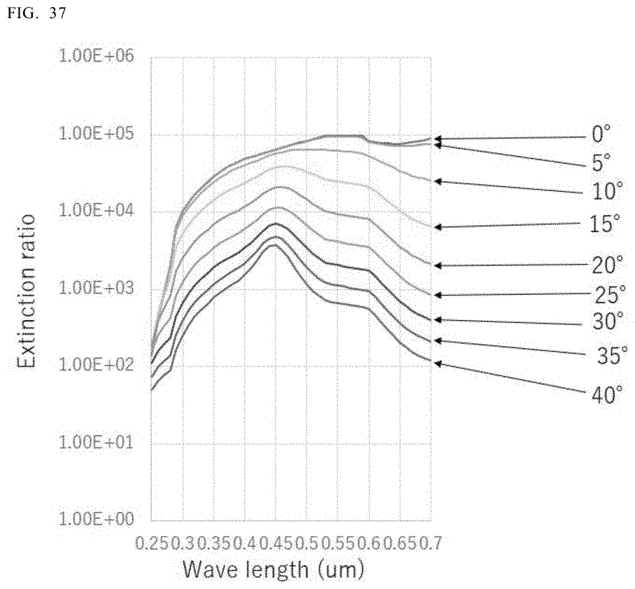

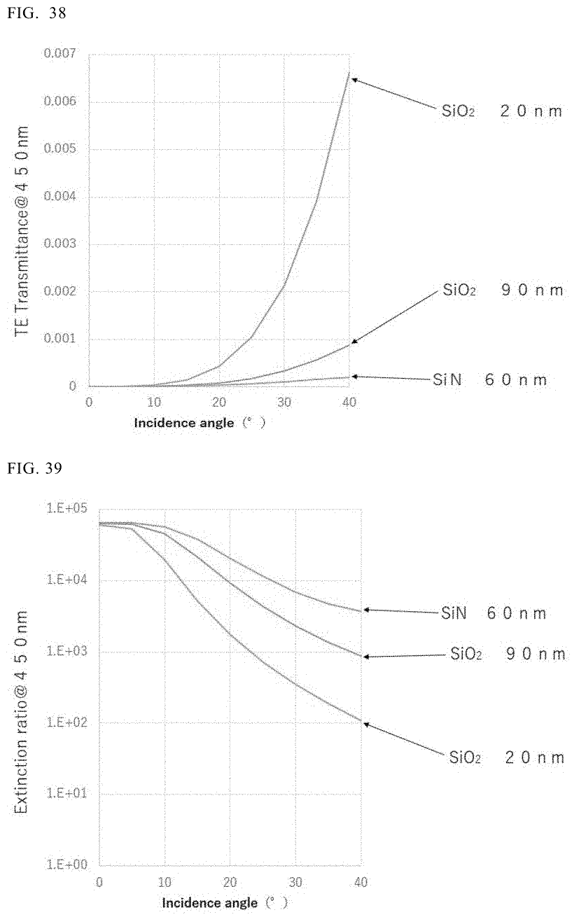

A simulation was made for, for each incidence angle, the TM transmittance, the TE transmittance, and the extinction ratio with respect to the wavelength of the linear polarized light when the linear polarized light enters the wire grid portion 2 from the polarizing-axis-correcting-portion-3 side at the azimuth angle of 45 degrees relative to each of the above-described polarizers. The results are shown in FIGS. 29 to 37. Moreover, a simulation was made for the TE transmittance and the extinction ratio with respect to the incidence angle of the linear polarized light when the linear polarized light with a wavelength of 450 nm enters the wire grid portion 2 from the polarizing-axis-correcting-portion-3 side at the azimuth angle of 45 degrees relative to each of the above-described polarizers. The results are shown in FIGS. 38 and 39.

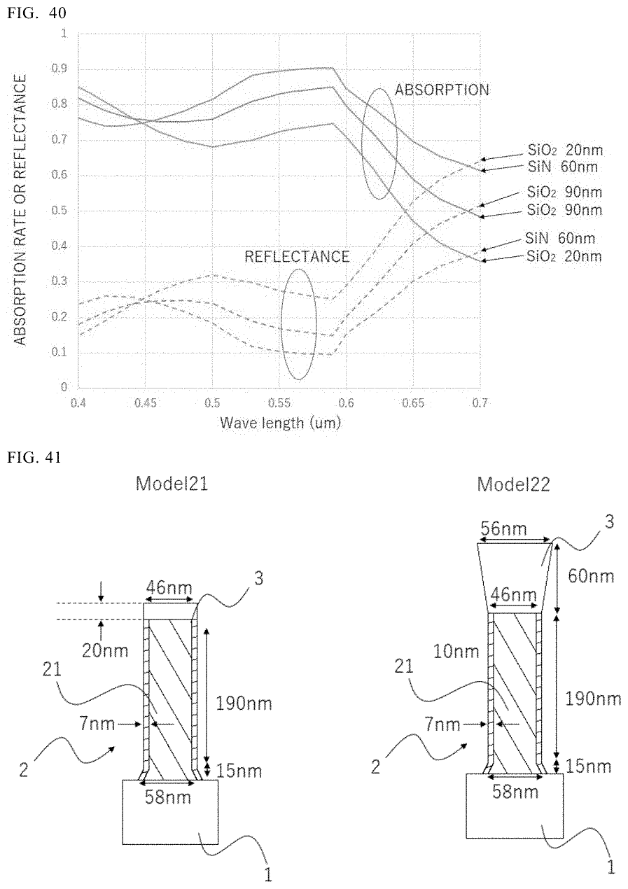

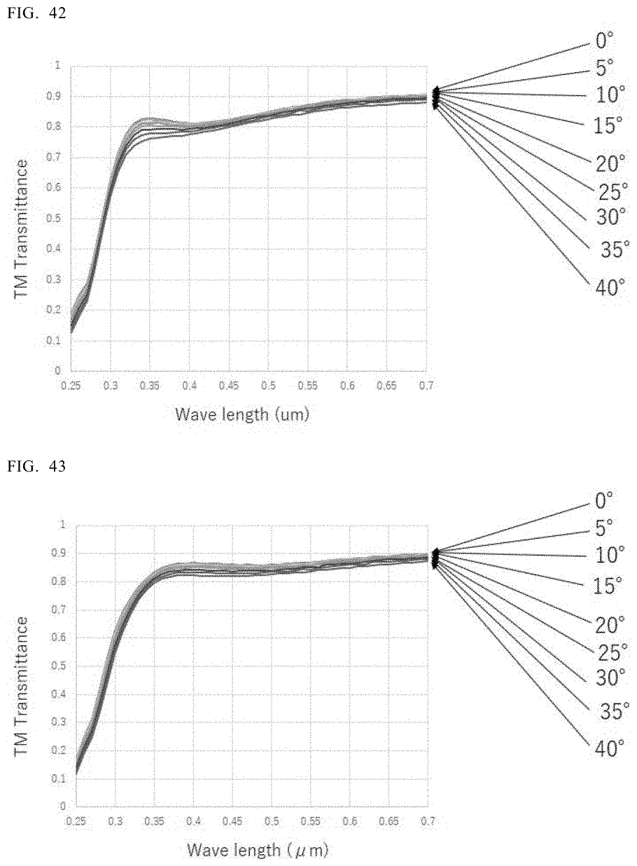

As shown in FIGS. 29 to 34, it becomes clear that, when the models 19 and 20 are compared with the model 18, there is no remarkable difference in TM transmittance, but the TE transmittance remarkably decreases. Consequently, it becomes clear that, as shown in FIGS. 35 to 37, the extinction ratio is improved. It becomes clear that, in particular, regarding the light that has a wavelength of 450 nm, the TE transmittance of the model 20 is sufficiently suppressed to low even if the incidence angle becomes large as shown in FIG. 38, and as shown in FIG. 39, the extinction ratio is also maintained to high. Furthermore, regarding the absorption-type wire grid, it can be confirmed that the models 19 and 20 which have the correction layer have second effects desirable as the absorption-type wire grid which are to increase the absorption rate of the absorption layer to a TE wave, and to decrease the reflectance as shown in FIG. 40 in comparison with the model 18.

[Simulation 7]

Next, using the simulation software, effects of the polarizing axis correcting portion 3 by ultraviolet rays on the TM transmittance, the TE transmittance (i.e., the Cross Nicol transmittance), and the extinction ratio in the polarizer that included the wire grid were calculated. The assumed polarizer included, as illustrated in FIG. 41, the substrate 1 formed of silicon dioxide (SiO₂), and the wire grid portion 2 which was formed thereon, had the center part formed of aluminum, and had the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm, had a base portion with a trapezoidal cross-sectional shape vertical to the extending direction of the wire 21, and a rectangular body portion. Moreover, the base portion had a height of 15 nm, and had a width of 58 nm at the base-material side, and 46 nm at the body-portion side. Furthermore, the body portion had a height of 190 nm, and had a width of 46 nm from the base-portion side to a surface side. Moreover, both sides of the aluminum oxide had a width of 7 nm. The assumed polarizing axis correcting portion 3 was: a layer formed of silicon dioxide (SiO₂), had a rectangular cross-sectional shape, had a width of 46 nm, and had a height of 20 nm, and placed on the respective tips of the wires 21 (model 21); and a layer formed of silicon dioxide (SiO₂), had a reverse taper cross-sectional shape, had a width of 46 nm at the wire-21 side, and 56 nm at the vertex side, and had a height of 60 nm, and placed on the respective tips of the wires 21 (model 22).

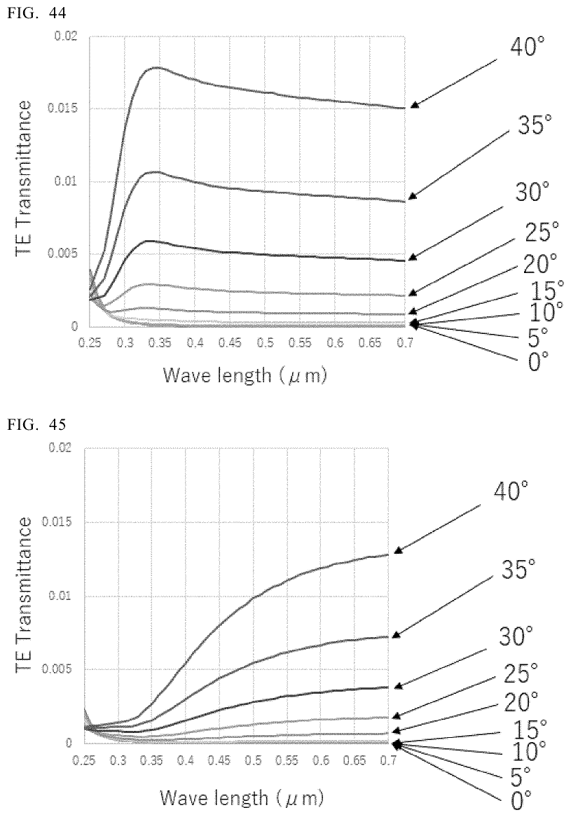

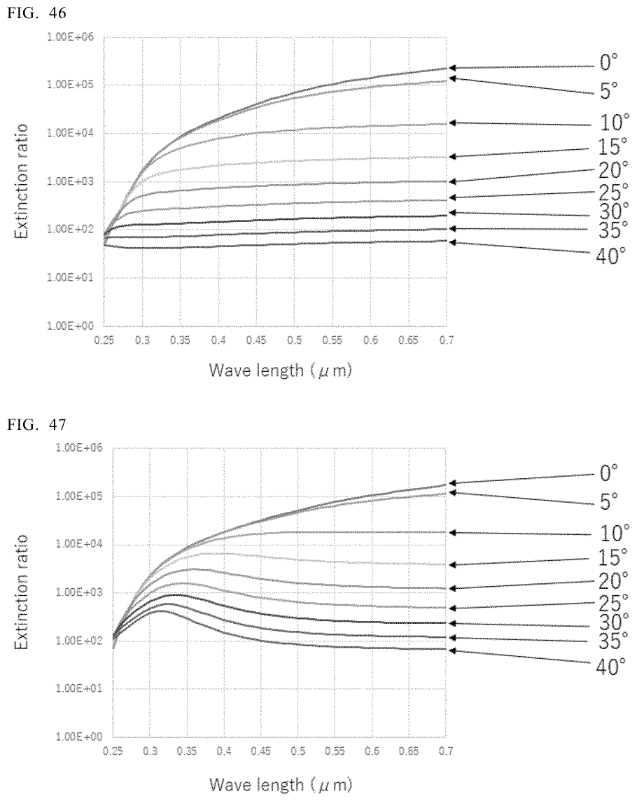

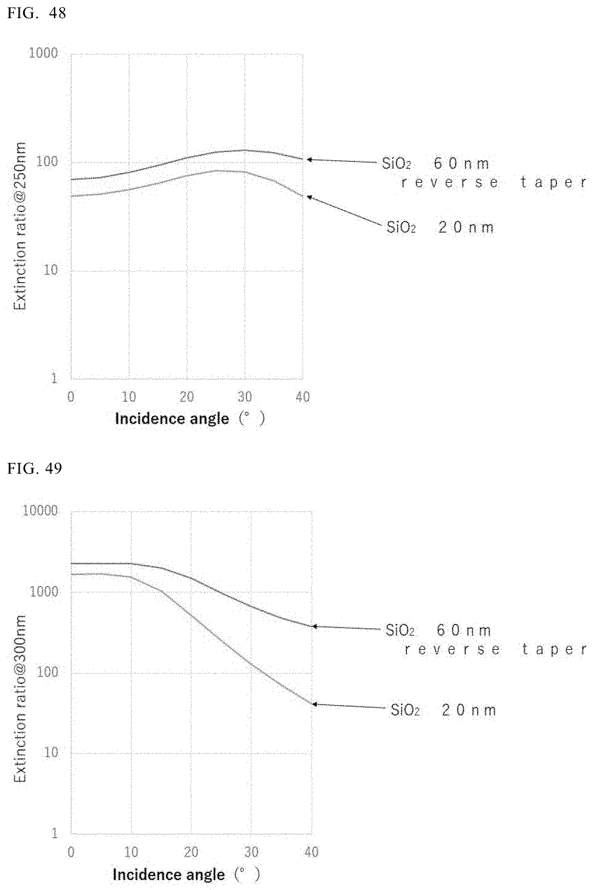

A simulation was made for, for each incidence angle, the TM transmittance, the TE transmittance, and the extinction ratio with respect to the wavelength of the linear polarized light when the linear polarized light enters the wire grid portion 2 from the polarizing-axis-correcting-portion-3 side at the azimuth angle of 45 degrees relative to each of the above-described polarizers. The results are shown in FIGS. 42 to 47. Moreover, a simulation was made for the extinction ratio with respect to the incidence angle of the linear polarized light when the linear polarized light that has the wavelength of 250 nm or 300 nm enters the wire grid portion 2 from the polarizing-axis-correcting-portion-3 side at the azimuth angle of 45 degrees relative to each of the above-described polarizers. The results are shown in FIGS. 48 and 49.

As shown in FIGS. 42 to 45, it becomes clear that, when the model 22 is compared with the model 21, there is no remarkable difference in TM transmittance with respect to ultraviolet rays that have the wavelength of 250 nm to 300 nm, but the TE transmittance remarkably decreases. Consequently, as shown in FIGS. 46 and 47, it becomes clear that the extinction ratio is improved. In particular, it becomes clear that the model 22 maintains the high extinction ratio even if the incidence angle increases with respect to light that has the wavelength of 300 nm as shown in FIG. 49.

### Examples

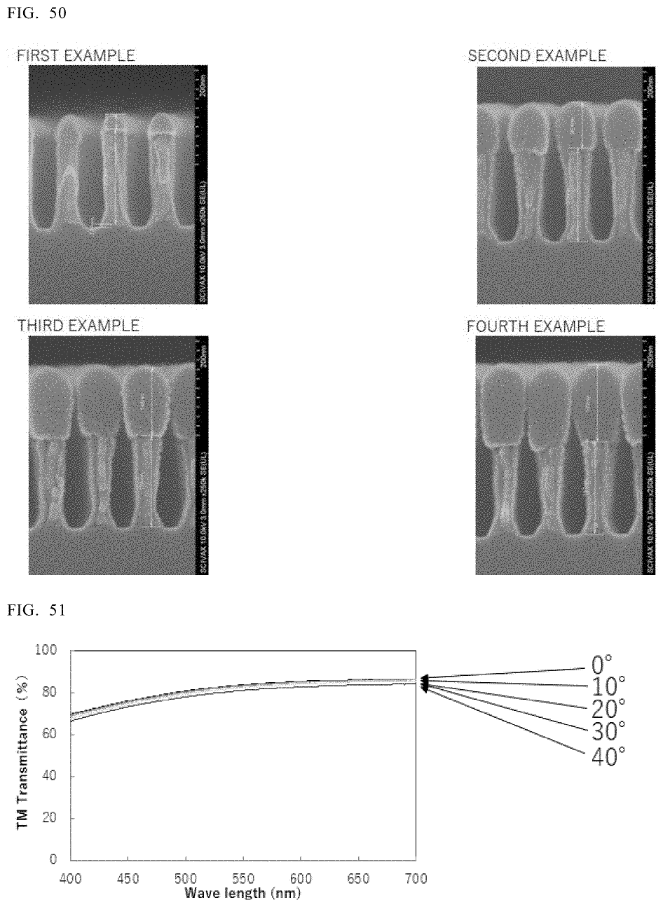

Next, the polarizer that includes the polarizing axis correcting portion 3 was actually created, and effects on the TM transmittance, the TE transmittance (i.e., the Cross Nicol transmittance), and the extinction ratio by the polarizing axis correcting portion 3 of the polarizer were examined. The applied polarizer included, as illustrated in a photograph that is FIG. 50, the substrate 1 formed of silicon dioxide, and the wire grid portion 2 which was formed thereon and formed of aluminum, and further the polarizing axis correcting portion 3 formed of oxidized silicon (SiO₂) on the respective tips of the wires 21. In this case, the wires 21 of the wire grid portion 2 had a pitch of 100 nm, a height of 200 nm, and a width of 50 nm. The heights of the polarizing axis correcting portion 3 were four kinds: 31 nm (first example); 98 nm (second example); 144 nm (third example); and 163 nm (fourth example).

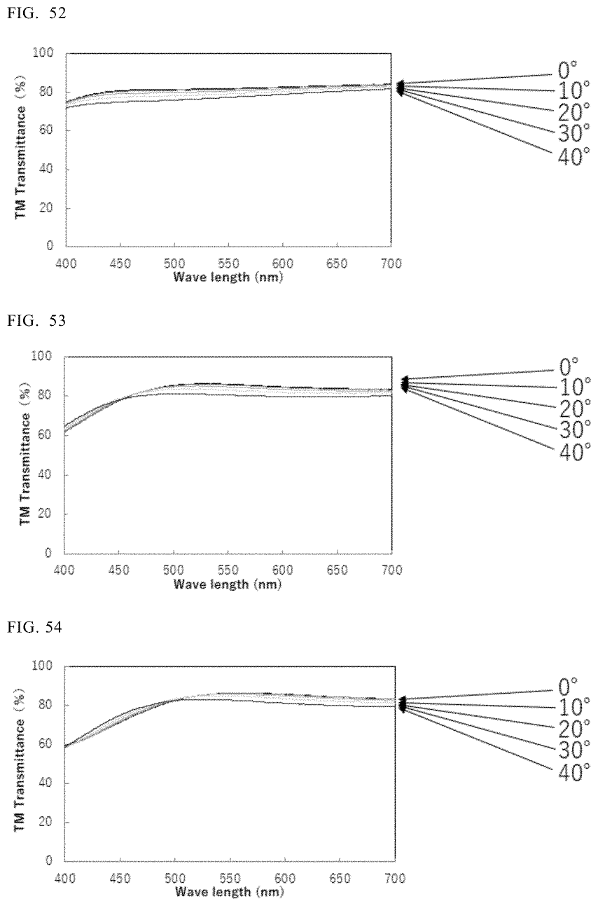

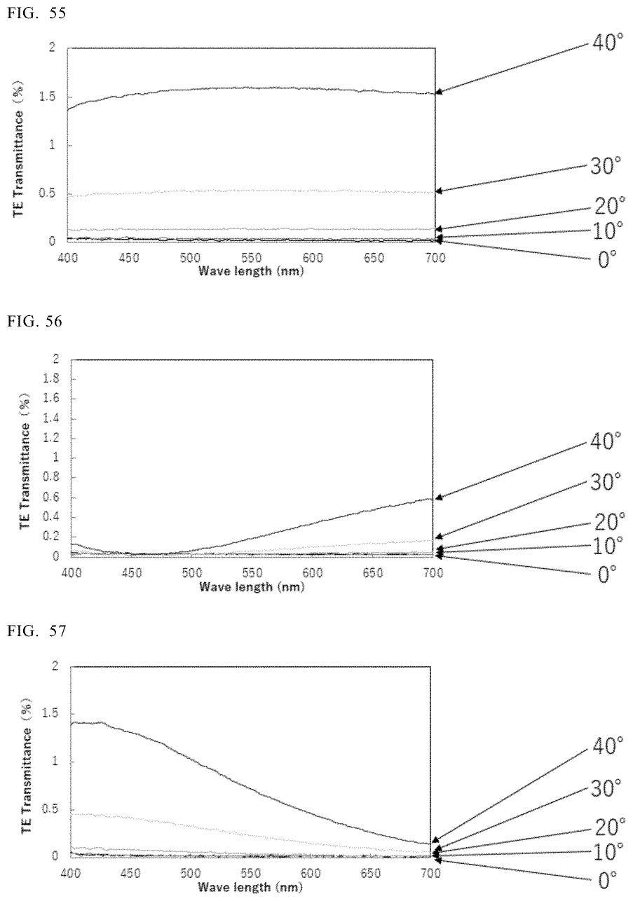

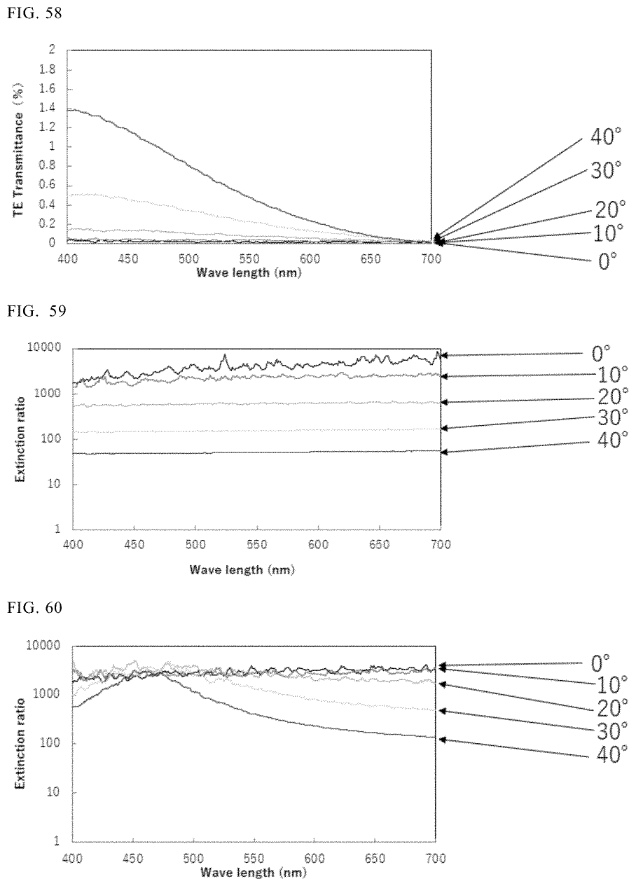

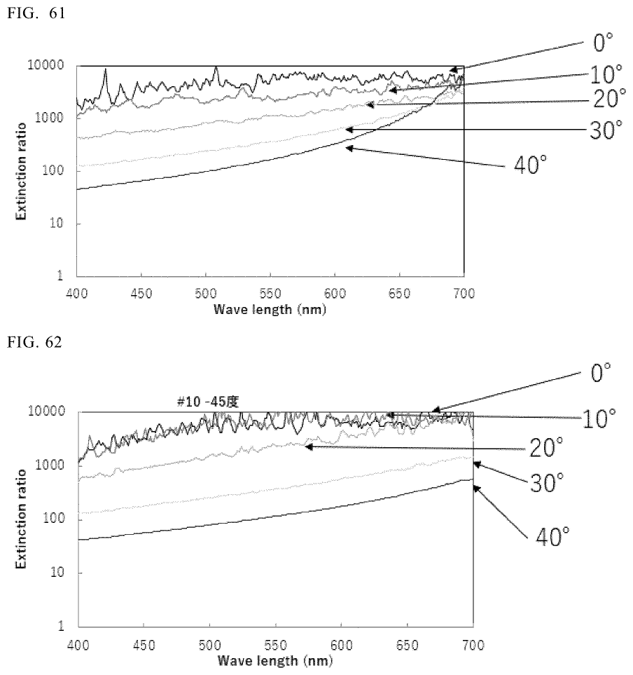

The TM transmittance, the TE transmittance, and the extinction ratio with respect to the wavelength of the linear polarized light when the linear polarized light enters the wire grid portion 2 from the polarizing-axis-correcting-portion-3 side at the azimuth angle of 45 degrees relative to each of the above-described polarizers were measured for each incidence angle. The results are shown in FIGS. 51 to 62.

As shown in FIGS. 51 to 62, it becomes apparent that, even if the thickness of the polarizing axis correcting portion 3 changes, there is no remarkable effect on the TM transmittance, but as for the TE transmittance, the wavelength of light that takes the minimum value of the TE transmittance changes. Moreover, it becomes apparent that the wavelength of light that shows the high extinction ratio also changes regarding the extinction ratio.

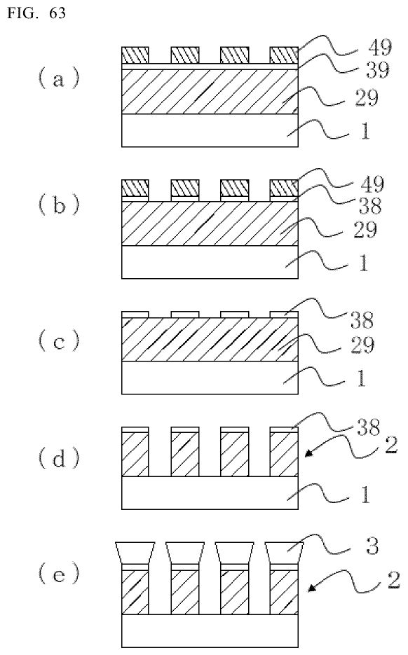

Next, an example creation method of the polarizer according to the present disclosure will be described below. As illustrated in FIG. 63, a metal layer 29 is formed on the substrate 1 that is transparent to light within the utilized bandwidth. For example, aluminum (Al) may be deposited on the substrate 1 formed of silicon dioxide (SiO₂) by sputtering. Next, a masking thin film 39 formed of the same dielectric as the material applied for the polarizing axis correcting portion 3 is formed on the metal layer 29. For example, the masking thin film 39 formed of silicon dioxide (SiO₂) is formed on the above-described aluminum layer by sputtering, etc. Furthermore, a resist is applied to form a mask pattern 49 in the resist by technologies, such as nanoimprinting and photo lithography (see FIG. 62A). Etching is performed on the masking thin film 39 using this mask pattern 49, and forms a hard mask 38 (see FIGS. 62B and C). Etching is performed on the metal layer 29 using this hard mask 38 to form the wire grid portion 2 (see FIG. 62D). Eventually, the shape and thickness of the polarizing axis correcting portion 3 are adjusted by depositing a dielectric on the hard mask 38 (see FIG. 62E). For example, the shape and thickness of the polarizing axis correcting portion 3 are adjusted by sputtering of silicon dioxide (SiO₂) on the mask pattern. Accordingly, the polarizer that has a desired pattern can be formed.

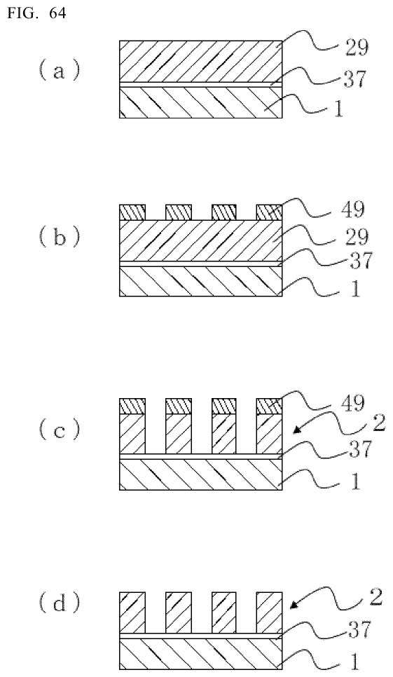

Moreover, another example creation method of the polarizer according to the present disclosure will be described below. As illustrated in FIG. 64, a dielectric layer 37 with a desired thickness that becomes the polarizing axis correcting portion 3 is formed on the substrate 1 that is transparent to light within the utilized bandwidth. For example, a film formed of silicon nitride (SiN) is deposited on the substrate 1 formed of silicon dioxide (SiO₂) by CVD. Next, a metal layer 29 is formed on the dielectric layer 37 (see FIG. 63A). For example, aluminum (Al) is deposited on the above-described silicon nitride film by sputtering. Furthermore, a resist is applied, and a mask pattern 49 is formed by technologies, such as nanoimprinting and photo lithography (see FIG. 63B), and etching is performed on the metal layer 29 by utilizing such a mask pattern as a mask to form the wire grid portion 2 (see FIGS. 63C and D). Accordingly, the polarizer with a desired pattern can be formed.

Next, a display and ultraviolet emitting apparatus will be described as example applications of the polarizer according to the present disclosure.

First, a display, e.g., a quantum dot display according to the present disclosure mainly includes, as illustrated in FIG. 65, a light source 51 that emits blue light, a light-source-side polarizer 52 that converts light from the light source 51 into linear polarized light, a liquid crystal 53 that changes the polarizing direction of the linear polarized light, the above-described polarizer 50 of the present disclosure, and a wavelength converter 54 that converts light into red and green wavelengths.

In the case of a quantum dot display, only blue light directly passes through the polarizer 50. Red and green lights passing through the polarizer 50 are colored by light emission of quantum dots of the wavelength converter 54. Accordingly, the utilized bandwidth of the polarizer 50 is the blue light. Hence, when the Cross Nicol transmittance is low relative to the incident blue light at the azimuth angle of 45 degrees relative to the wires 21, the contrasts can be maintained at a wide viewing angle. Accordingly, it is preferable that the polarizing axis correcting portion 3 of the polarizer 50 according to the present disclosure should have a thickness that causes the wavelength of light which takes the minimum value of the TE transmittance to be equal to or greater than 450 nm and equal to or smaller than 495 nm when the linear polarized light enters at the azimuth angle of 45 degrees and at the incidence angle of 40 degrees relative to the wires 21. For example, according to the above-described simulations, the polarizers according to the model 18 and the model 19 correspond.

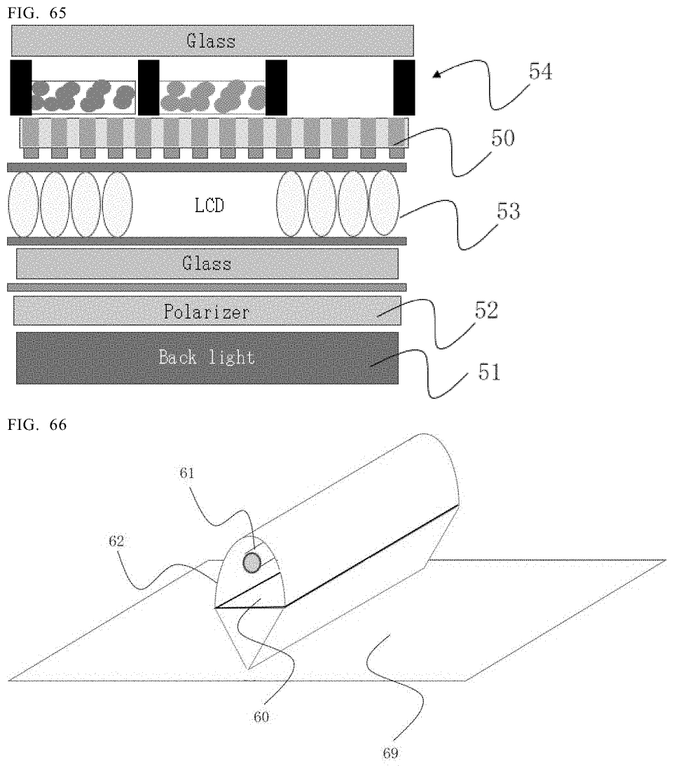

Moreover, an ultraviolet emitting apparatus mainly includes a light source 61 that emits ultraviolet rays, a curved mirror 62 that reflects the emitted ultraviolet rays from the light source 61 toward an object 69, and the above-described polarizer 60 according to the present disclosure as illustrated in FIG. 66. Moreover, in order for a light distribution process on a light distributing film, only ultraviolet rays with the polarizing axis in a predetermined direction among the ultraviolet rays emitted from the light source 61 are caused to pass through the polarizer 60, and the passing ultraviolet rays are emitted to the object 69. In this case, the direction of light emitted to the polarizer 60 from the light source 61 varies, and a polarization degree of oblique incident light at azimuth angle of 45 degrees relative to the polarizer 60 becomes low. Hence, when the Cross Nicol transmittance is low relative to the ultraviolet rays that enter at the azimuth angle of 45 degrees relative to the wire 21, a further better light distribution process is enabled. Accordingly, it is preferable that the polarizing axis correcting portion 3 of the polarizer 60 according to the present disclosure should have a thickness that causes the wavelength of light which takes the minimum value of the TE transmittance to be equal to or smaller than 380 nm when the linear polarized light enters at the azimuth angle of 45 degrees and at the incidence angle of 40 degrees relative to the wires 21. For example, according to the above-described simulations, the polarizer of the model 22 corresponds.

Next, regarding a polarizer applied for a beam splitter, the optimal structure for improving the extinction ratio was examined.

[Simulation 8]

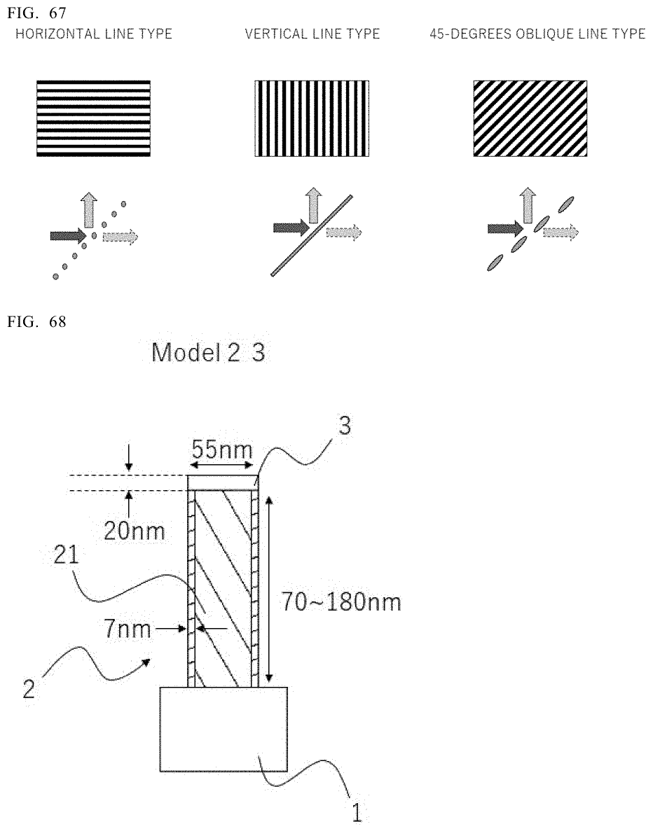

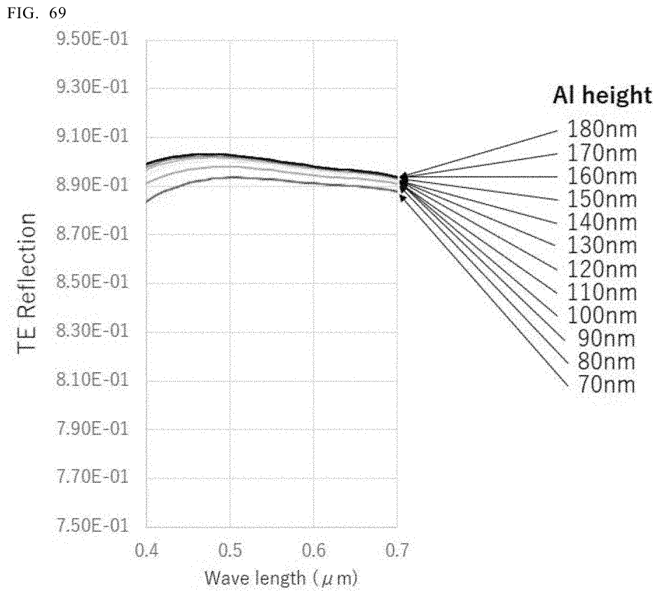

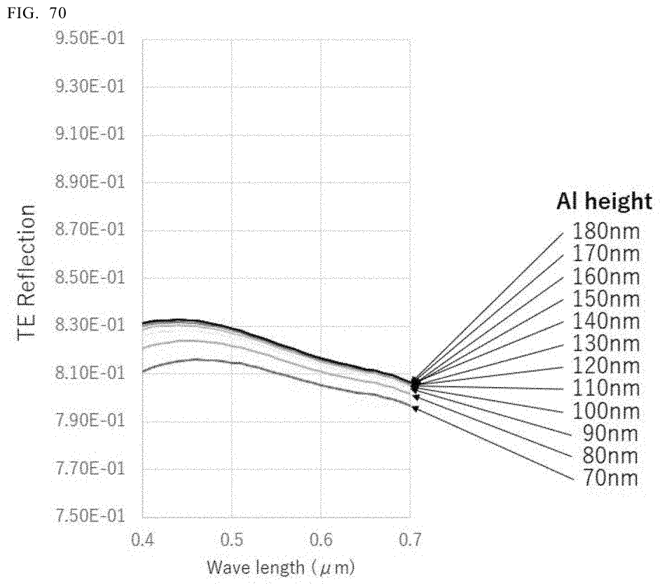

First, using the simulation software, the reflection characteristics and the transmittance characteristics were calculated when, in a polarizer applied as a beam splitter as illustrated in FIG. 67, light is emitted at an incidence angle of 45 degrees for three kinds of structures: the extending direction of the pattern of the wire grid portion 2 is horizontal to the incident direction of light (azimuth angle: 0 degree); vertical (azimuth angle: 90 degrees); and 45 degrees oblique (azimuth angle: 45 degrees). The assumed polarizer included, as illustrated in FIG. 68, the substrate 1 formed of silicon dioxide (SiO₂), and the wire grid portion 2 formed thereon, having the center part formed of aluminum, and having the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm and each had a rectangular cross-sectional shape vertical to the extending direction of the wires 21. Moreover, the width was 55 nm. Furthermore, the wires 21 had 12 kinds of height from 70 nm to 180 nm changed 10 nm by 10 nm. Still further, both sides of the aluminum oxide had a width of 7 nm. The assumed polarizing axis correcting portion 3 was a layer formed of silicon dioxide (SiO₂), had a rectangular cross-sectional shape, had a width of 55 nm and a height of 20 nm, and placed on the respective tips of the wires 21 (model 23).

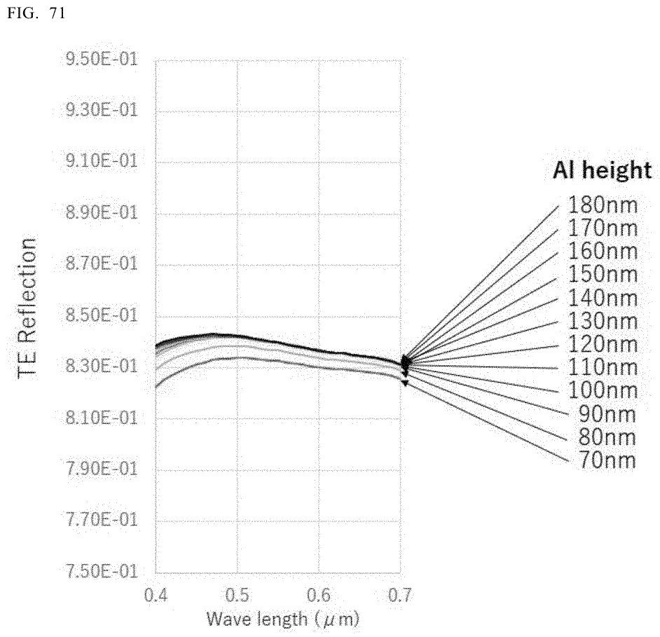

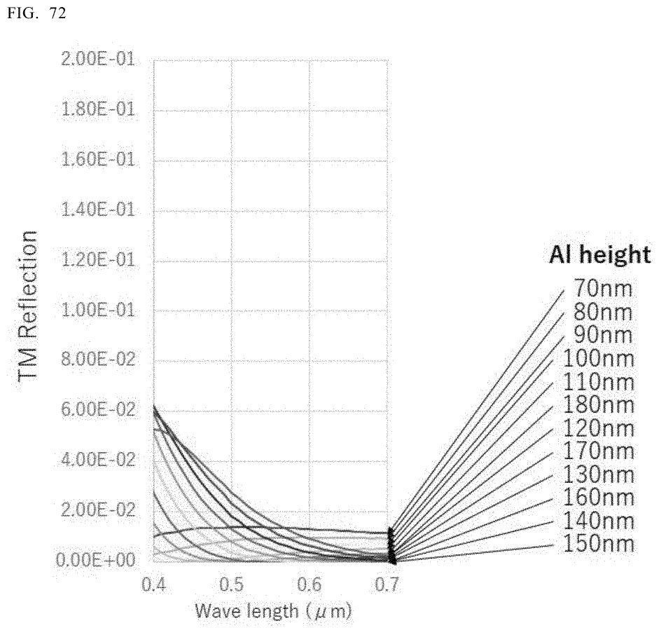

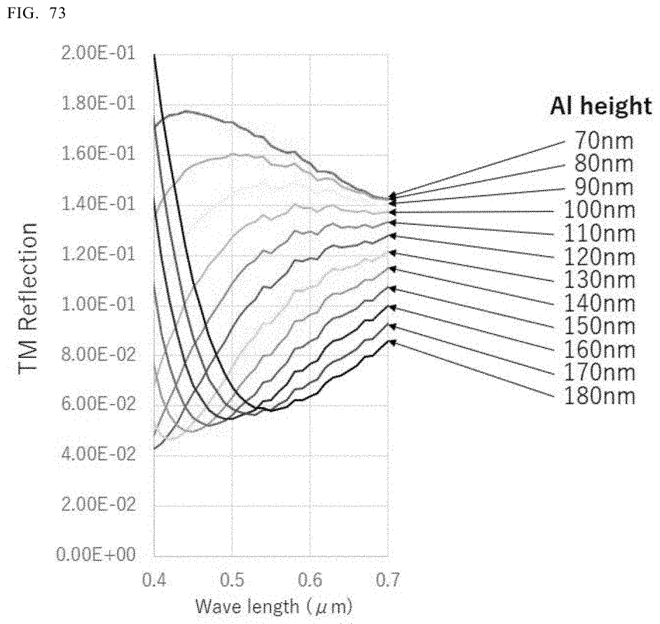

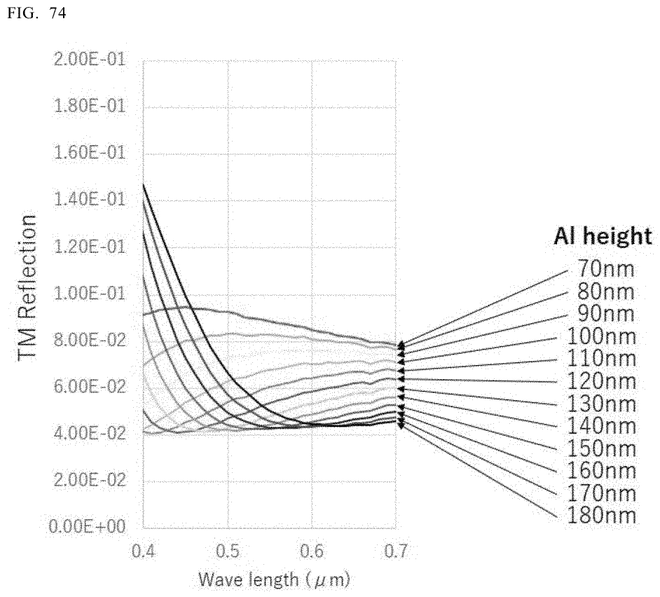

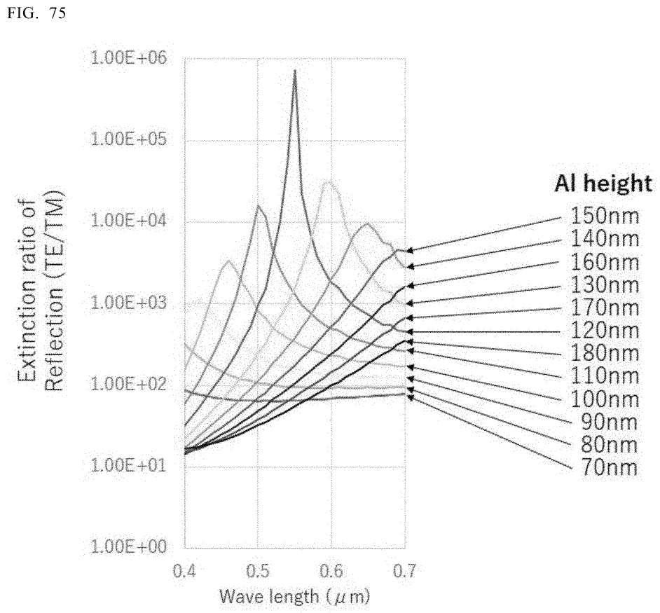

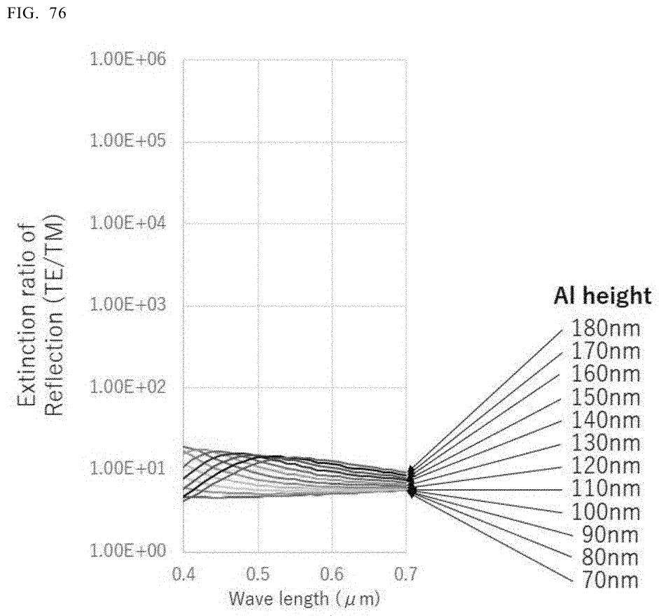

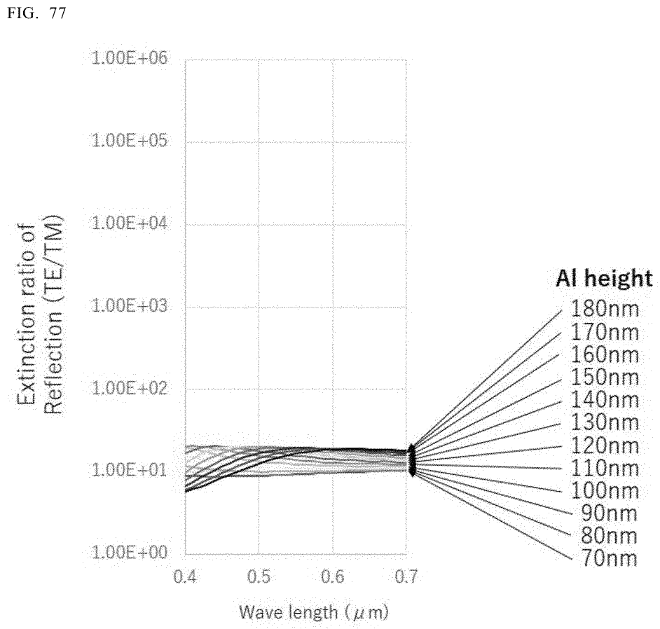

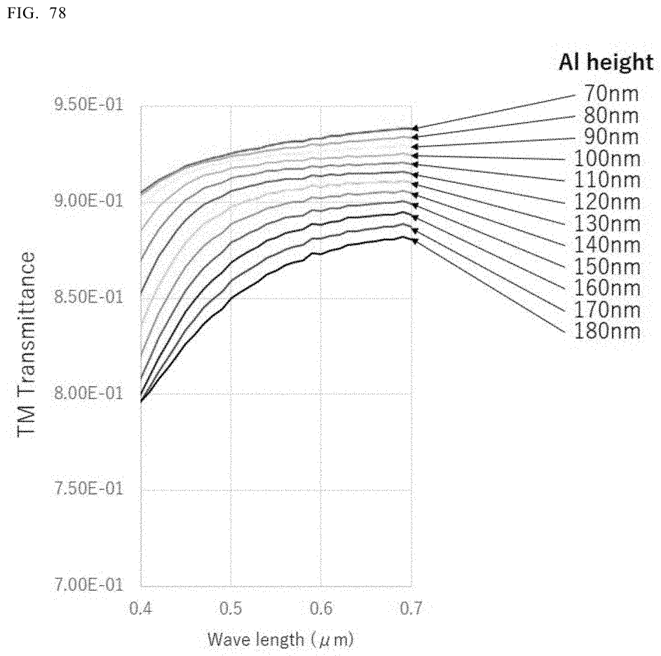

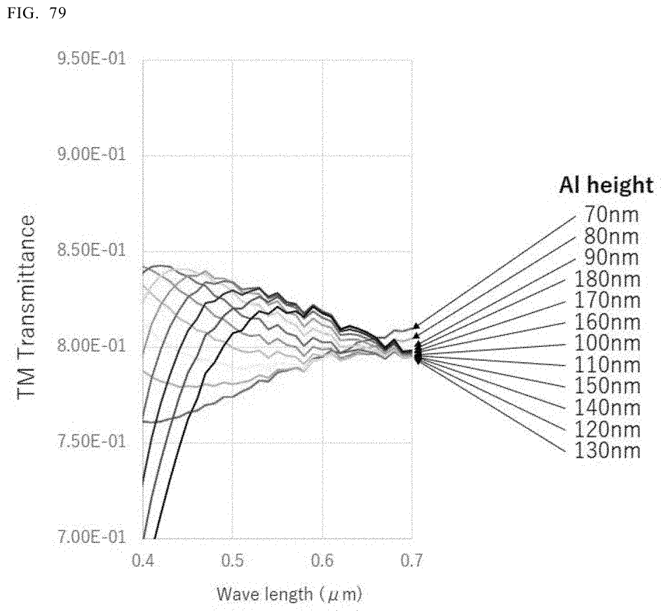

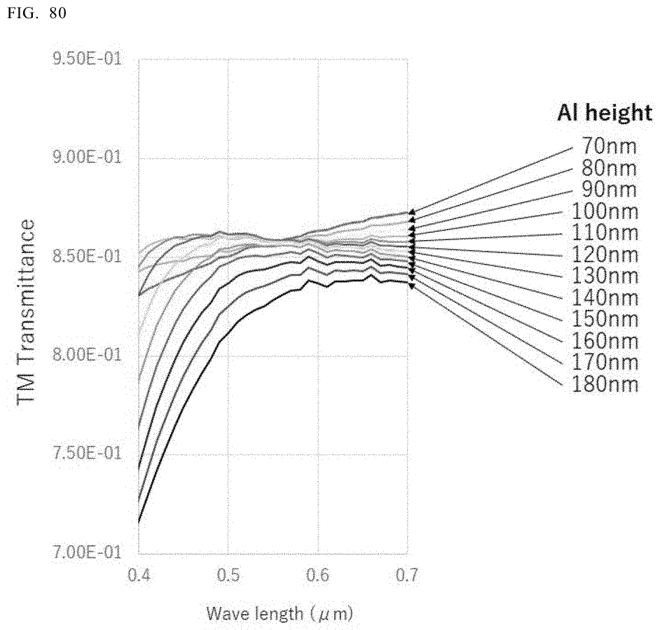

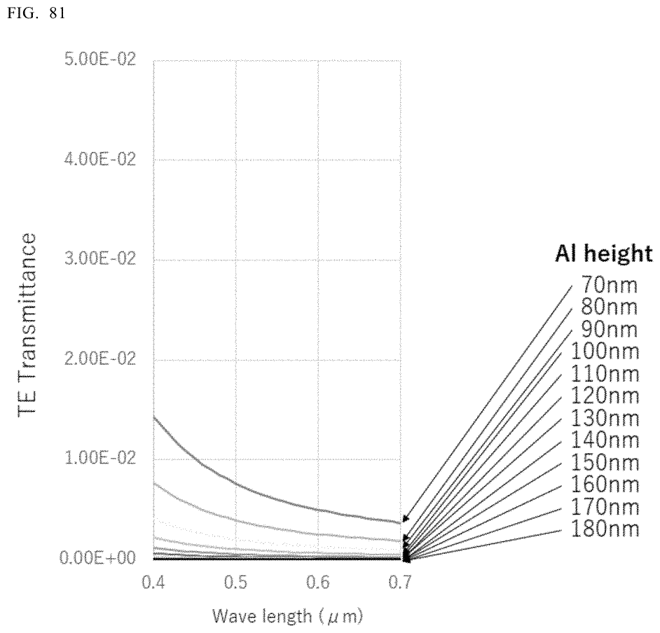

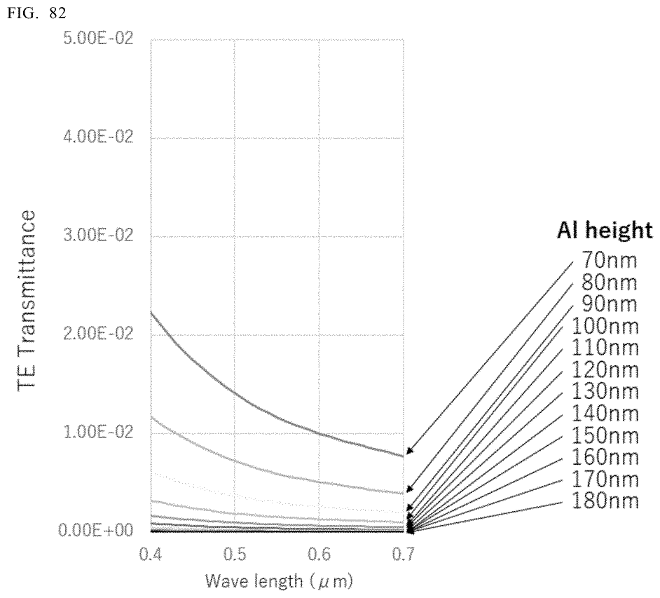

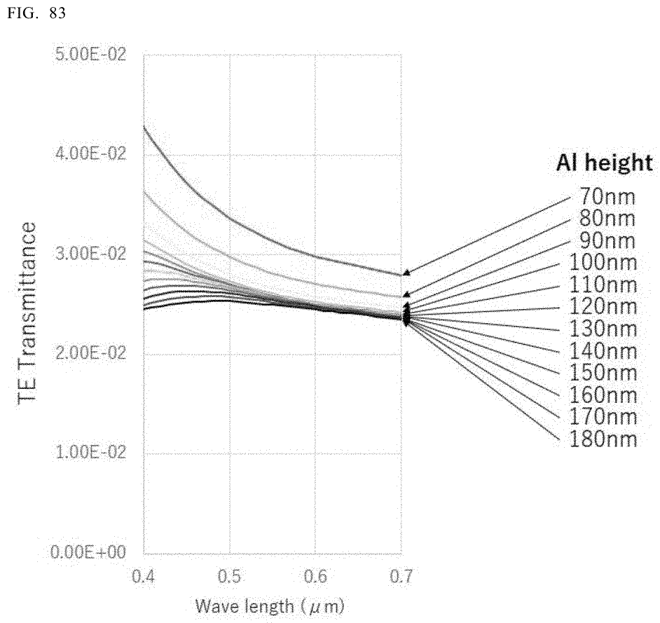

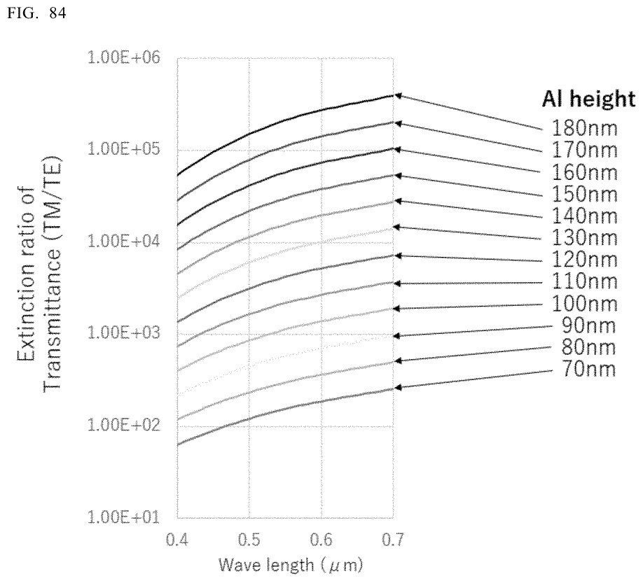

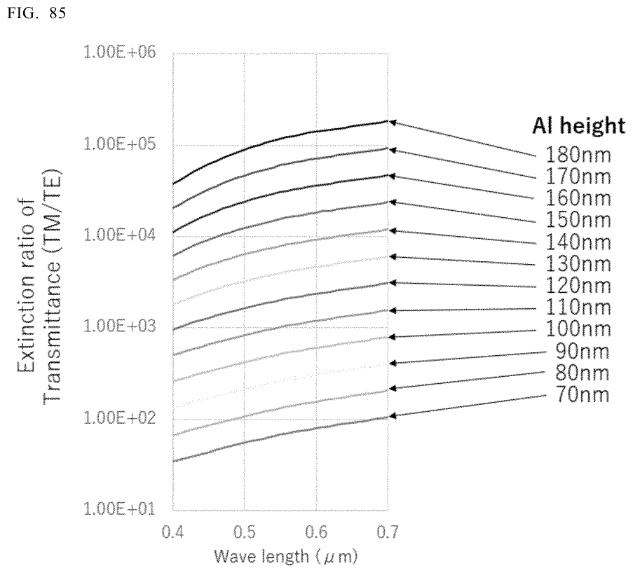

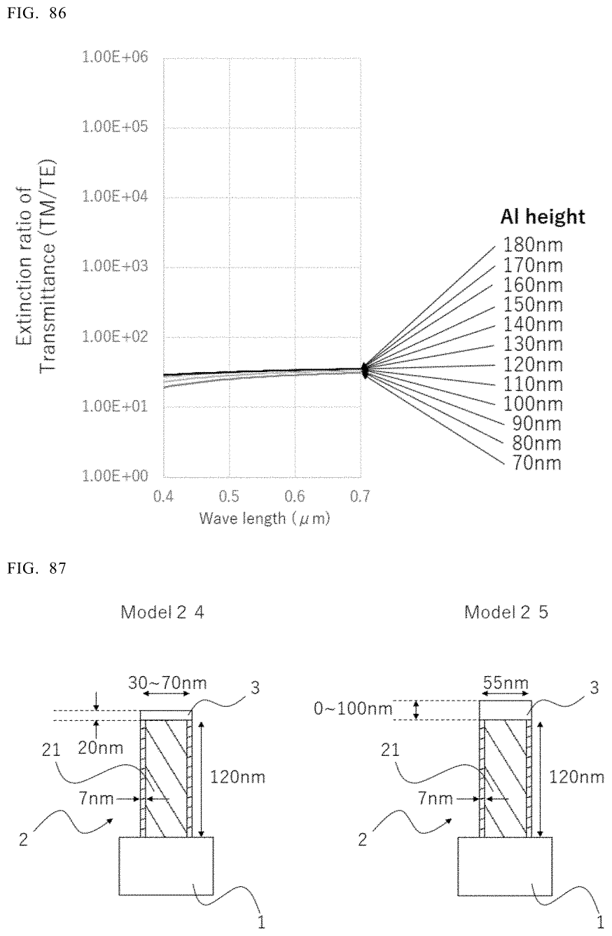

A simulation was made for, for each height of the aluminum (Al), the TE reflectance, TM reflectance, reflection extinction ratio, TM transmittance, TE transmittance, and transmittance extinction ratio of the above model. The results are shown in FIGS. 69 to 86.

With respect to all of the reflectance, the transmittance, and the extinction ratio thereof, a horizontal line type (the azimuth angle of incident light: 0 degree) shows the excellent characteristics. Moreover, it becomes apparent that, in the horizontal line structure, the reflection extinction ratio becomes the highest at the height of Al between 110 to 130 nm, and there is a peak at the wavelength around 500 to 600 nm. Furthermore, it becomes apparent that, when the height of aluminum increases, the transmittance extinction ratio also monotonically increases. Accordingly, in view of the characteristics that are transmittance and reflection, it becomes apparent that, for the polarizer like a beam splitter that has an importance in reflection extinction ratio, the desirable height of aluminum is substantially 120 nm.

[Simulation 9]

A simulation was made for, in the horizontal line structure (the azimuth angle of incident light: zero degree) that showed the excellent characteristics in the simulation 8, the optical characteristics with a fill factor (Fill factor) of the wire grid portion 2 being as a parameter, and for the optical characteristics with the thickness of the polarizing axis correcting portion 3 being as a parameter. In this case, the term fill factor means a ratio of width relative to the pitch of the wires 21 of the wire grid portion 2.

The assumed polarizer included, as illustrated in FIG. 87, the substrate 1 formed of silicon dioxide (SiO₂), and the wire grid portion 2 which was formed thereon, had the center part formed of aluminum, and had the side faces formed of aluminum oxide that was a natural-oxidation film. Both sides of the aluminum oxide had a width of 7 nm. Moreover, the wires 21 of the wire grid portion 2 each had a rectangular cross-sectional shape vertical to the extending direction, had a pitch of 100 nm, and had a height of 120 nm. Moreover, the assumed polarizing axis correcting portion 3 was a thin film of silicon dioxide (SiO₂) which had a rectangular cross-sectional shape vertical to the extending direction.

In this case, when the Fill factor is the parameter, as indicated by the model 24 in FIG. 87, the widths of the wire 21 were nine kinds between 30 and 70 nm which were changed 5 nm by 5 nm. Moreover, the thickness of silicon dioxide (SiO₂) that was the polarizing axis correcting portion 3 was 20 nm.

Moreover, when the thickness of silicon dioxide (SiO₂) is the parameter, as indicated by the model 25 in FIG. 87, the thicknesses of silicon dioxide (SiO₂) that was the polarizing axis correcting portion 3 were 12 kinds between 1 to 100 nm which were changed 9 nm by 9 nm. Moreover, the width of the wire 21 was 55 nm.

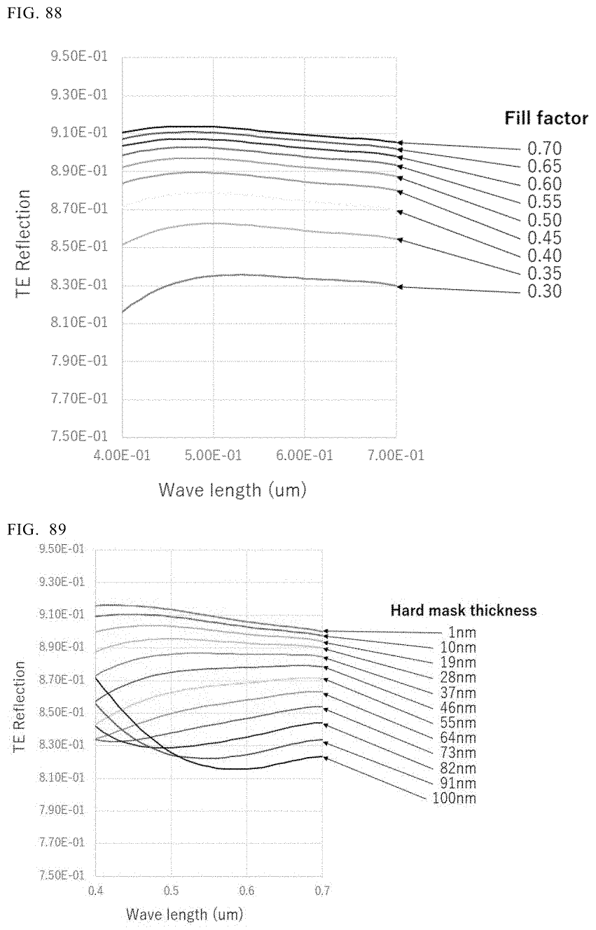

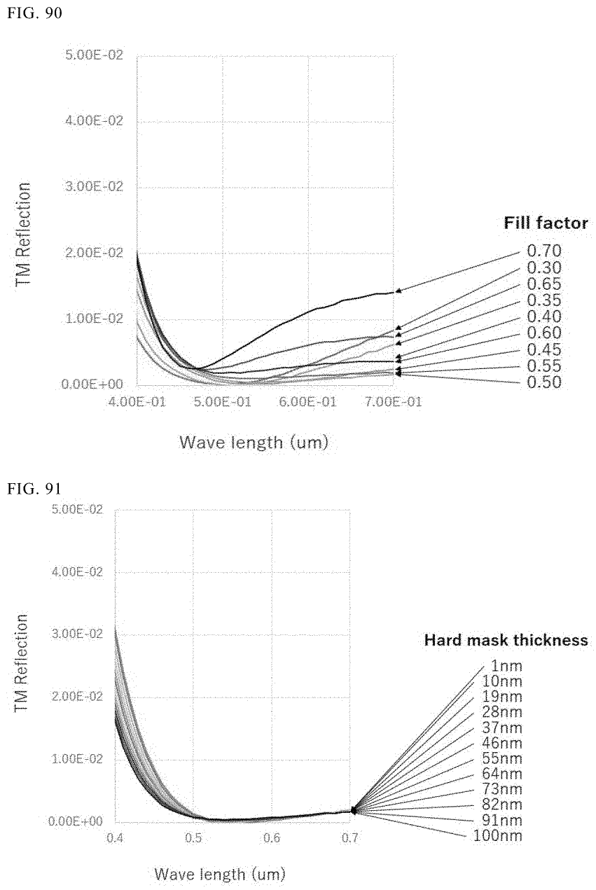

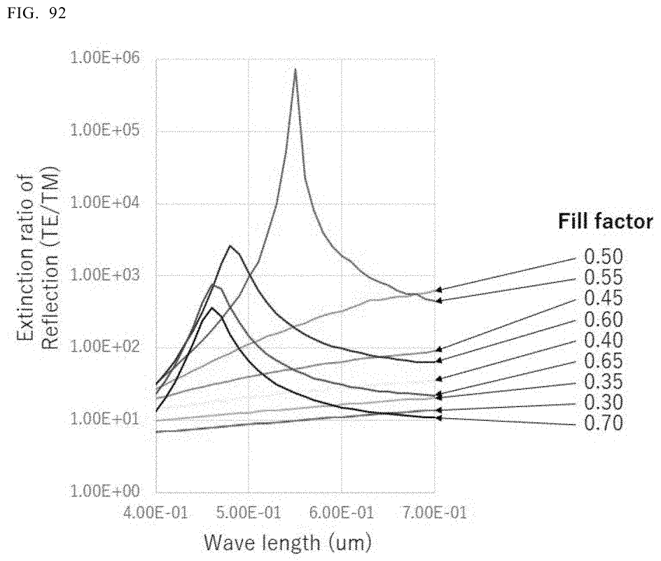

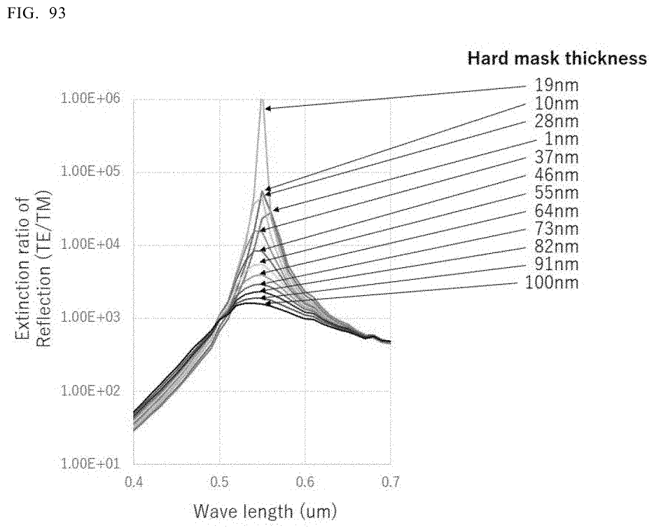

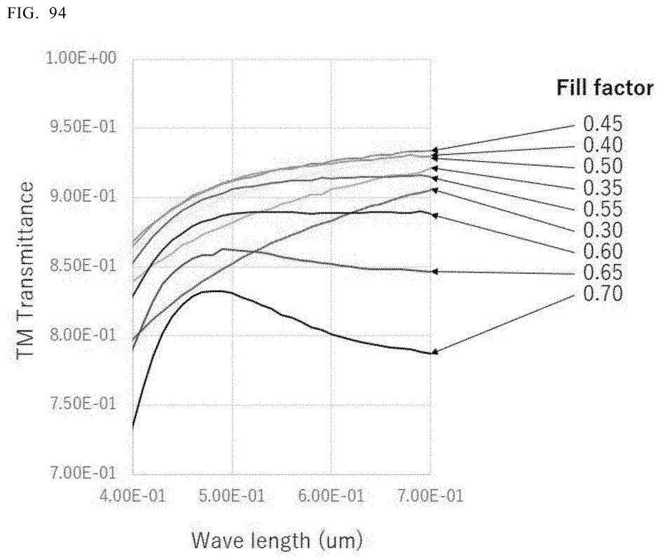

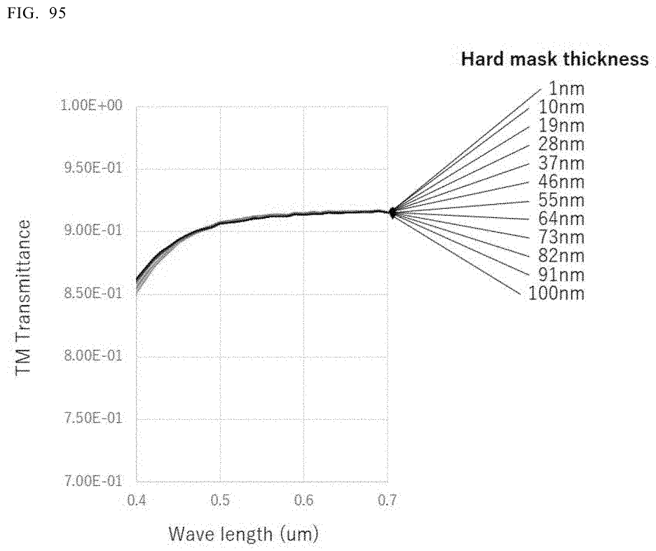

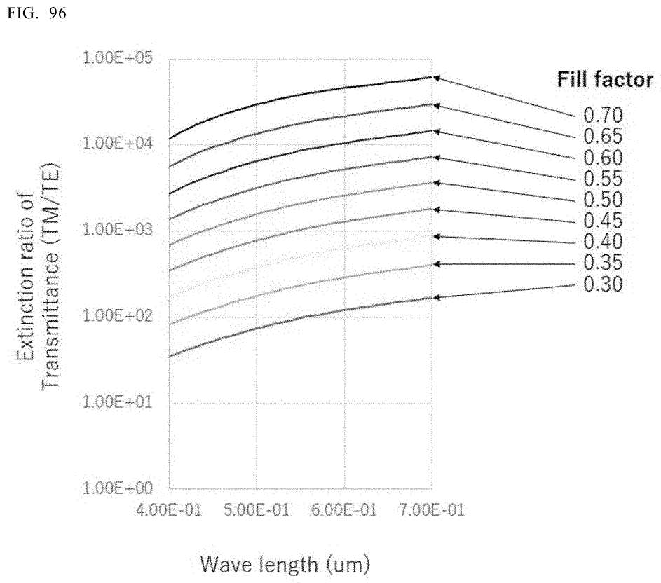

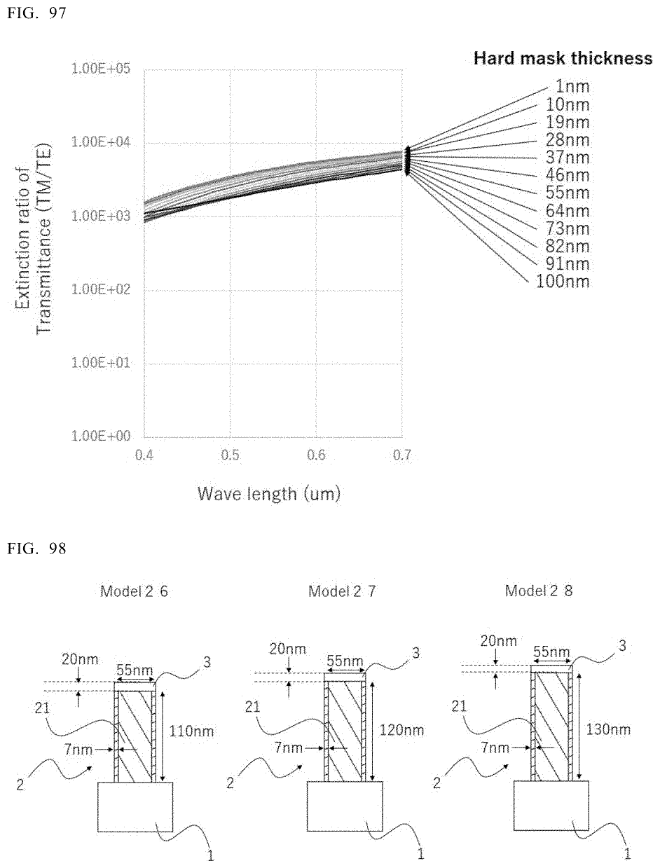

The TE reflectance, TM reflectance, reflection extinction ratio, TM transmittance, and transmittance extinction ratio of the above-described model are shown in FIGS. 88 to 97. Note that the incidence angle of light was 45 degrees.

Consequently, it becomes apparent that when the Fill factor is between 0.5 and 0.6, the reflection extinction ratio has a high value. In view of the transmittance, and the reflectance, etc., it is thought that a structure in which the Fill factor is 0.55 is the most desirable structure. The value of this Fill factor is larger than that of normal transmission type wire grids. The reason why the transmittance does not remarkably decrease in this case may be that the thickness of aluminum is thin.

The TE reflectance decreases by several % as the thickness of the polarizing axis correcting portion increases. It becomes apparent that, although the peak value of the reflection extinction ratio remarkably changes by the film thickness of SiO₂ that is a hard mask and becomes the maximum at 20 nm, the characteristics other than the peak wavelength do not remarkably change.

[Simulation 10]

With the optimal structure obtained in the simulations 8 and 9, the heights of the wires 21 of the wire grid portion 2 were changed 10 nm by 10 nm at the upper and lower sides, and a simulation was made for the optical characteristics thereof.

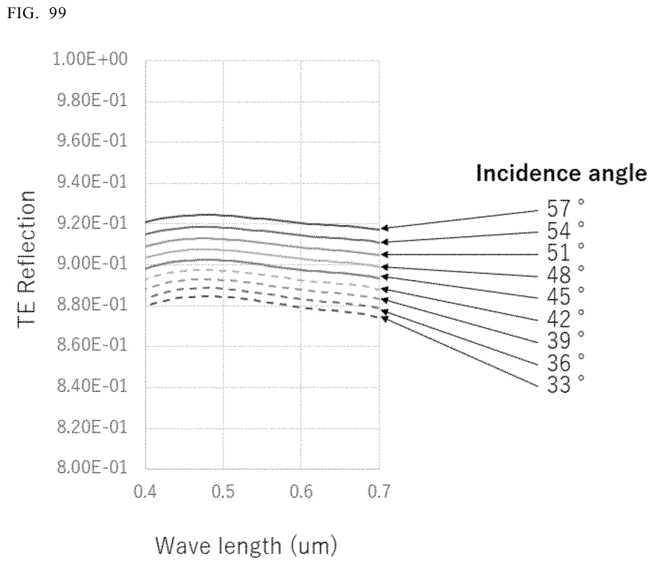

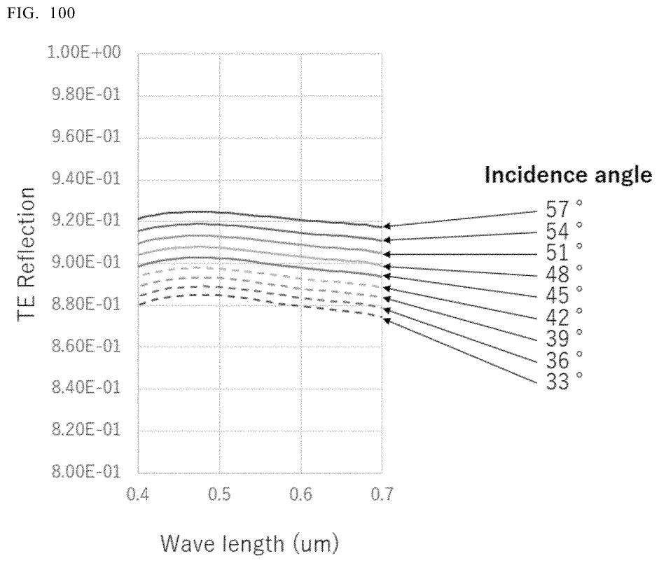

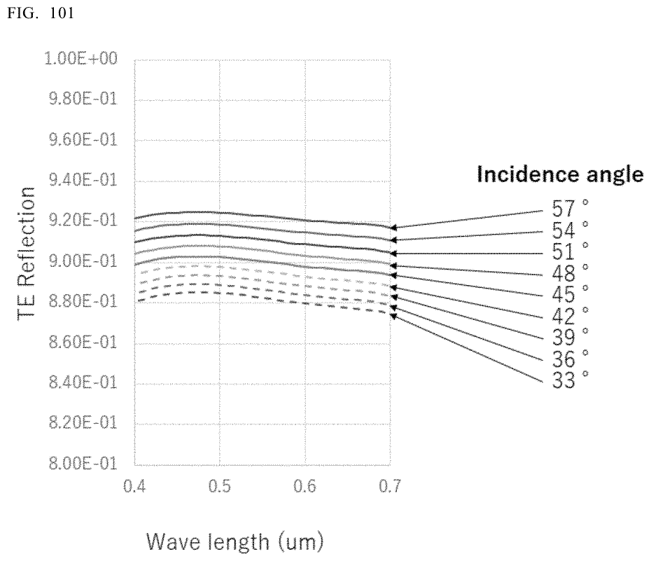

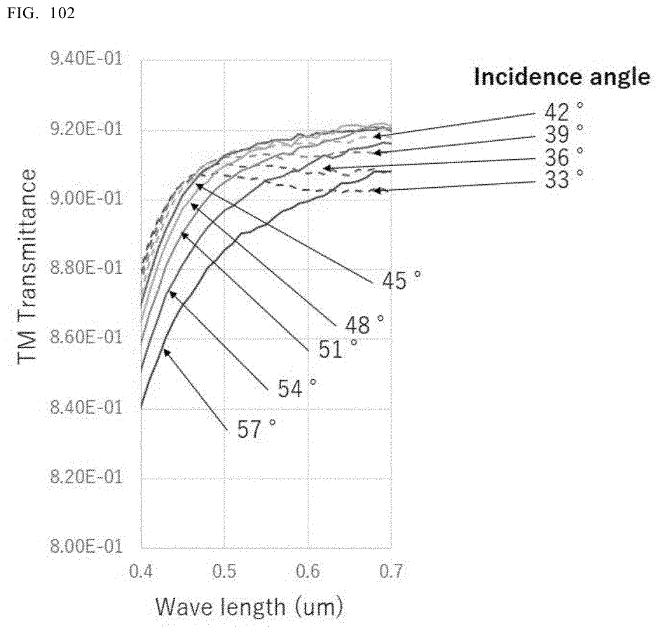

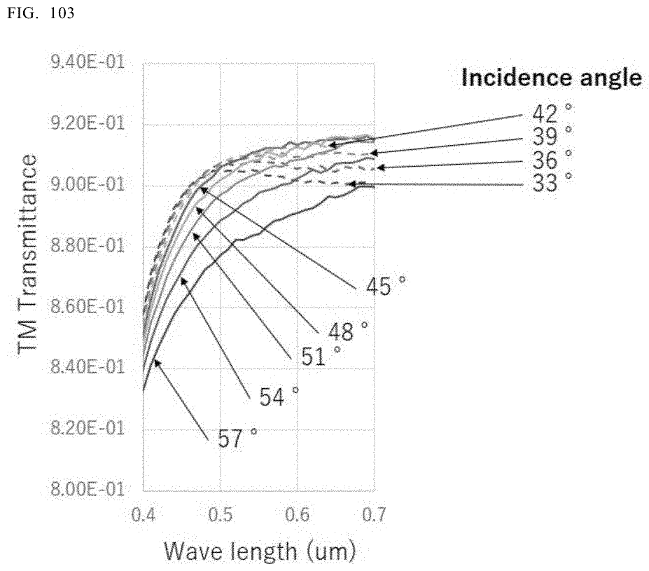

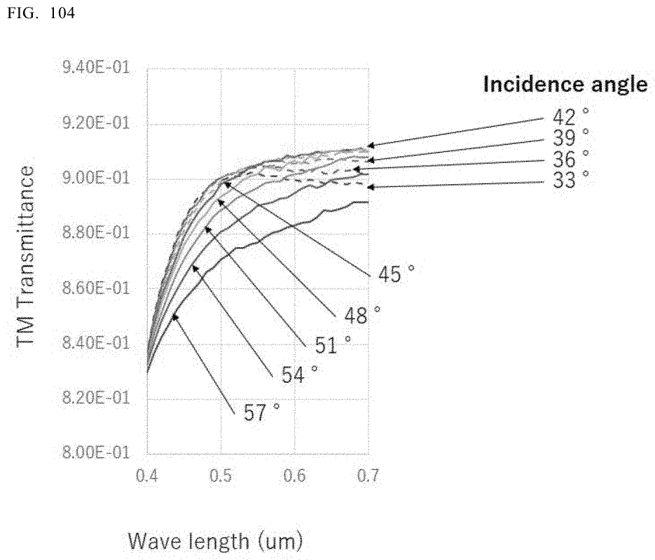

The assumed polarizer included, as illustrated in FIG. 98, the substrate 1 formed of silicon dioxide (SiO₂), and the wire grid portion 2 formed thereon, having the center part formed of aluminum, and having the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm, and each had a rectangular cross-sectional shape vertical to the extending direction of the wires 21. Moreover, the width was 55 nm. Furthermore, the wire 21 had a height of 110 (model 26), 120 (model 27), and 130 nm (model 28). Still further, both sides of aluminum oxide had a width of 7 nm. The assumed polarizing axis correcting portion 3 was a layer formed of silicon dioxide (SiO₂), had a rectangular cross-sectional shape, had a width of 55 nm, and had a height of 20 nm, and placed on the respective tips of the wires 21.

Moreover, the incidence angles of light were nine kinds between 33 to 57 degrees which are changed 3 degrees by 3 degrees.

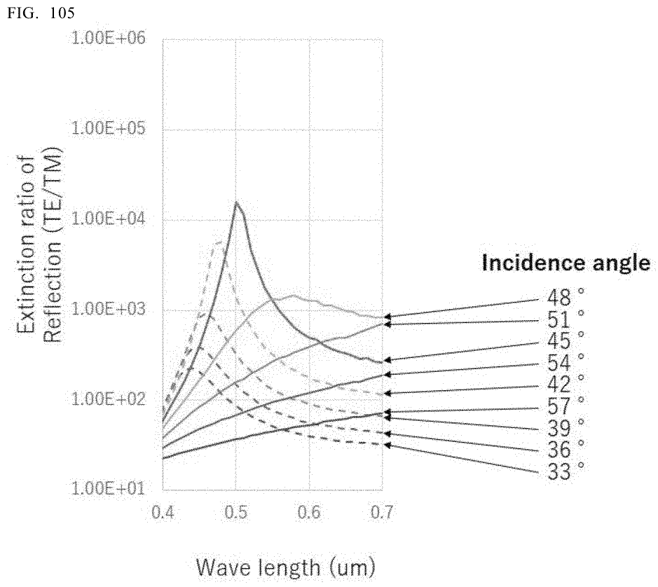

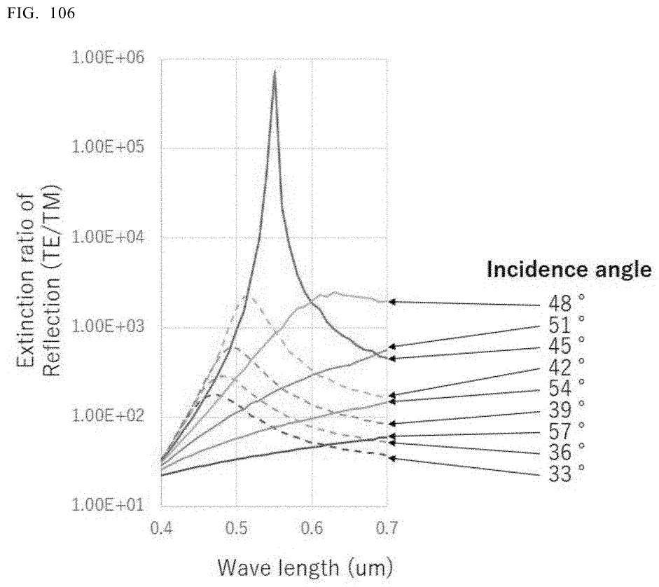

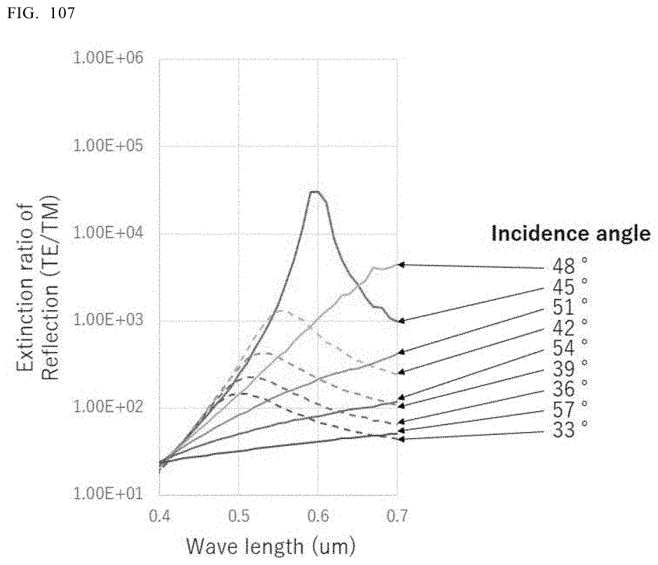

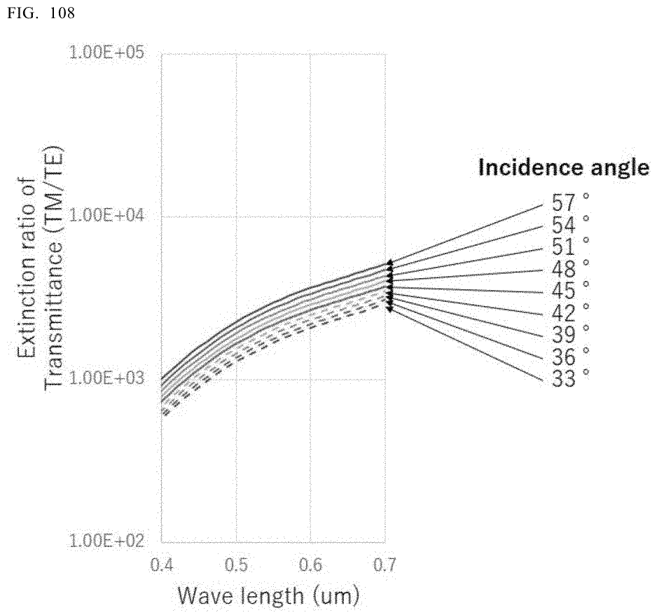

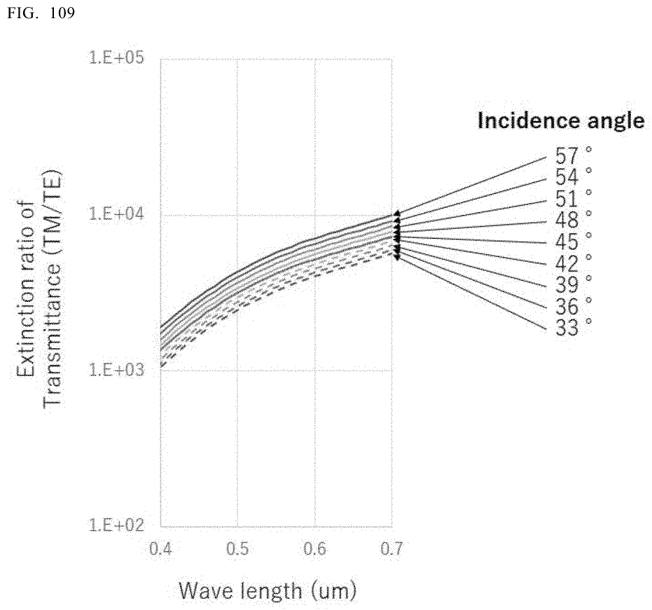

In each of the above-described models, results of the TE reflectance, TM transmittance, reflection extinction ratio, and transmittance extinction ratio for each incidence angle of light are shown in FIGS. 99 to 110.

Consequently, it becomes clear that, when the thickness of aluminum is changed, although the peak value and peak position of the reflection extinction ratio change, changes in other characteristics are little.

[Simulation 11]

Next, characteristics comparisons were made for wire grid regarding three kinds: a standard-type wire grid structure; a high-reflection extinction ratio wire grid structure (the optimal structure obtained in the simulations 8 and 9); and a wide-view-angle reflection extinction ratio wire grid structure. Nine kinds of the applied parameter that was the incidence angle of light were between 33 to 57 which were changed 3 degrees by 3 degrees.

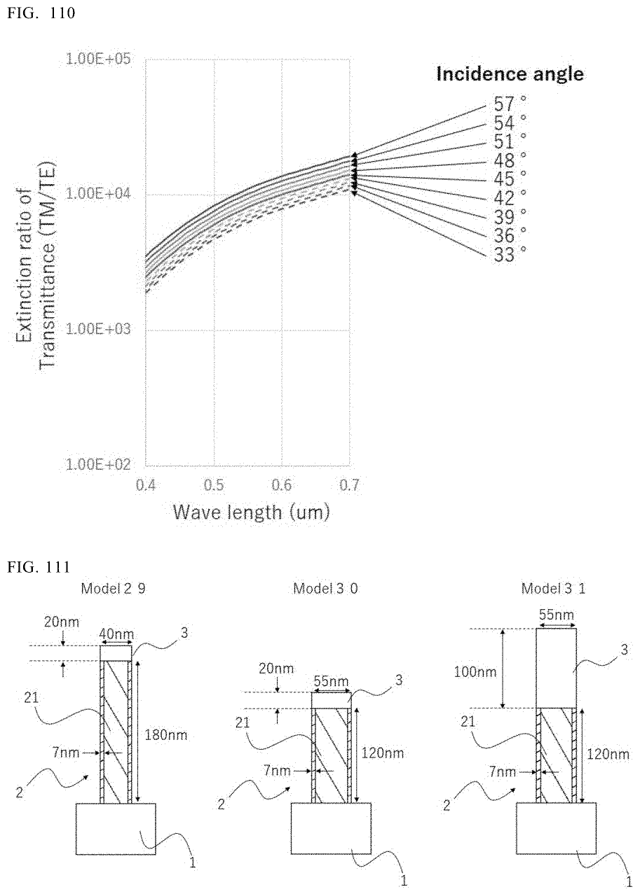

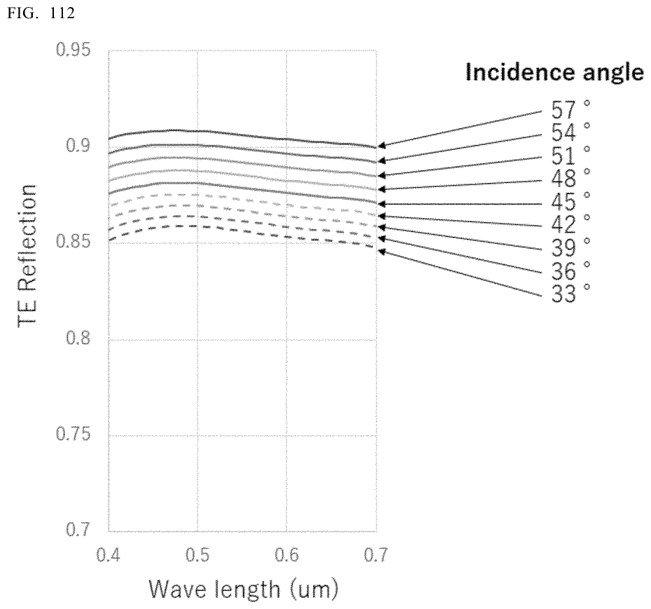

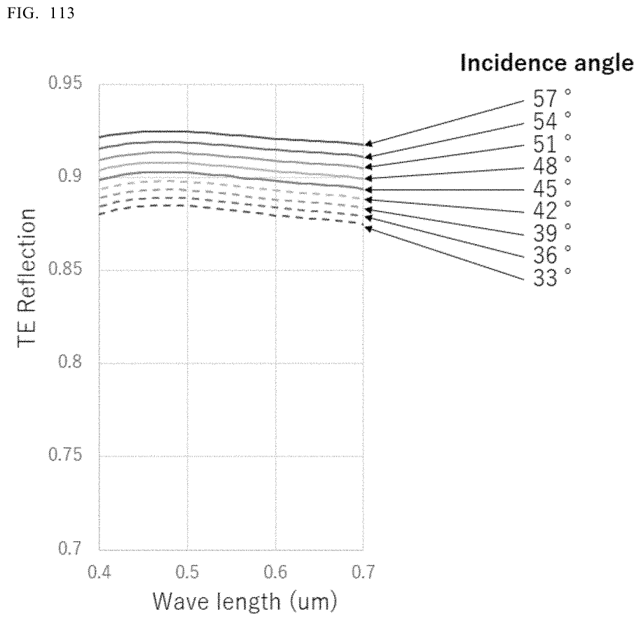

The assumed polarizer that employs the standard-type wire grid structure included, as indicated by a model 29 in FIG. 111, the substrate 1 formed of silicon dioxide (SiO₂), and the wire grid portion 2 formed thereon, having the center part formed of aluminum, and having the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm, and each had a rectangular cross-sectional shape vertical to the extending direction of the wires 21. Moreover, a width was 40 nm. Furthermore, the wire 21 had a height of 180 nm. Still further, both sides of aluminum oxide had a width of 7 nm. The assumed polarizing axis correcting portion 3 was a layer formed of silicon dioxide (SiO₂), had a rectangular cross-sectional shape, had a width of 40 nm, and had a height of 20 nm, and placed on the respective tips of the wires 21.

Moreover, the assumed polarizer that employs the high-reflection extinction ratio wire grid structure included, as indicated by a model 30 in FIG. 111, the substrate 1 formed of silicon dioxide (SiO₂), and the wire grid portion 2 formed thereon, having the center part formed of aluminum, and having the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm, and each had a rectangular cross-sectional shape vertical to the extending direction of the wires 21. Moreover, a width was 55 nm. Furthermore, the wire 21 had a height of 120 nm. Still further, both sides of aluminum oxide had a width of 7 nm. The assumed polarizing axis correcting portion 3 was a layer formed of silicon dioxide (SiO₂), had a rectangular cross-sectional shape, had a width of 55 nm and had a height of 20 nm, and placed on the respective tips of the wire 21.

Moreover, the assumed polarizer that employs the wide-view-angle reflection extinction ratio wire grid structure included, as indicated by a model 31 in FIG. 111, the substrate 1 formed of silicon dioxide (SiO₂), and the wire grid portion 2 formed thereon, having the center part formed of aluminum, and having the side faces formed of aluminum oxide that was a natural-oxidation film. The assumed polarizing axis correcting portion 3 was a thin film of silicon dioxide (SiO₂). In this case, the wires 21 of the wire grid portion 2 had a pitch of 100 nm, and each had a rectangular cross-sectional shape vertical to the extending direction of the wire 21. Moreover, the width was 55 nm. Furthermore, the wire 21 had a height of 120 nm. Still further, both sides of aluminum oxide had a width of 7 nm. The assumed polarizing axis correcting portion 3 was a layer formed of silicon dioxide (SiO₂), had a rectangular cross-sectional shape, had a width of 55 nm, and had a height of 100 nm, and placed on the respective tips of the wires 21.

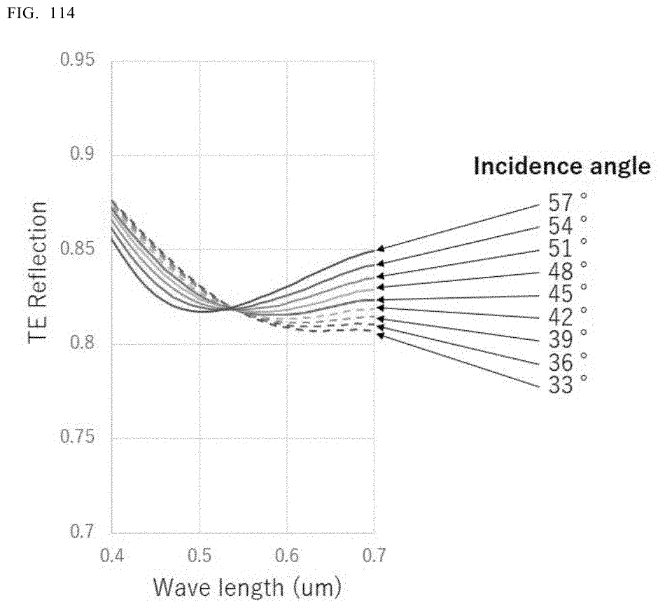

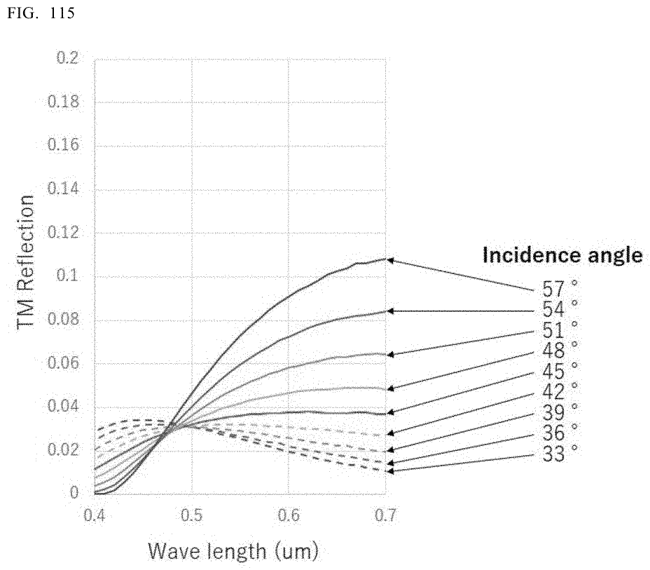

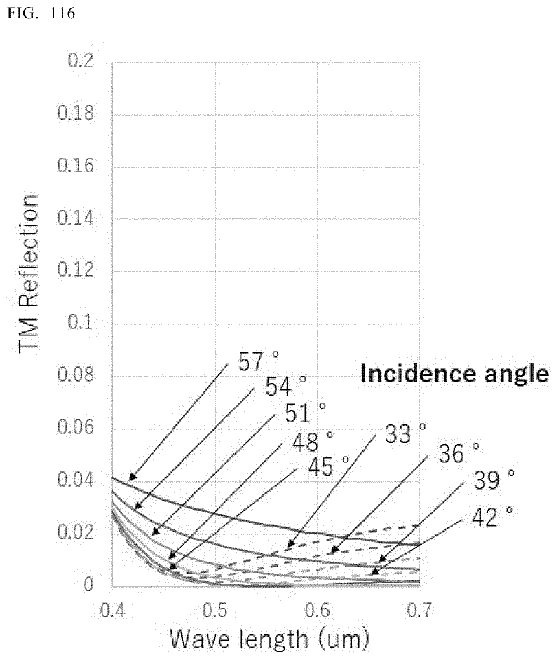

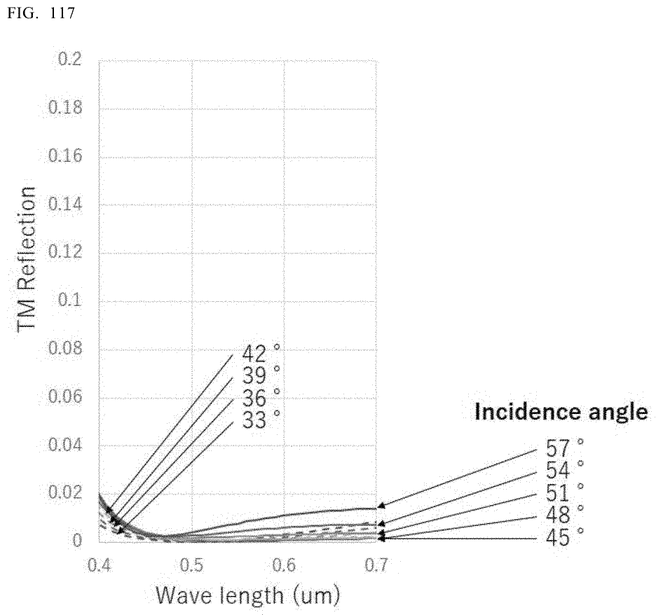

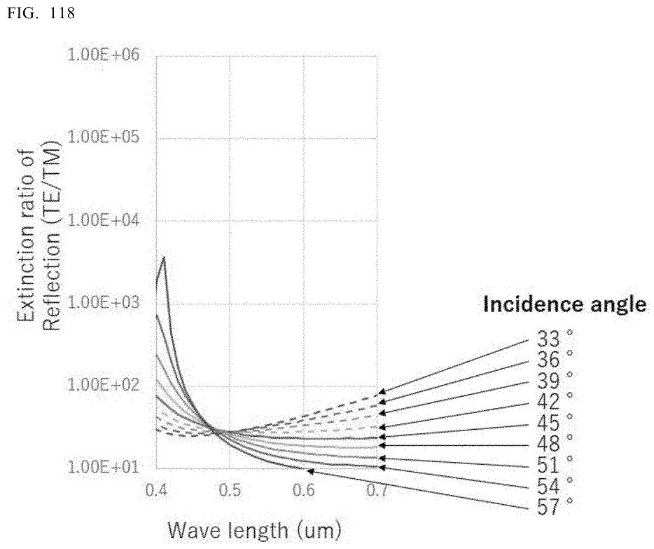

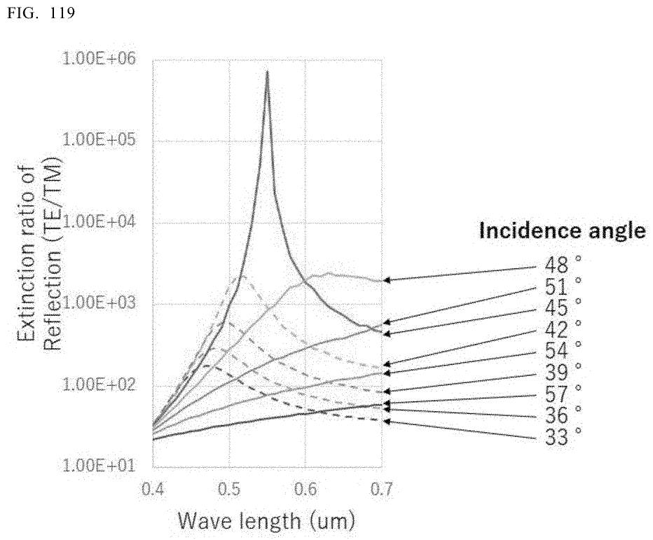

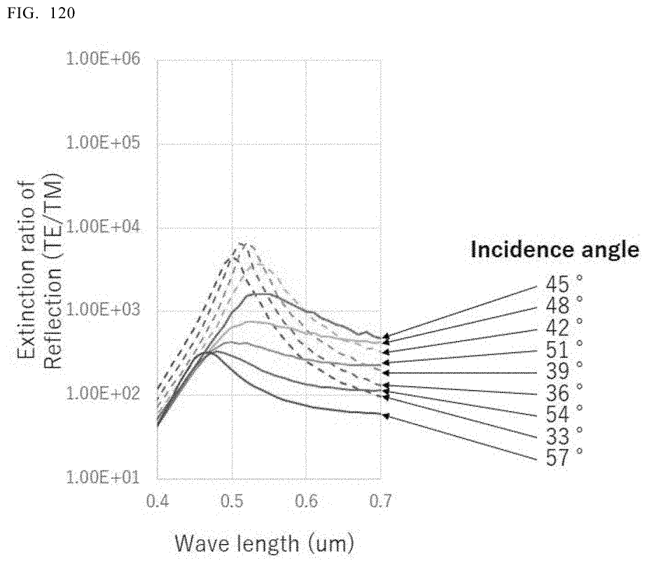

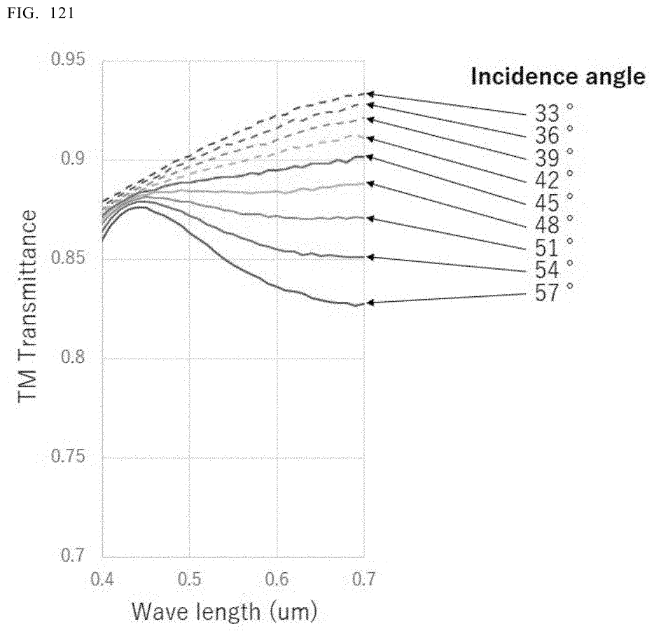

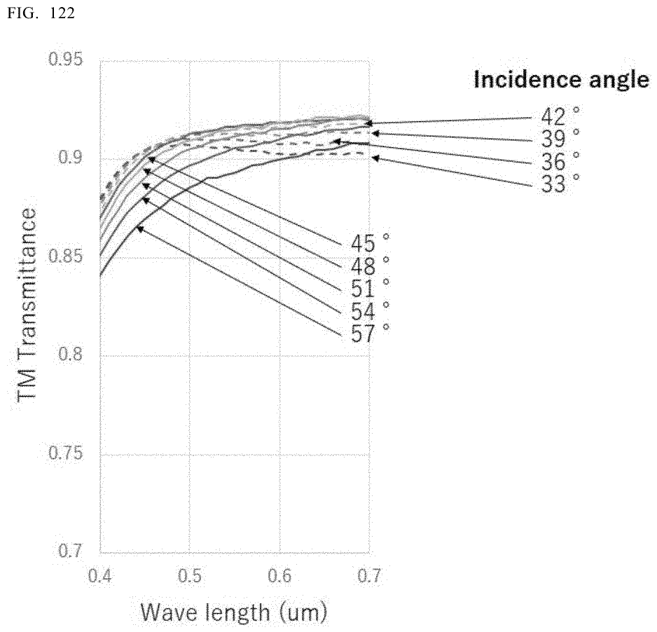

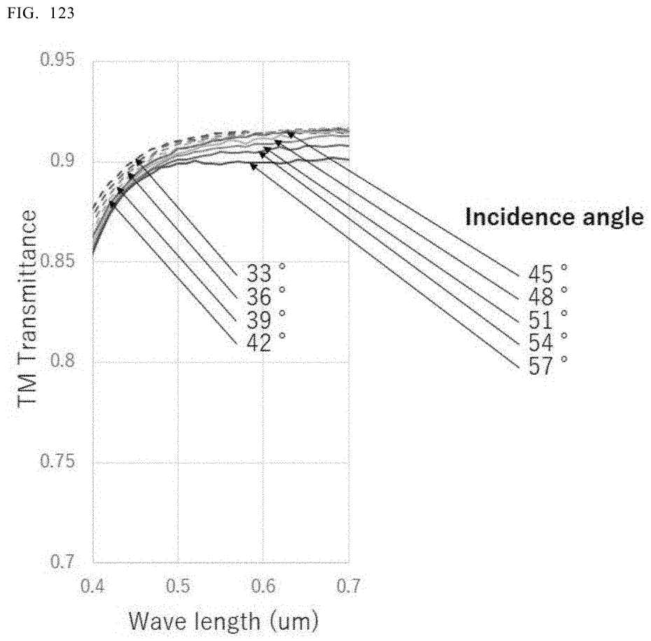

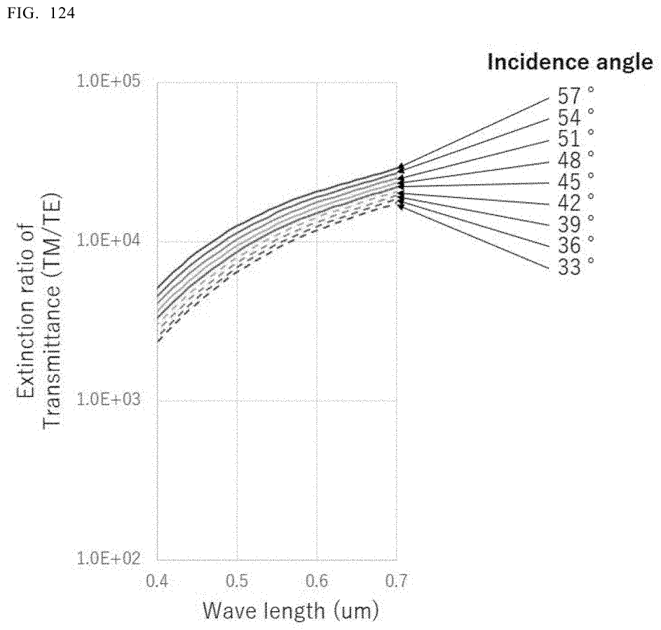

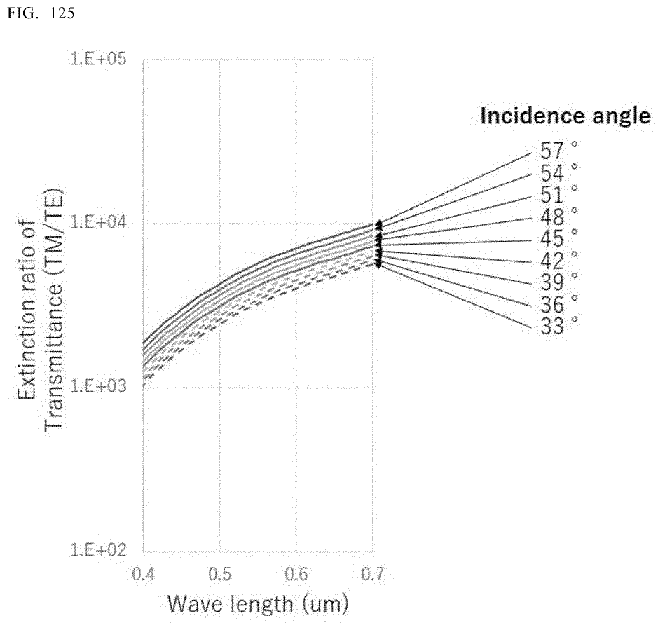

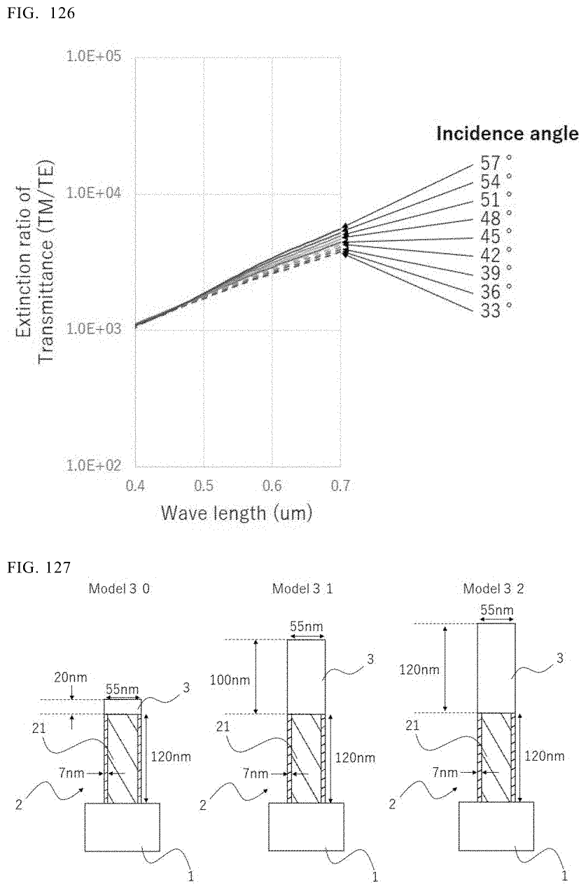

Results regarding the TE reflectance, TM reflectance, reflection extinction ratio, TM transmittance, and transmittance extinction ratio of the above-described models are shown in FIGS. 112 to 126.

Consequently, the standard-type wire grid structure (model 29) has a quite low reflection extinction ratio. In contrast, it becomes apparent that although the high-reflection extinction ratio wire grid structure (model 30) has a high reflectance and an excellent reflection extinction ratio at 45 degrees, when the incidence angle increases, the extinction ratio decreases. Moreover, it becomes apparent that although the wide-view-angle reflection extinction ratio wire grid structure (model 31) has a slightly low TE reflectance, the reduction of the reflection extinction ratio is low when the incidence angle is changed.

[Simulation 12]

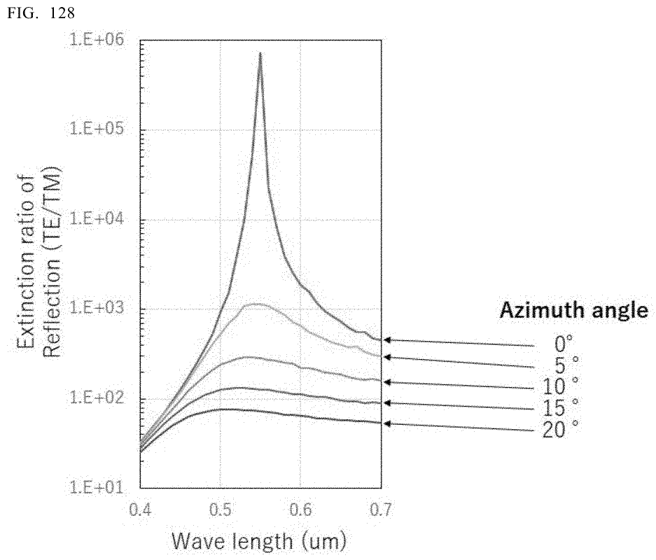

Next, a simulation was made for, regarding the high-reflection extinction ratio wire grid structure illustrated in FIG. 127 (the model 30), the wide-view-angle reflection extinction ratio wire grid structure (the model 31), and the wire grid structure in which the thickness of the SiO₂ of the model 31 was changed to 120 nm (model 32), the optical characteristics within the range of the incidence angle between 35 to 55 degrees with the azimuth angle being changed from 0 to 20 degrees.

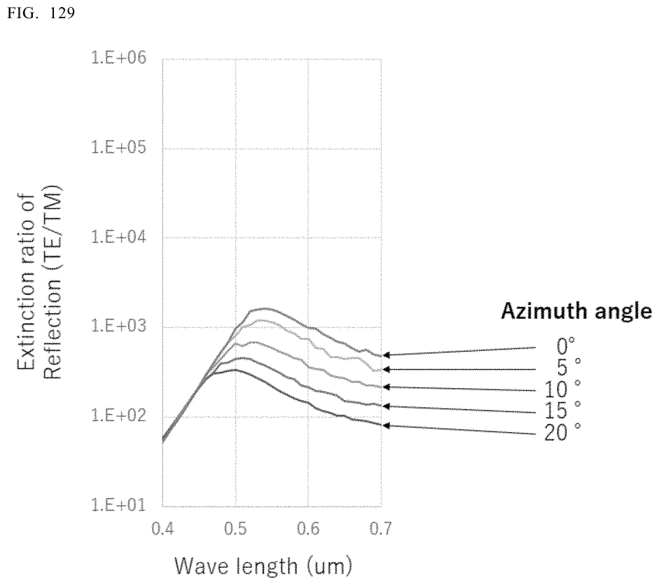

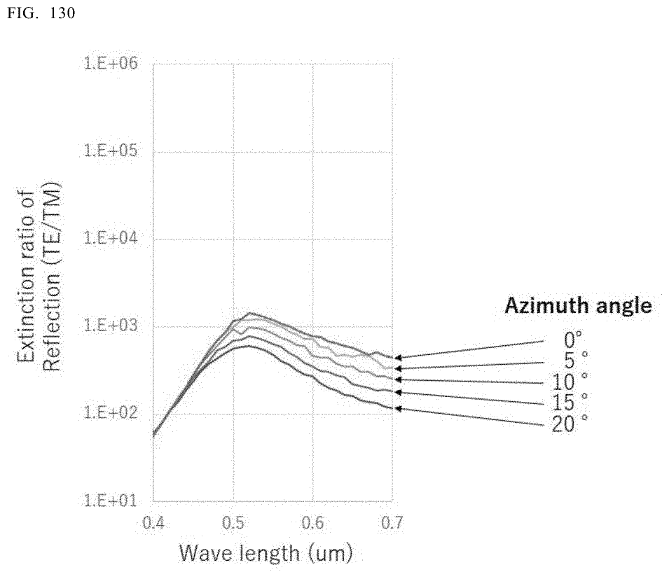

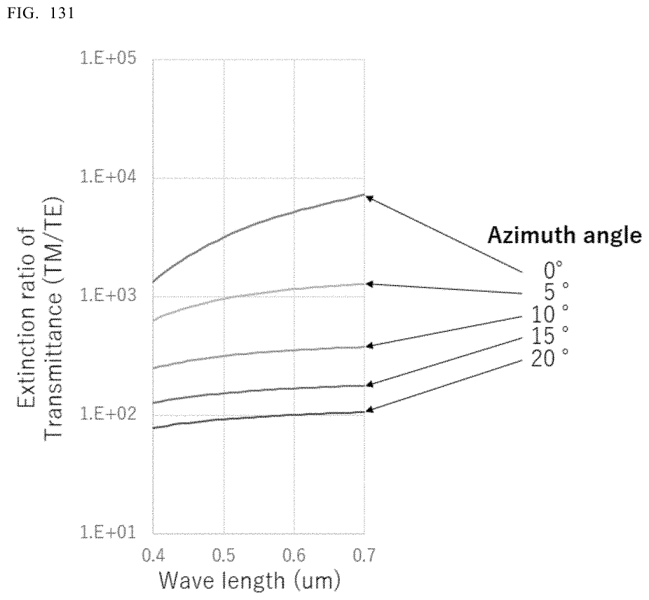

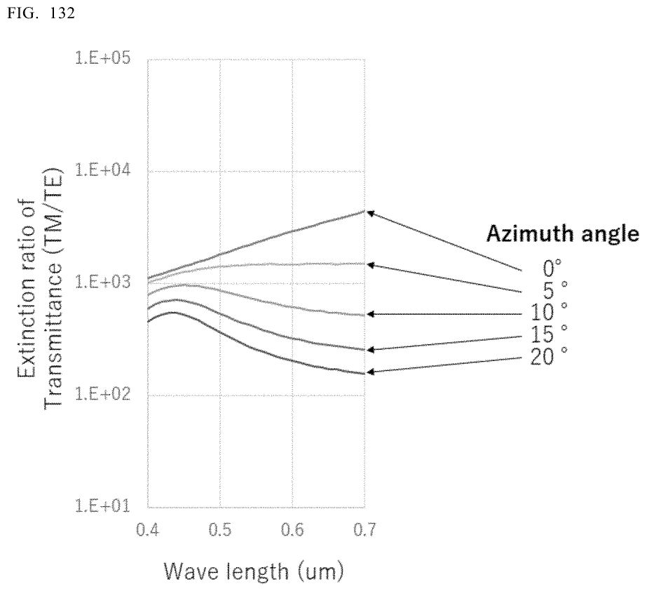

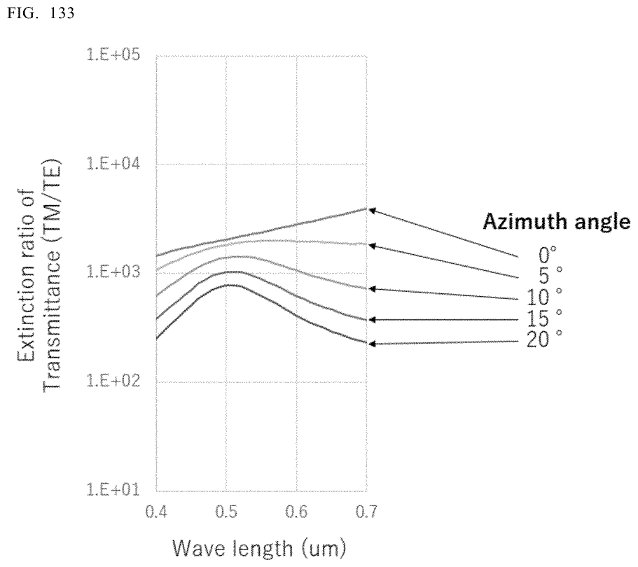

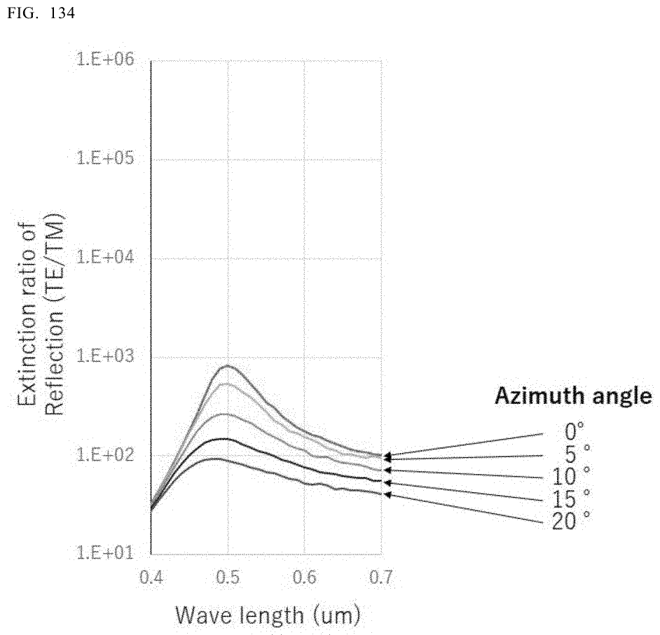

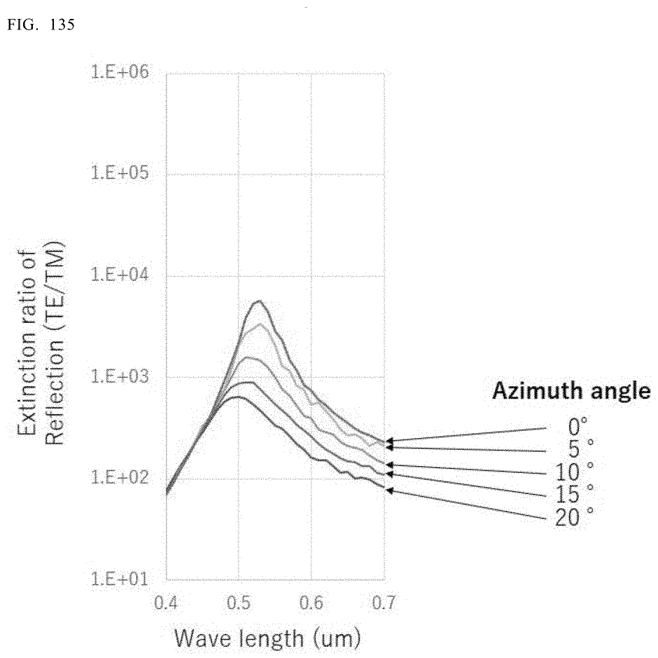

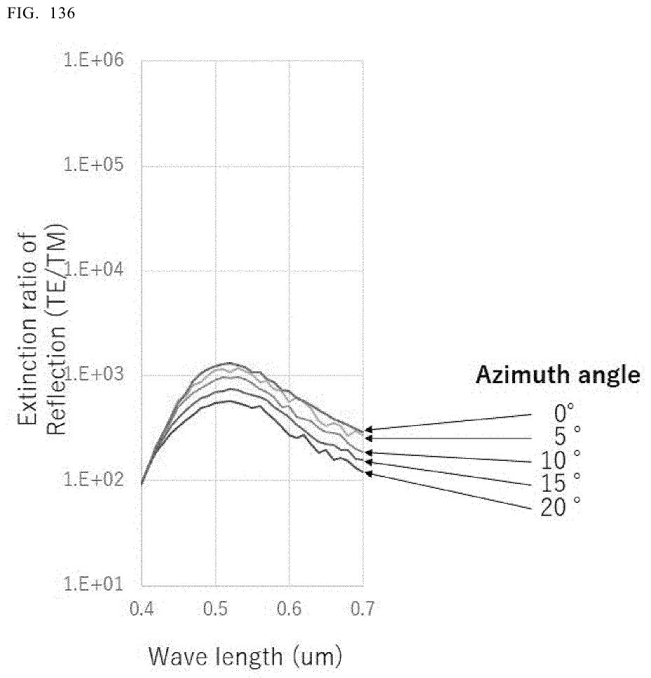

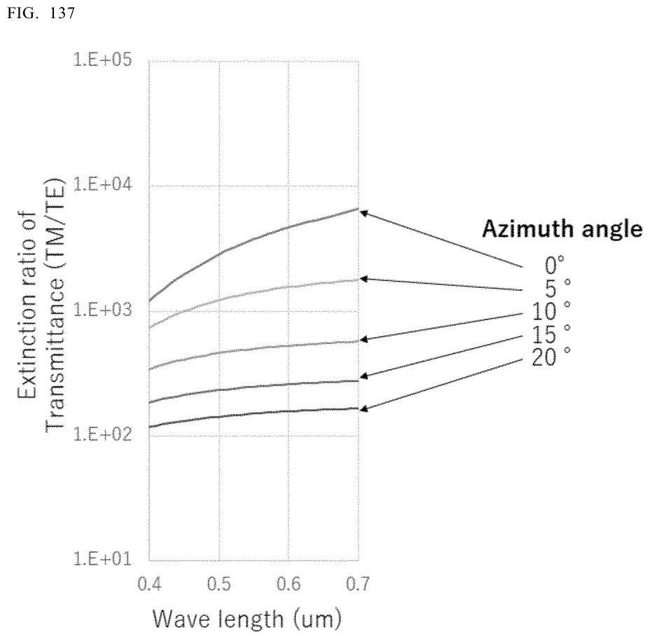

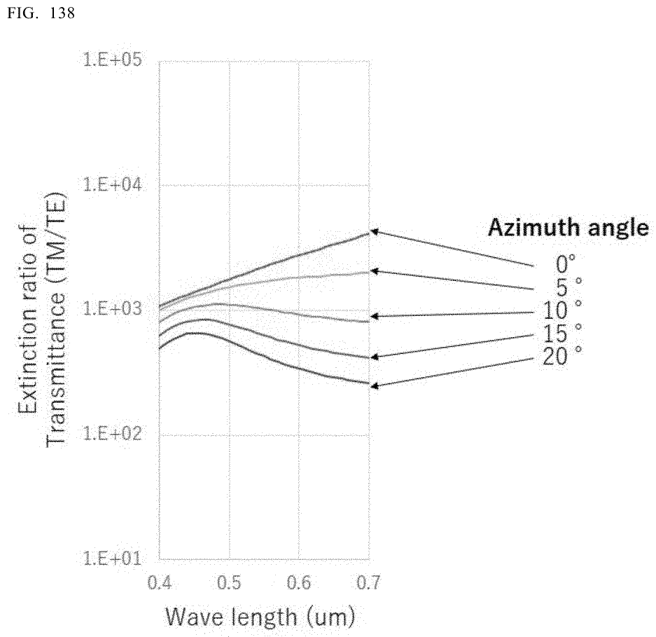

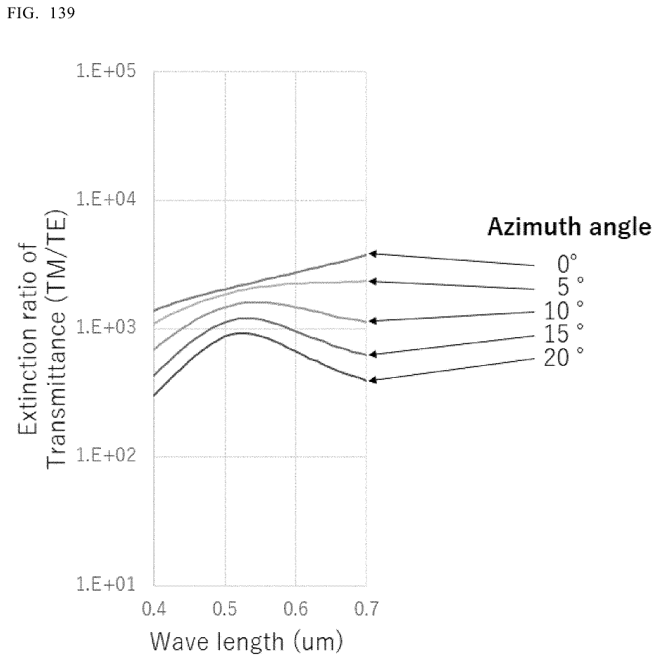

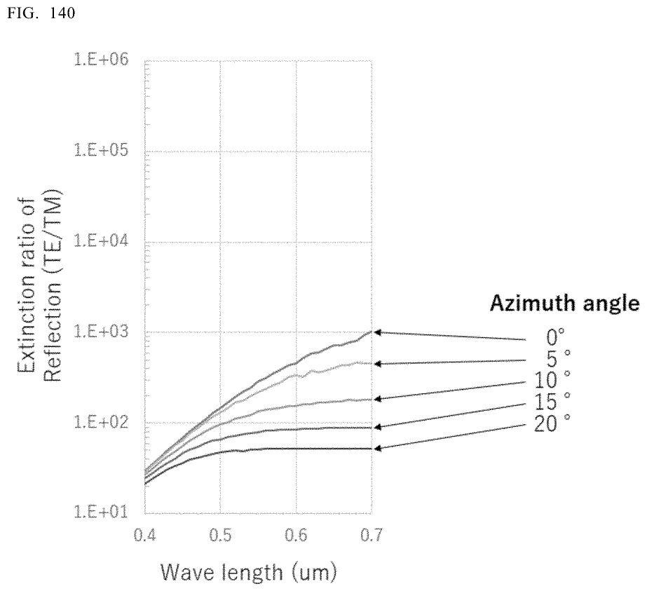

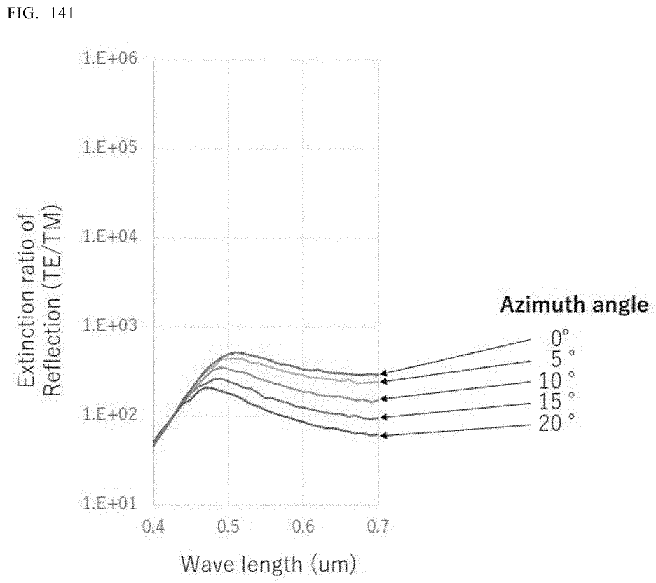

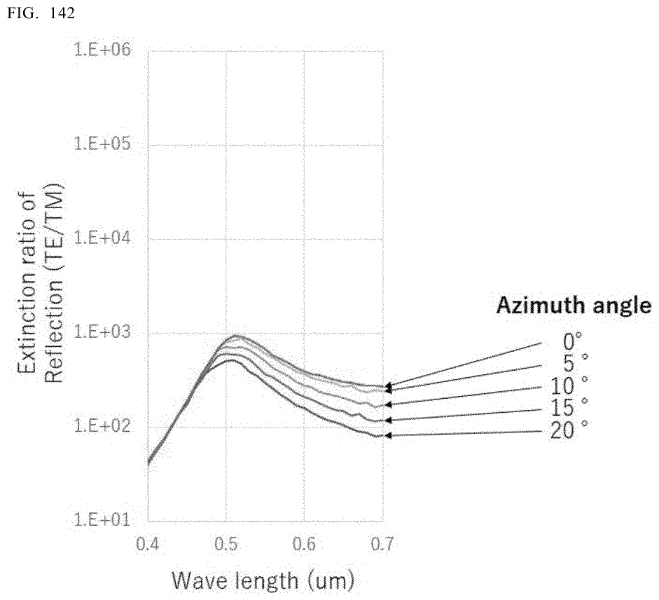

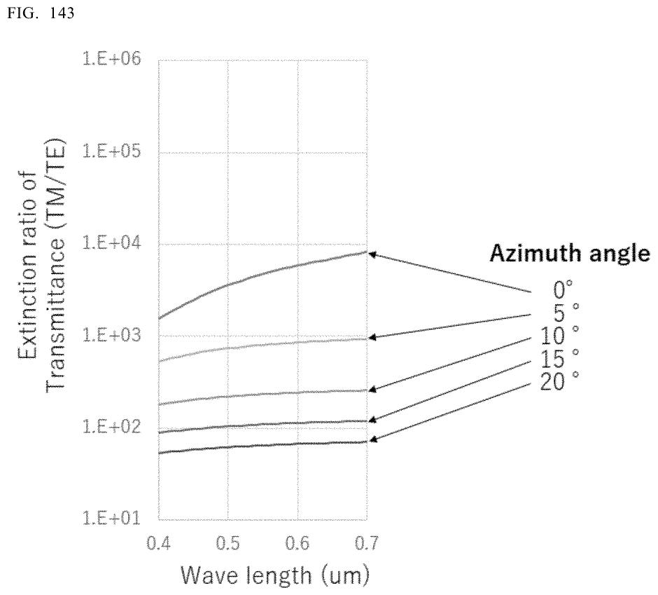

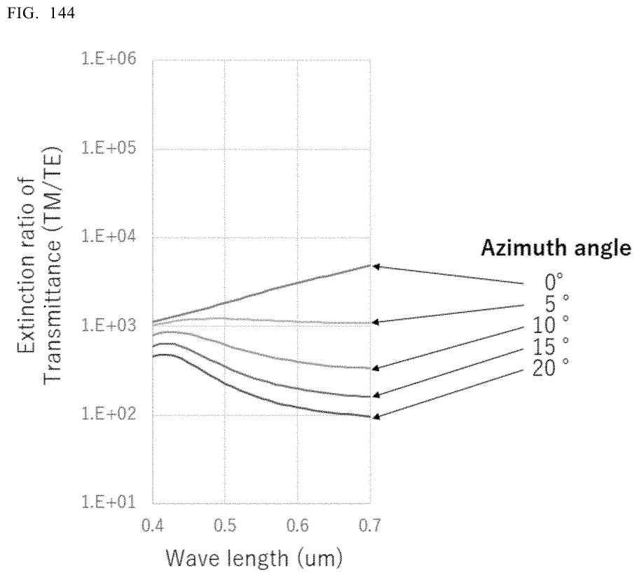

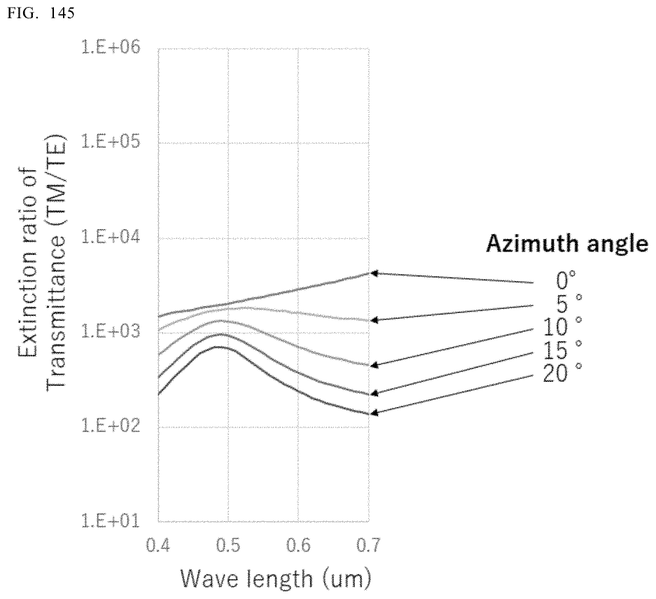

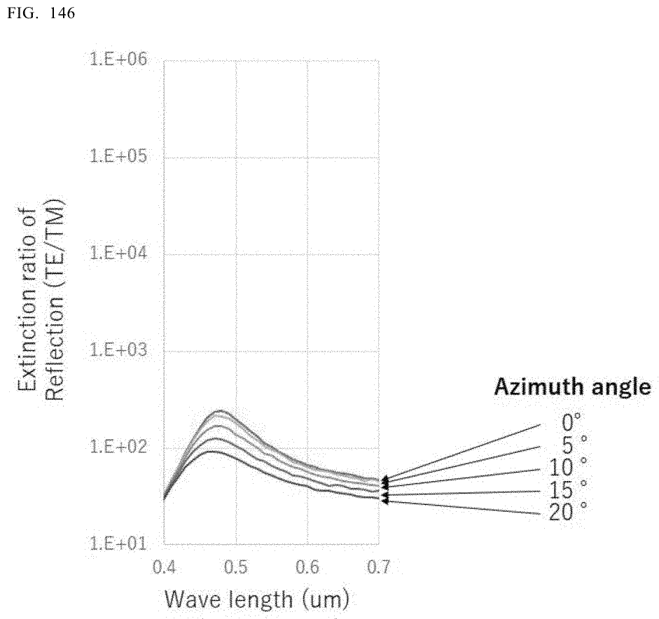

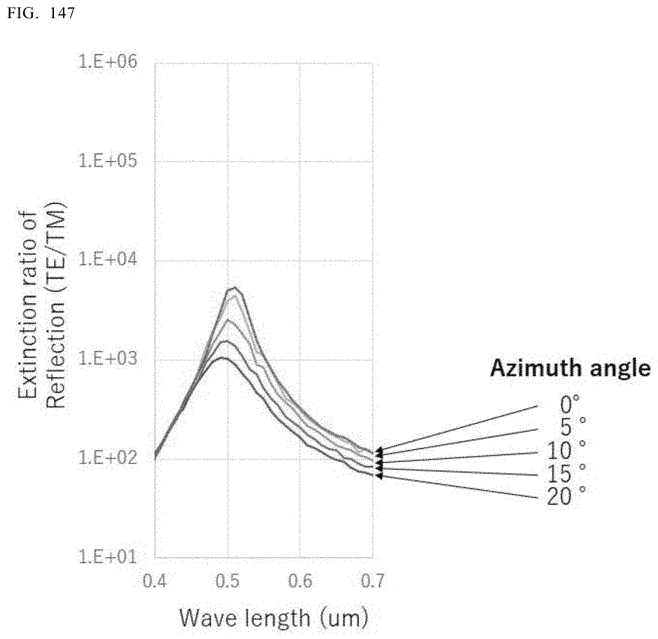

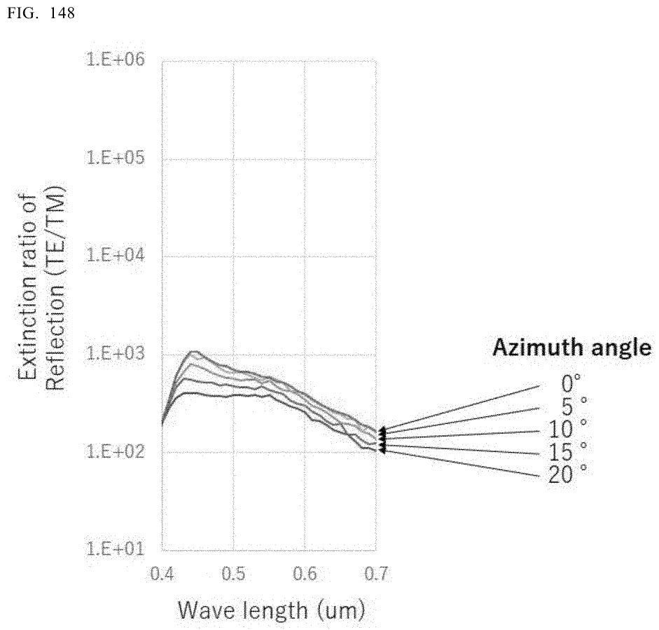

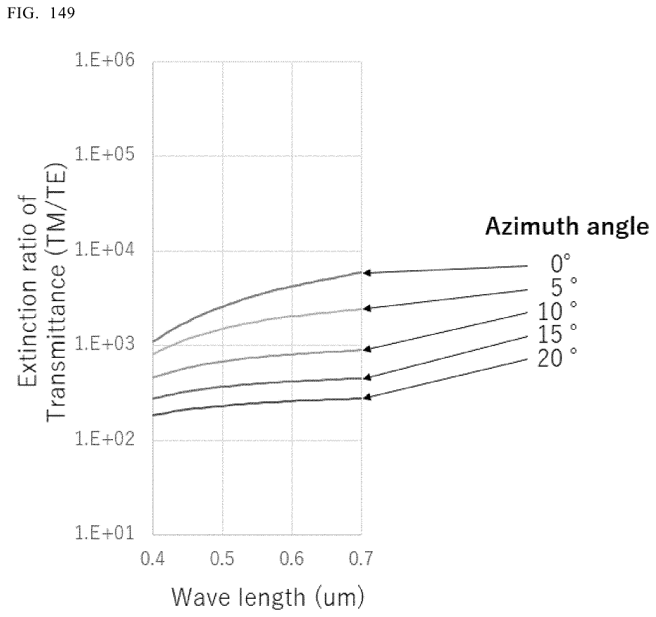

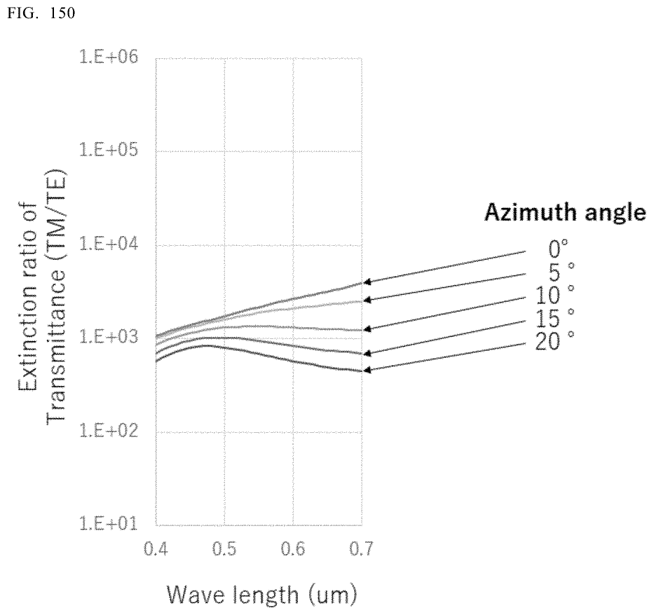

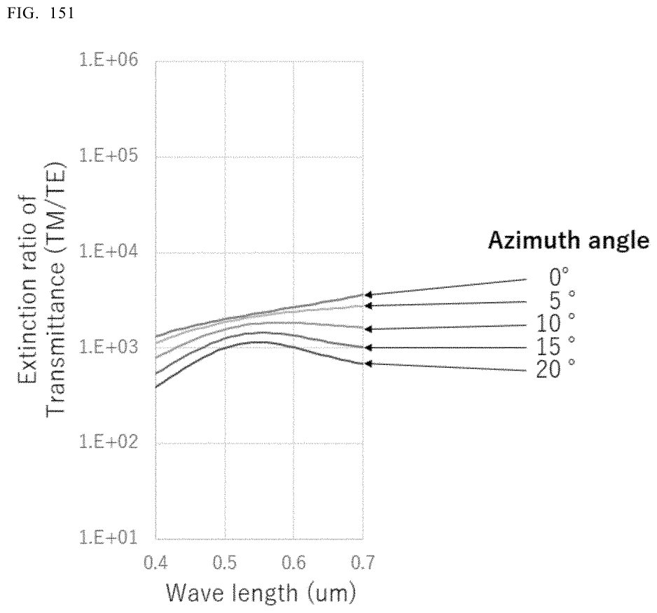

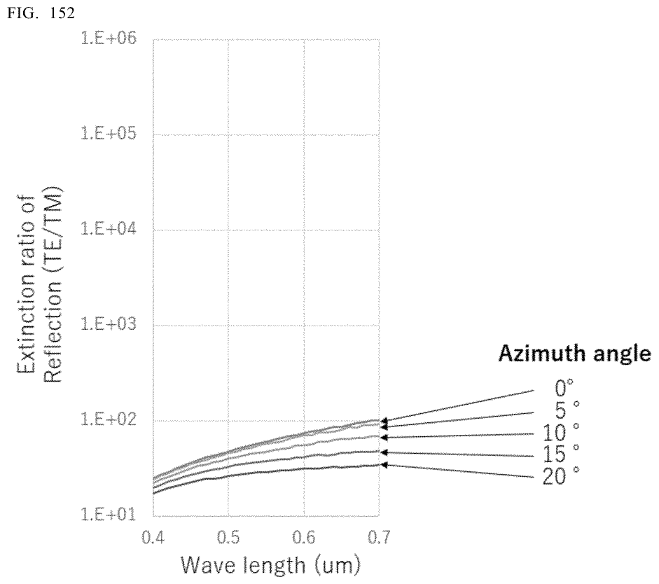

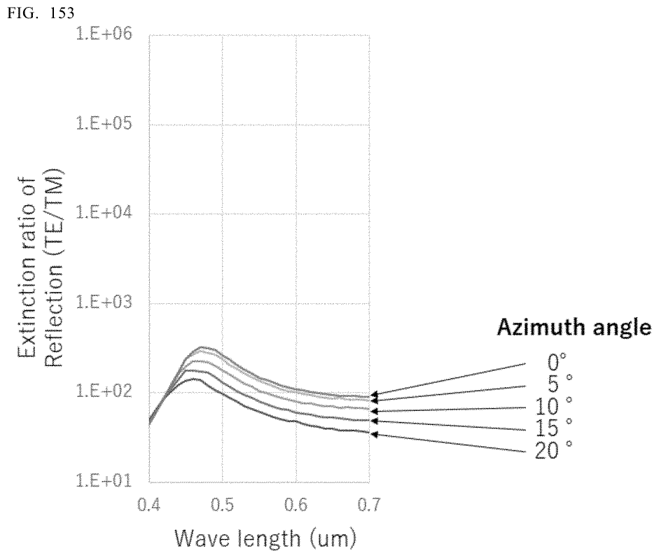

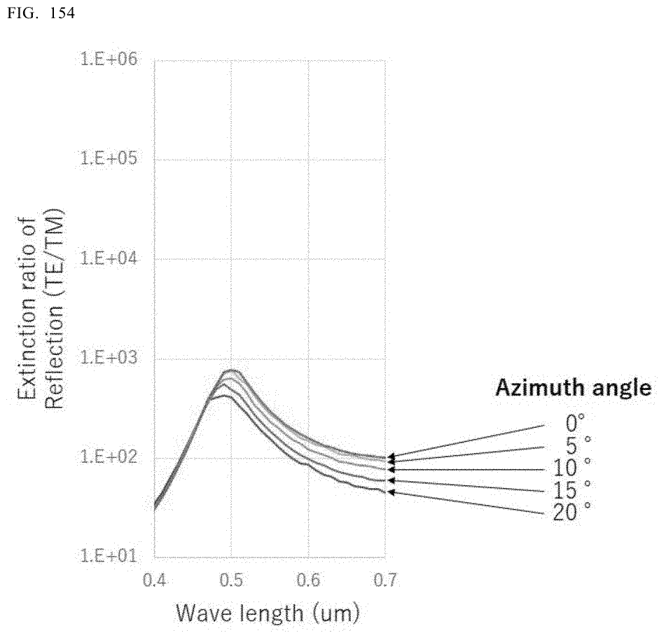

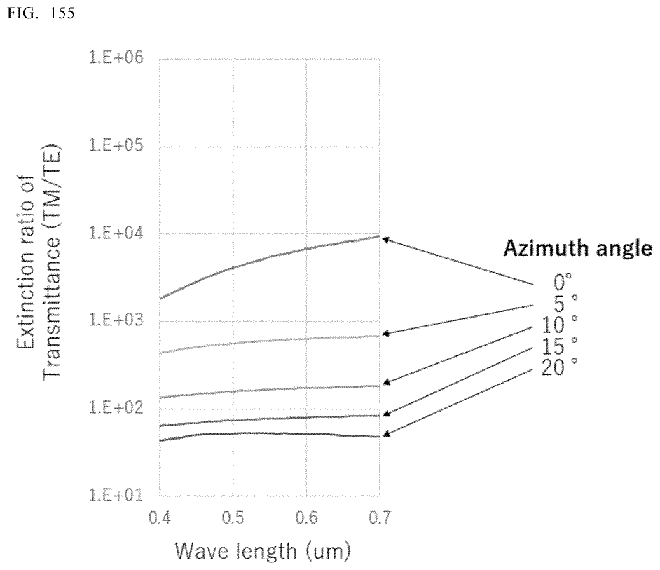

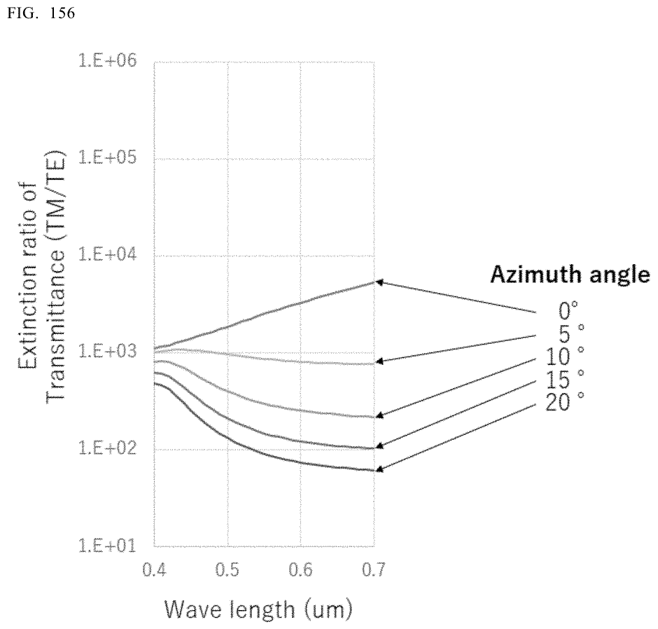

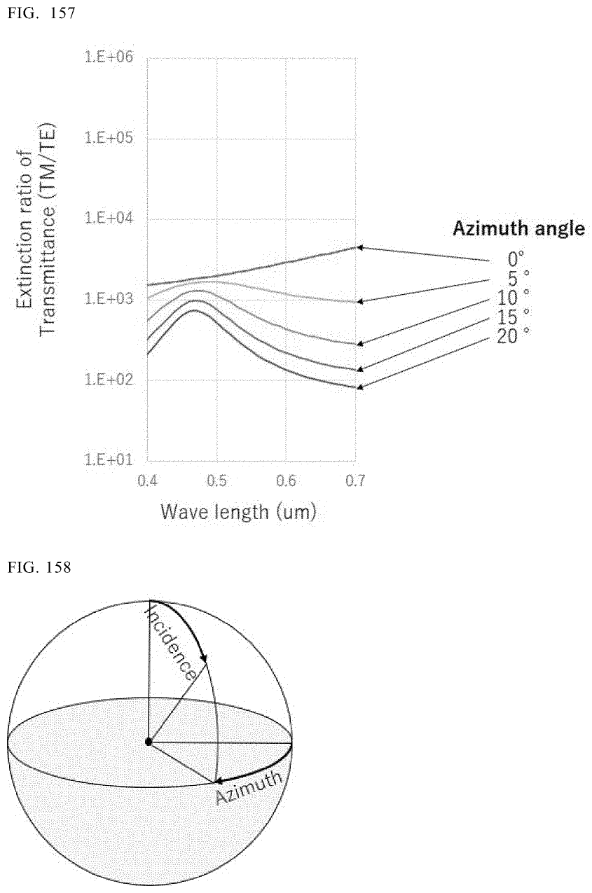

Results for the reflection extinction ratio and transmittance extinction ratio of the above-described models at each angle are shown in FIGS. 128 to 157.

Consequently, when the incidence angle is constant but the azimuth angle is changed, the advantage of the structure provided with thick SiO₂ for a wide view angle becomes remarkable in not only the reflection extinction ratio but also the transmittance extinction ratio. Moreover, like the model 32, the characteristics are optimized when the thickness of thick SiO₂ for wide view angle is adjusted so as to obtain the peak wavelength of the extinction ratio which is substantially 500 nm.

### REFERENCE SIGNS LIST

1 Substrate
2 Wire grid portion
3 Polarizing axis correcting portion
21 Wire
22 Absorption layer
50 Polarizer
51 Light source
52 Light-source-side polarizer
53 Liquid crystal
54 Wavelength converter
60 Polarizer
61 Light source
62 Mirror
69 Object

What is claimed is:

1. A polarizer comprising:
a substrate transparent to light within a utilized bandwidth; and
a wire grid portion comprising a plurality of wires which extends in a direction and which is arranged side by side at a pitch shorter than a wavelength of the light;
a polarizing axis correcting portion which is formed of a dielectric provided at a side at which the light enters the wire grid portion, and which performs correction so as to reduce a displacement in an angle between an incidence-side transmittance axis of linear polarized light and an emitting-side absorption axis thereof when the linear polarized light within the utilized bandwidth enters at an azimuth angle of 45 degrees relative to the wires.

2. The polarizer according to claim 1, wherein the polarizing axis correcting portion performs the correction so as to reduce the displacement in the angle between the incidence-side transmittance axis of the linear polarized light and the emitting-side absorption axis thereof by changing an intensity ratio between a P-wave of the incident light and an S-wave thereof.

3. The polarizer according to claim 1, wherein when the linear polarized light within the utilized bandwidth enters at the azimuth angle of 45 degrees and at an incidence angle of 50 degrees relative to the wires, the polarizing axis correcting portion has a thickness that corrects the displacement in the angle between the incidence-side transmittance axis of the linear polarized light and the emitting-side absorption axis thereof to be equal to or smaller than 7 degrees at all wavelengths within the utilized bandwidth.

4. The polarizer according to claim 1, wherein when the linear polarized light within the utilized bandwidth enters at the azimuth angle of 45 degrees and at an incidence angle of 50 degrees relative to the wires, the polarizing axis correcting portion has a thickness that corrects the displacement in the angle between the incidence-side transmittance axis of the linear polarized light and the emitting-side absorption axis thereof to be equal to or smaller than 2 degrees at all wavelengths within the utilized bandwidth.

5. The polarizer according to claim 1, wherein
the utilized bandwidth is a visual light range; and
when the linear polarized light within the visual light range enters at the azimuth angle of 45 degrees and at an incidence angle of 40 degrees relative to the wires, the polarizing axis correcting portion has a thickness that causes a wavelength of light which takes the minimum value of a TE transmittance to be equal to or greater than 495 nm and to be equal to or smaller than 570 nm.

6. The polarizer according to claim 1, wherein
the utilized bandwidth is a visual light range; and
when the linear polarized light within the visual light range enters at the azimuth angle of 45 degrees and at an incidence angle of 40 degrees relative to the wires, the polarizing axis correcting portion has a thickness that corrects a TE transmittance of light which has a wavelength of equal to or greater than 507 nm and equal to or smaller than 555 nm to be equal to or smaller than 0.2%.

7. The polarizer according to claim 1, wherein the polarizing axis correcting portion is formed of silicon dioxide, and has a thickness of equal to or greater than 60 nm and equal to or smaller than 120 nm.

8. The polarizer according to claim 1, wherein the polarizing axis correcting portion is formed of silicon nitride, and has a thickness of equal to or greater than 40 nm and equal to or smaller than 90 nm.

9. The polarizer according to claim 1, wherein the polarizing axis correcting portion is formed of titanium dioxide, and has a thickness of equal to or greater than 20 nm and equal to or smaller than 60 nm.

10. The polarizer according to claim 1, wherein the polarizing axis correcting portion is placed on the wire grid portion at the substrate side.

11. The polarizer according to claim 1, wherein the polarizing axis correcting portion is placed on the wire grid portion at a side facing the substrate.

12. The polarizer according to claim 11, wherein the polarizing axis correcting portion is placed on the respective tips of the wires of the wire grid portion.

13. The polarizer according to claim 12, wherein in a cross section that is vertical to the extending direction of the wire, a cross-sectional shape of the polarizing axis correcting portion comprises a part that has at least partially wider width than a width of the wire.

14. The polarizer according to claim 12, wherein in a cross section that is vertical to the extending direction of the wire, a cross-sectional shape of the polarizing axis correcting portion is formed in a reverse taper shape.

15. The polarizer according to claim 1, wherein the wire grid portion comprises an absorption layer.

16. A display comprising:
a light source that emits blue light;
a polarizer that converts the light from the light source into linear polarized light;
a liquid crystal that changes a polarizing direction of the linear polarized light;
a polarizer according to claim 1; and
a wavelength converter that converts the light into a red or green wavelength.

17. The display according to claim 16, wherein when the linear polarized light enters at an azimuth angle of 45 degrees and at an incidence angle of 40 degrees relative to the wires, the polarizing axis correcting portion has a thickness that causes a wavelength of light which takes the minimum value of a TE transmittance to be equal to or greater than 380 nm and to be equal to or smaller than 495 nm.

18. An ultraviolet emitting apparatus comprising:
a light source that emits ultraviolet rays;
a curved mirror that reflects the ultraviolet rays emitted from the light source toward an object; and
the polarizer according to claim 1, wherein the utilized bandwidth is the ultraviolet rays.

19. The ultraviolet emitting apparatus according to claim 18, wherein when the linear polarized light enters at an azimuth angle of 45 degrees and at an incidence angle of 40 degrees relative to the wires, the polarizing axis correcting portion has a thickness that causes a wavelength of light which takes the minimum value of a TE transmittance to be smaller than 380 nm.
